(19) United States
(12) Patent Application Publication
(10) Pub. No.: US 2009/0239028 A1
(43) Pub. Date: Sep. 24, 2009

(54) HONEYCOMB STRUCTURE

(75) Inventors: Kazushige OHNO, Ibi-gun (JP); Kazutake Ogyu, Ibi-gun (JP); Shigeharu Ishikawa, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki-shi (JP)

(21) Appl. No.: 12/395,939

(22) Filed: Mar. 2, 2009

(30) Foreign Application Priority Data
Mar. 24, 2008 (JP) PCT/JP2008/055455
Mar. 24, 2008 (JP) PCT/JP2008/055456
Mar. 24, 2008 (JP) PCT/JP2008/055458
Mar. 24, 2008 (JP) PCT/JP2008/055459

(51) Int. Cl. B32B 3/12

(52) U.S. Cl. 428/116

(57) ABSTRACT

A honeycomb structure includes a plurality of honeycomb fired bodies each having cells. The honeycomb fired bodies include a center-portion honeycomb fired body and a peripheral-portion honeycomb fired body. An area of the center-portion honeycomb fired body is at least about 900 mm² and at most about 2500 mm² in a cross section. A shape of the peripheral-portion honeycomb fired body is different from the shape of the center-portion honeycomb fired body in the cross section. An area of the peripheral-portion honeycomb fired body is at least about 0.9 times and at most about 1.3 times larger than the area of the center-portion honeycomb fired body in the cross section.

### CROSS-REFERENCE TO RELATED APPLICATIONS

The present application claims priority under 35 U.S.C. §119 to PCT Applications No. PCT/JP2008/055455 filed Mar. 24, 2008, PCT/JP2008/055456 filed Mar. 24, 2008, PCT/JP2008/055458 filed Mar. 24, 2008, and PCT/JP2008/055459 filed Mar. 24, 2008. The contents of these applications are incorporated herein by reference in their entirety.

### BACKGROUND OF THE INVENTION

1. Field of the Invention

The present invention relates to a honeycomb structure.

2. Discussion of the Background

In recent years, particulate matter (hereinafter, also referred to simply as particulate or PM) contained in exhaust gases discharged from internal combustion engines of vehicles such as buses and trucks, and construction machines have raised serious problems as contaminants harmful to the environment and the human body.

For this reason, various honeycomb structures, which are made of porous ceramics, have been proposed as filters that capture particulate in exhaust gases and purify the exhaust gases.

As a honeycomb structure of this kind, for example, a honeycomb structure has been proposed in which, after a plurality of rectangular pillar-shaped honeycomb fired bodies have been combined with one another with an adhesive layer interposed therebetween, the combined honeycomb fired body undergoes a cutting process to be formed into a predetermined shape to manufacture the honeycomb structure (for example, see WO01/23069A1).

Further, a honeycomb structure has been also proposed in which a plurality of honeycomb fired bodies, each of which is manufactured by preliminarily being extrusion-molded into a predetermined shape, are combined with one another with an adhesive layer interposed therebetween (for example, see JP-A 2004-154718).

On a cross section perpendicular to a longitudinal direction of these honeycomb structures, a honeycomb fired body having a rectangular shape in the cross section is located in the center portion of the honeycomb structure. Honeycomb fired bodies having a smaller cross-sectional area than that of the honeycomb fired bodies located in the center portion are located in the peripheral portion of the honeycomb structure.

Moreover, a honeycomb structure having another structure has been proposed in which, on a cross section perpendicular to a longitudinal direction thereof, a honeycomb fired body having a rectangular shape in the cross section is located in the center portion of the honeycomb structure, and a honeycomb fired body having a cross-sectional area larger than that of a honeycomb fired body located in the center portion are located in the peripheral portion of the honeycomb structure (for example, see WO04/96414A1).

The contents of WO01/23069A1, JP-A 2004-154718 and WO04/96414A1 are incorporated herein by reference in their entirety.

### SUMMARY OF THE INVENTION

According to one aspect of the present invention, a honeycomb structure includes a plurality of honeycomb fired bodies that are combined with one another with an adhesive layer interposed therebetween. Each of the honeycomb fired bodies has cell walls extending along a longitudinal direction of the honeycomb structure to define cells. The honeycomb fired bodies include a center-portion honeycomb fired body located in a center portion and a peripheral-portion honeycomb fired body located in a peripheral portion in a cross section perpendicular to the longitudinal direction of the honeycomb structure. A shape of the center-portion honeycomb fired body is a substantially rectangular shape in the cross section. An area of the center-portion honeycomb fired body is at least about 900 mm² and at most about 2500 mm² in the cross section. A shape of the peripheral-portion honeycomb fired body is different from the shape of the center-portion honeycomb fired body in the cross section. An area of the peripheral-portion honeycomb fired body is at least about 0.9 times and at most about 1.3 times larger than the area of the center-portion honeycomb fired body in the cross section.

According to another aspect of the present invention, a honeycomb structure includes a ceramic block. In the ceramic block, a plurality of honeycomb fired bodies are combined with one another with an adhesive layer interposed therebetween and each of the honeycomb fired bodies has cell walls extending along a longitudinal direction of the honeycomb structure to define cells. A plurality of the honeycomb fired bodies include a center-portion honeycomb fired body located in a center portion of the ceramic block and a peripheral-portion honeycomb fired body forming a part of a peripheral side face of the ceramic block. An area of the center-portion honeycomb fired body is at least about 900 mm² and at most about 2500 mm² in a cross section perpendicular to the longitudinal direction. Provided that a figure, which is similar to a shape of the ceramic block in the cross section and is concentric with the shape of the ceramic block in the cross section, is drawn in the cross section with an area ratio of the figure being about 49% to the area of the ceramic block in the cross section, a part of the peripheral-portion honeycomb fired body is located in the figure.

According to further aspect of the present invention, a honeycomb structure includes a plurality of honeycomb fired bodies that are combined with one another with an adhesive layer interposed therebetween. Each of the honeycomb fired bodies has cell walls extending along a longitudinal direction of the honeycomb structure to define cells. The honeycomb structure includes a peripheral portion forming a peripheral side face of the honeycomb structure; and a center portion having a substantially rectangular shape located at the inner side of the peripheral portion in a cross section perpendicular to the longitudinal direction of the honeycomb structure. The peripheral portion includes a plurality of peripheral-portion honeycomb fired bodies combined with one another with the adhesive layer interposed therebetween. The center portion includes one center-portion honeycomb fired body or a plurality of center-portion honeycomb fired bodies combined with one another with the adhesive layer interposed therebetween. The honeycomb structure includes at least one of the adhesive layers in the peripheral portion formed in a direction extending from a corner point of the center portion to the peripheral side face of the honeycomb structure in the cross section. The adhesive layer extending from the corner point of the center portion to the peripheral side face of the honeycomb structure forms an angle of at least about 40° and at most about 50° with at least one adhesive layer formed in a direction extending from the center portion other than the corner points thereof to the peripheral side face of the honeycomb structure.

According to the other aspect of the present invention, a honeycomb structure includes a ceramic block. In the ceramic block, a plurality of honeycomb fired bodies are combined with one another with an adhesive layer interposed therebetween, and each of the honeycomb fired bodies has cell walls extending along a longitudinal direction of the honeycomb structure to define cells. An area of the honeycomb fired body is at least about 900 mm² and at most about 2500 mm² in a cross section perpendicular to the longitudinal direction. An area of the ceramic block is at least about 10000 mm² and at most about 55000 mm² in the cross section. A number of the adhesive layers existing on a route which passes through the honeycomb fired bodies and extends from a center of gravity of the ceramic block to a periphery of the ceramic block in the cross section is two or less in a case that the area of the ceramic block in the cross section is about 10000 mm² or more and less than 25000 mm², three or less in a case that the area of the ceramic block in the cross section is 25000 mm² or more and less than 40000 mm², and four or less in a case that the area of the ceramic block in the cross section is 40000 mm² or more and about 55000 mm² or less.

According to yet the other aspect of the present invention, a honeycomb structure includes a ceramic block. In the ceramic block, a plurality of honeycomb fired bodies are combined with one another with an adhesive layer interposed therebetween, and each of the honeycomb fired bodies has cell walls extending along a longitudinal direction of the honeycomb structure to define cells. An area of the honeycomb fired body is at least about 900 mm² and at most about 2500 mm² in a cross section perpendicular to the longitudinal direction. An area of the ceramic block is at least about 10000 mm² and at most about 55000 mm² in the cross section. A number of the adhesive layers existing on a route which passes through the honeycomb fired bodies and extends from a center of gravity of the ceramic block to a periphery of the ceramic block in the cross section is two or less in a case that the area of the ceramic block in the cross section is about 10000 mm² or more and less than 25000 mm². The number of the adhesive layers is three or less in a case that the area of the ceramic block in the cross section is 25000 mm² or more and less than 40000 mm². The number of the adhesive layers is four or less in a case that the area of the ceramic block in the cross section is 40000 mm² or more and about 55000 mm² or less.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a perspective view schematically showing a honeycomb structure according to the first embodiment of the first invention.

FIG. 2A is a perspective view schematically showing a center-portion honeycomb fired body in the honeycomb structure according to the first embodiment of the first invention, and FIG. 2B is an A-A line cross-sectional view of the honeycomb fired body shown in FIG. 2A.

FIG. 3 is a perspective view schematically showing a peripheral-portion honeycomb fired body according to the first embodiment of the first invention.

FIG. 4 is a cross-sectional view of a honeycomb structure manufactured in Example 1-1.

FIG. 5 is a cross-sectional view of a honeycomb structure manufactured in Comparative Example 1-1.

FIG. 6 is a cross-sectional view of a honeycomb structure according to the second embodiment of the first invention.

FIGS. 7A and 7B are cross-sectional views for describing another example of a method for manufacturing a honeycomb structure according to the third embodiment of the first invention.

FIG. 8 is a cross-sectional view of a honeycomb structure according to another embodiment of the first invention.

FIG. 9 is a cross-sectional view of a honeycomb structure according to another embodiment of the first invention.

FIG. 10 is a cross-sectional view of a honeycomb structure according to another embodiment of the first invention.

FIG. 11 is a perspective view schematically showing a honeycomb structure according to the first embodiment of the second invention.

FIG. 12 is a cross-sectional view of a honeycomb structure manufactured in Example 2-1.

FIG. 13 is a cross-sectional view of a honeycomb structure manufactured in Comparative Example 2-1.

FIG. 14 is a cross-sectional view of a honeycomb structure according to the second embodiment of the second invention.

FIGS. 15A and 15B are cross-sectional views of the honeycomb structure according to another embodiment of the second invention.

FIGS. 16A and 16B are cross-sectional views for describing another example of a method for manufacturing a honeycomb structure according to the embodiments of the second invention.

FIG. 17 is a perspective view schematically showing a honeycomb structure according to the first embodiment of the third invention.

FIG. 18 is an A-A line cross-sectional view of the honeycomb structure shown in FIG. 17.

FIG. 19 is a cross-sectional view of a honeycomb structure manufactured in Comparative Example 3-1.

FIG. 20 is a cross-sectional view of a honeycomb structure according to the second embodiment of the third invention.

FIG. 21 is a cross-sectional view of a honeycomb structure according to another embodiment of the third invention.

FIG. 22 is a perspective view schematically showing a honeycomb structure according to the first embodiment of the fourth invention.

FIG. 23 is an A-A line cross-sectional view of the honeycomb structure shown in FIG. 22.

FIG. 24 is a cross-sectional view of a honeycomb structure manufactured in Comparative Example 4-1.

FIG. 25 is a cross-sectional view of a honeycomb structure according to the second embodiment of the fourth invention.

FIG. 26 is a cross-sectional view of a honeycomb structure manufactured in Comparative Example 4-2.

FIG. 27 is a cross-sectional view of a honeycomb structure according to the third embodiment of the fourth invention.

FIGS. 28A and 28B are cross-sectional views for describing another example of a method for manufacturing a honeycomb structure according to the third embodiment of the fourth invention.

FIG. 29 is a cross-sectional view of a honeycomb structure manufactured in Comparative Example 4-3.

### DESCRIPTION OF THE EMBODIMENTS

Embodiments will now be described with reference to the accompanying drawings, wherein like reference numerals designate corresponding or identical elements throughout the various drawings.

Upon using a honeycomb structure as an exhaust-gas purifying filter, a high-temperature exhaust gas discharged from an internal combustion engine flows into cells of the honeycomb structure. At this time, since much heat is applied to a honeycomb fired body located in the center portion, temperature of the honeycomb fired body located in the center portion tends to easily increase in comparison with that of the honeycomb fired body located in the peripheral portion.

Moreover, in the honeycomb structure having a plurality of honeycomb fired bodies combined with one another with an adhesive layer interposed therebetween (hereinafter, also referred to as an aggregated honeycomb structure), since normally the thermal conductivity of the adhesive layer is inferior to the thermal conductivity of the honeycomb fired bodies, the thermal conduction is easily intervened by the adhesive layer. Consequently, a great temperature difference tends to be caused between the center portion and the peripheral portion in the aggregated honeycomb structure.

In particular, in the honeycomb structures disclosed in WO01/23069A1, JP-A 2004-154718 and WO04/96414A1, the honeycomb fired bodies, each having a sufficiently smaller cross-sectional area than that of the honeycomb fired bodies in the center portion, are located in the peripheral portion, and since the presence of these honeycomb fired bodies having a smaller cross-sectional area located in the peripheral portion causes an increase in the ratio of occupation of the adhesive layer, the temperature difference between the center portion and the peripheral portion tends to become greater.

In the case when the temperature difference between the center portion and the peripheral portion of the honeycomb structure increases, upon carrying out a regenerating process on the honeycomb structure for burning and removing particulates, unburned particulates tend to remain in the peripheral portion of the honeycomb structure.

Upon using the honeycomb structure as an exhaust-gas purifying filter, it is required to hold the honeycomb structure in a predetermined casing with a holding sealing material. In order to prevent displacement of the honeycomb structure in the casing or to prevent coming off of a part of the honeycomb fired bodies from the honeycomb structure due to the exhaust gases, it is required to surely secure the honeycomb structure in the casing. Thus, the honeycomb structure preferably has high strength for preventing damages due to compressive stress applied from the outside of the honeycomb structure.

In the honeycomb structure disclosed in WO01/23069A1, JP-A 2004-154718 and WO04/96414A1, the adhesive layers are formed into a grid pattern. Thus, the honeycomb structure has high strength to compressive stress applied from a predetermined direction (a direction parallel to the adhesive layer), but has low strength to compressive stress applied from another direction, for example a direction which makes about 45° with the adhesive layer, and the honeycomb structure tends to be damaged due to the compressive stress from the direction.

Moreover, in the honeycomb structure disclosed in WO01/23069A1, JP-A 2004-154718 and WO04/96414A1, each of the adhesive layers crosses one another at right angles. Thus, the honeycomb structure tends to fail to spread stress generated in the honeycomb structure and the honeycomb structure tends to be damaged.

The inventors of the present invention have made eager investigations to solve the above problems.

A honeycomb structure according to an embodiment of the first aspect of the present invention includes: a plurality of honeycomb fired bodies that are combined with one another with an adhesive layer interposed therebetween, each of the honeycomb fired bodies having a large number of cells that are placed in parallel with one another in a longitudinal direction with a cell wall interposed therebetween,

wherein

the honeycomb fired bodies include a center-portion honeycomb fired body located in a center portion and a peripheral-portion honeycomb fired body located in a peripheral portion in a cross section perpendicular to the longitudinal direction of the honeycomb structure, a shape of the center-portion honeycomb fired body is a substantially rectangular shape in the cross section,

an area of the center-portion honeycomb fired body is at least about 900 mm² and at most about 2500 mm² in the cross section,

a shape of the peripheral-portion honeycomb fired body is different from the shape of the center-portion honeycomb fired body in the cross section, and

an area of the peripheral-portion honeycomb fired body is at least about 0.9 times and at most about 1.3 times larger than the area of the center-portion honeycomb fired body in the cross section.

In the honeycomb structure according to the embodiment of the first aspect of the present invention, out of the plurality of the honeycomb fired bodies combined with one another with the adhesive layer interposed therebetween, the peripheral-portion honeycomb fired body has the area at least about 0.9 times and at most about 1.3 times larger than the area of the center-portion honeycomb fired body in the cross section. Therefore, since no honeycomb fired body having an extremely small cross-sectional area is located in the peripheral portion of the honeycomb structure and since the adhesive layer to be used for combining such small honeycomb fired bodies with one another is not required, the honeycomb structure tends not to have a temperature distribution between the center portion and the peripheral portion, and unburned particulates tend not to remain upon carrying out the regenerating process.

Further, since the area of the peripheral-portion honeycomb fired body is about 0.9 times or more larger than the area of the center-portion honeycomb fired body in the cross section, a temperature distribution tends not to occur between the honeycomb fired body located in the center portion and that located in the peripheral portion, and unburned particulates tend not to remain upon carrying out the regenerating process.

Moreover, since the area of the peripheral-portion honeycomb fired body is up to about 1.3 times larger than the area of the center-portion honeycomb fired body in the cross section, cracks tend not to occur in the honeycomb fired body due to thermal stress.

Furthermore, in the honeycomb structure according to the embodiment of the first aspect of the present invention, the area of the center-portion honeycomb fired body is at least about 900 mm² and at most about 2500 mm² in the cross section. The reason for this structure is described as follows.

In the case that the cross-sectional area of the center-portion honeycomb fired body is about 900 mm² or more, an amount of adhesive for forming the honeycomb structure tends not to become large, with the result that a temperature distribution tends not to occur in the honeycomb structure and cracks tend not to occur in the honeycomb fired body upon carrying out a regenerating process.

In contrast, in the case that the cross-sectional area of the center-portion honeycomb fired body is about 2500 mm² or less, the effect of the adhesive layer for alleviating the thermal stress is sufficient and cracks tend not to occur in the honeycomb fired body. That is, the cross-sectional area of the center-portion honeycomb fired body maintained within the above range is suitable for preventing the occurrence of cracks in the honeycomb fired body upon carrying out the regenerating process.

In the honeycomb structure according to the embodiment of the first aspect of the present invention, the shape of the peripheral-portion honeycomb fired body is preferably formed into a shape surrounded by three line segments and one arc or elliptical arc in the cross section, and

two angles made by the two line segments out of the three line segments are a substantially right angle and an obtuse angle.

In the case that the peripheral-portion honeycomb fired body has the shape of this kind, the size of the peripheral-portion honeycomb fired body in the cross section tends not to be extremely small in comparison with that of the center-portion honeycomb fired body. Therefore, the honeycomb structure tends not to have a temperature distribution between the center portion and the peripheral portion, and unburned particulates tend not to remain upon carrying out the regenerating process.

A honeycomb structure according to an embodiment of the second aspect of the present invention having a substantially round pillar-shape or substantially cylindroid shape includes:

a ceramic block in which
a plurality of honeycomb fired bodies are combined with one another with an adhesive layer interposed therebetween, and
each of the honeycomb fired bodies has a large number of cells that are placed in parallel with one another in a longitudinal direction with a cell wall interposed therebetween,

wherein

a plurality of the honeycomb fired bodies include a center-portion honeycomb fired body located in a center portion of the ceramic block and a peripheral-portion honeycomb fired body forming a part of a peripheral side face of the ceramic block,

an area of the center-portion honeycomb fired body is at least about 900 mm² and at most about 2500 mm² in a cross section perpendicular to the longitudinal direction, and

provided that a figure, which is similar to the shape of the ceramic block in the cross section and is concentric with the shape of the ceramic block in the cross section, is drawn in the cross section with an area ratio of the figure being about 49% to the area of the ceramic block in the cross section, a part of the peripheral-portion honeycomb fired body is located in the figure.

In the honeycomb structure according to the embodiment of the second aspect of the present invention, the plurality of the honeycomb fired bodies are combined with one another with the adhesive layer interposed therebetween, and the plurality of the honeycomb fired bodies include the center-portion honeycomb fired body and the peripheral-portion honeycomb fired body.

In the honeycomb structure, provided that a figure, which is similar to the shape of the ceramic block in the cross section and is concentric with the shape of the ceramic block in the cross section, is drawn in the cross section with an area ratio of the figure being about 49% to the area of the ceramic block in the cross section, a part of the peripheral-portion honeycomb fired body is located in the figure.

In the structure of this kind, in the cross section perpendicular to the longitudinal direction of the honeycomb structure including the center-portion honeycomb fired body and the peripheral-portion honeycomb fired body, since there is no peripheral-portion honeycomb fired body which is located only outside the figure, the honeycomb structure tends not to have a temperature distribution between the center portion and the peripheral portion, and unburned particulates tend not to remain.

As mentioned above, temperature of the center-portion honeycomb fired body tends to increase more easily than that of the peripheral-portion honeycomb fired body in the honeycomb structure.

When a part of each of the peripheral-portion honeycomb fired bodies is located in the figure, heat tends to be transferred to the peripheral-portion honeycomb fired bodies, and thus, unburned particulates tend not to remain.

On the other hand, when a part of each of the peripheral-portion honeycomb fired bodies is not located in the figure (each of the honeycomb fired bodies is located only outside the figure), the honeycomb structure tends to have a temperature distribution between the center portion and the peripheral portion, and unburned particulates tends to remain as mentioned above.

Furthermore, in the honeycomb structure according to the embodiment of the second aspect of the present invention, the area of the center-portion honeycomb fired body is at least about 900 mm² and at most about 2500 mm² in the cross section. The reason for this structure is described as follows.

In the case that the cross-sectional area of the center-portion honeycomb fired body is about 900 mm² or more, an amount of adhesive for forming the honeycomb structure tends not to become large, with the result that a temperature distribution tends not to occur in the honeycomb structure and cracks tend not to occur in the honeycomb fired body upon carrying out a regenerating process.

In contrast, in the case that the cross-sectional area of the center-portion honeycomb fired body is about 2500 mm² or less, the effect of the adhesive layer for alleviating the thermal stress is sufficient and cracks tend not to occur in the honeycomb fired body. That is, the cross-sectional area of the center-portion honeycomb fired body maintained within the above range is suitable for preventing the occurrence of cracks in the honeycomb fired body upon carrying out the regenerating process.

A honeycomb structure according to an embodiment of the second aspect of the present invention preferably has a substantially round pillar-shape or a substantially cylindroid shape.

A honeycomb structure according to an embodiment of the third aspect of the present invention includes: a plurality of honeycomb fired bodies that are combined with one another with an adhesive layer interposed therebetween, each of the honeycomb fired bodies having a large number of cells that are placed in parallel with one another in a longitudinal direction with a cell wall interposed therebetween,

wherein

the honeycomb structure includes: a peripheral portion forming a peripheral side face of the honeycomb structure; and a center portion having a substantially rectangular shape located at the inner side of the peripheral portion in a cross section perpendicular to the longitudinal direction of the honeycomb structure,

the peripheral portion includes a plurality of peripheral-portion honeycomb fired bodies combined with one another with the adhesive layer interposed therebetween,

the center portion includes one center-portion honeycomb fired body or a plurality of center-portion honeycomb fired bodies combined with one another with the adhesive layer interposed therebetween,

the honeycomb structure includes at least one of the adhesive layers in the peripheral portion formed in a direction extending from a corner point of the center portion to the peripheral side face of the honeycomb structure in the cross section, and

the adhesive layer extending from the corner point of the center portion to the peripheral side face of the honeycomb structure forms an angle of at least about 40° and at most about 50° with at least one adhesive layer formed in a direction extending from the center portion other than the corner points thereof to the peripheral side face of the honeycomb structure.

With respect to the honeycomb structure according to the embodiment of the third aspect of the present invention, of the adhesive layers in the peripheral portion, the adhesive layer formed in a direction extending from a corner point of the center portion to the peripheral side face of the honeycomb structure is also referred to as a “first peripheral-portion adhesive layer”, and the adhesive layer formed in a direction extending from the center portion other than the corner points thereof to the peripheral side face of the honeycomb structure is also referred to as a “second peripheral-portion adhesive layer”, hereinafter.

Also with respect to the honeycomb structure according to the embodiment of the third aspect of the present invention, the center portion in the cross section perpendicular to the longitudinal direction of the honeycomb structure is the area occupied by: the center-portion honeycomb fired body; the adhesive layer combining the center-portion honeycomb fired bodies with one another; and the adhesive layer combining the center-portion honeycomb fired body with the peripheral-portion honeycomb fired body.

Furthermore, the peripheral portion in the cross section perpendicular to the longitudinal direction of the honeycomb structure is the area occupied by: the peripheral-portion honeycomb fired bodies; and the adhesive layer combining the peripheral-portion honeycomb fired bodies with one another.

The honeycomb structure according to the embodiment of the third aspect of the present invention has the center portion and the peripheral portion, and in the peripheral portion located outside the center portion, the plurality of the peripheral-portion honeycomb fired bodies forming a part of the peripheral side face of the honeycomb structure are combined with one another with the adhesive layer interposed therebetween.

Of the adhesive layers interposed between the peripheral-portion honeycomb fired bodies in the cross section perpendicular to the longitudinal direction of the honeycomb structure, the angle formed by the adhesive layer extending from the corner point of the center portion to the peripheral side face of the honeycomb structure (the first peripheral-portion adhesive layer) and at least one adhesive layer formed in a direction extending from the center portion other than the corner points thereof to the peripheral side face of the honeycomb structure (the second peripheral-portion adhesive layer) is at least about 40° and at most about 50°.

Thus, it is easier to prevent the honeycomb structure from being damaged due to compressive stress applied from the outside of the honeycomb structure.

Further, since the first peripheral-portion adhesive layer extends from the corner point of the center portion to the peripheral side face of the honeycomb structure, two adhesive layers existing between the center-portion honeycomb fired body and the peripheral-portion honeycomb fired body and the first peripheral-portion adhesive layer form a Y shape in the corner point of the center portion.

As mentioned above, in the case that there is the Y-shape portion of the adhesive layer in the cross section perpendicular to the longitudinal direction of the honeycomb structure, it is easier to prevent the honeycomb structure from being damaged.

In the honeycomb structure according to the embodiment of the third aspect of the present invention, the angle formed by the first peripheral-portion adhesive layer and the second peripheral-portion adhesive layer means the angle formed by the straight line passing through the inside of the first peripheral-portion adhesive layer and the straight line passing through the inside of the second peripheral-portion adhesive layer.

In the honeycomb structure according to the embodiment of the third aspect of the present invention, preferably, the center portion includes a plurality of the center-portion honeycomb fired bodies combined with one another with the adhesive layer interposed therebetween, and

in the cross section perpendicular to the longitudinal direction of the honeycomb structure, at least one adhesive layer, which is disposed between the peripheral-portion honeycomb fired bodies and formed in a direction extending from the center portion other than the corner points thereof to the peripheral side face of the honeycomb structure, forms a substantially straight line with at least one adhesive layer disposed between the center-portion honeycomb fired bodies.

The adhesive layer of this kind is more likely to play a role as, so as to say, a beam for improving strength of the honeycomb structure.

A honeycomb structure according to an embodiment of the fourth aspect of the present invention includes:

a ceramic block in which
a plurality of honeycomb fired bodies are combined with one another with an adhesive layer interposed therebetween, and
each of the honeycomb fired bodies has a large number of cells that are placed in parallel with one another in a longitudinal direction with a cell wall interposed therebetween,

wherein

an area of the honeycomb fired body is at least about 900 mm² and at most about 2500 mm² in a cross section perpendicular to the longitudinal direction,

an area of the ceramic block is at least about 10000 mm² and at most about 55000 mm² in the cross section, and

the number of the adhesive layers existing on a route which passes through the honeycomb fired bodies and extends from the center of gravity of the ceramic block to the periphery of the ceramic block in the cross section is:
two or less in the case that the area of the ceramic block in the cross section is about 10000 mm² or more and less than 25000 mm²,
three or less in the case that the area of the ceramic block in the cross section is 25000 mm² or more and less than 40000 mm², and
four or less in the case that the area of the ceramic block in the cross section is 40000 mm² or more and about 55000 mm² or less.

With respect to the honeycomb structure according to the embodiment of the fourth aspect of the present invention, in the case that the center of gravity is on the adhesive layer upon counting the number of adhesive layers which exist on the route extending from the center of gravity of the ceramic block to the periphery of the ceramic block, the adhesive layer on which the center of gravity exists is counted as one of adhesive layers existing on the route.

Also with respect to the honeycomb structure according to the embodiment of the fourth aspect of the present invention, upon counting the number of adhesive layers which exist on the route extending from the center of gravity of the ceramic block to the periphery of the ceramic block, the route is decided so as to pass through the smallest number of the adhesive layers.

The honeycomb structure according to the embodiment of the fourth aspect of the present invention includes the ceramic block in which the plurality of the honeycomb fired bodies are combined with one another with the adhesive layer interposed therebetween, and in the honeycomb structure, the area of the honeycomb fired body is about 900 mm² and at most about 2500 mm² in the cross section, and the area of the ceramic block is at least about 10000 mm² and at most about 55000 mm² in the cross section.

In the honeycomb structure of this kind, since the cross-sectional area of the ceramic block and the number of the adhesive layers which exist on the route extending from the center of gravity of the ceramic block to the periphery of the ceramic block in the cross section perpendicular to the longitudinal direction of the honeycomb structure satisfy the above-mentioned relationships, the honeycomb structure is allowed to exert the following effects:

the adhesive layer easily alleviates thermal stress, and thus, it is possible to prevent occurrence of cracks and damages on the honeycomb structure; and

the honeycomb structure tends not to have a temperature distribution between the center portion and the peripheral portion of the honeycomb structure, and thus, unburned particulates tend not to remain.

That is, in the honeycomb structure according to the embodiment of the fourth aspect of the present invention, since the route extending from the center portion to the peripheral portion of the honeycomb structure (main route of heat transfer) is decided so as to pass through the adhesive layers as small in number as possible, and the honeycomb structure tends not to impair a function to alleviate thermal stress of the adhesive layer, heat is easily transferred from the center portion to the peripheral portion of the honeycomb structure, and thus, the honeycomb structure tends not to have a temperature distribution between the center portion and the peripheral portion. Moreover, it is easier to prevent occurrence of damages and cracks in the honeycomb structure.

In the honeycomb structure according to the embodiment of the fourth aspect of the present invention, the ceramic block preferably has a substantially round shape in the cross section.

The following effect is allowed to be exerted particularly in the case that the ceramic block has a substantially round shape in the cross section, that is, the honeycomb structure tends not to have a temperature distribution between the center portion and the peripheral portion when the cross-sectional area of the ceramic block and the number of the adhesive layers which exist on the route extending from the center of gravity of the ceramic block to the periphery of the ceramic block in the cross section of the honeycomb structure satisfy the above-mentioned relationships.

This is because, although the peripheral portion of the honeycomb block tends to include a honeycomb fired body having a small cross-sectional area in the case that the honeycomb block has a substantially round cross-sectional shape, the honeycomb structure satisfying the above relationships easily avoids the tendency of this kind.

In the present description, the cross section perpendicular to the longitudinal direction of the honeycomb structure, the cross section perpendicular to the longitudinal direction of the ceramic block, the cross section perpendicular to the longitudinal direction of the honeycomb fired body, and the cross section perpendicular to the longitudinal direction of the honeycomb molded body may be simply referred to as the cross section of a honeycomb structure, the cross section of a ceramic block, the cross section of a honeycomb fired body, and the cross section of a honeycomb molded body.

Moreover, in the present description, the cross-sectional area of a honeycomb structure, the cross-sectional area of a ceramic block, the cross-sectional area of a honeycomb fired body, and the cross-sectional area of a honeycomb molded body may be simply referred to as the cross-sectional area perpendicular to the longitudinal direction of the honeycomb structure, the cross-sectional area perpendicular to the longitudinal direction of the ceramic block, the cross-sectional area perpendicular to the longitudinal direction of the honeycomb fired body, and the cross-sectional area perpendicular to the longitudinal direction of the honeycomb molded body.

In the present description, the center-portion honeycomb fired body refers to a honeycomb fired body that does not form the periphery of the honeycomb structure in the cross section perpendicular to the longitudinal direction of the honeycomb structure, and the peripheral-portion honeycomb fired body refers to a honeycomb fired body that forms the periphery of the honeycomb structure in the cross section perpendicular to the longitudinal direction of the honeycomb structure.

Here, in the case that a coat layer is formed on the honeycomb structure as will be described later, the peripheral-portion honeycomb fired body refers to a honeycomb fired body that forms the periphery of a ceramic block.

As mentioned above, the honeycomb fired bodies used for forming the honeycomb structure according to each of the embodiments of the first to third aspects of the present invention are distinguished as the center-portion honeycomb fired bodies and the peripheral-portion honeycomb fired bodies.

However, in the present description, when the two kinds of honeycomb fired bodies are not particularly required to be distinguished, each of these is simply referred to as the honeycomb fired body.

Referring to the drawings, the following description will discuss an embodiment of a honeycomb structure according to the first aspect of the present invention.

### First Embodiment of First Aspect of the Present Invention

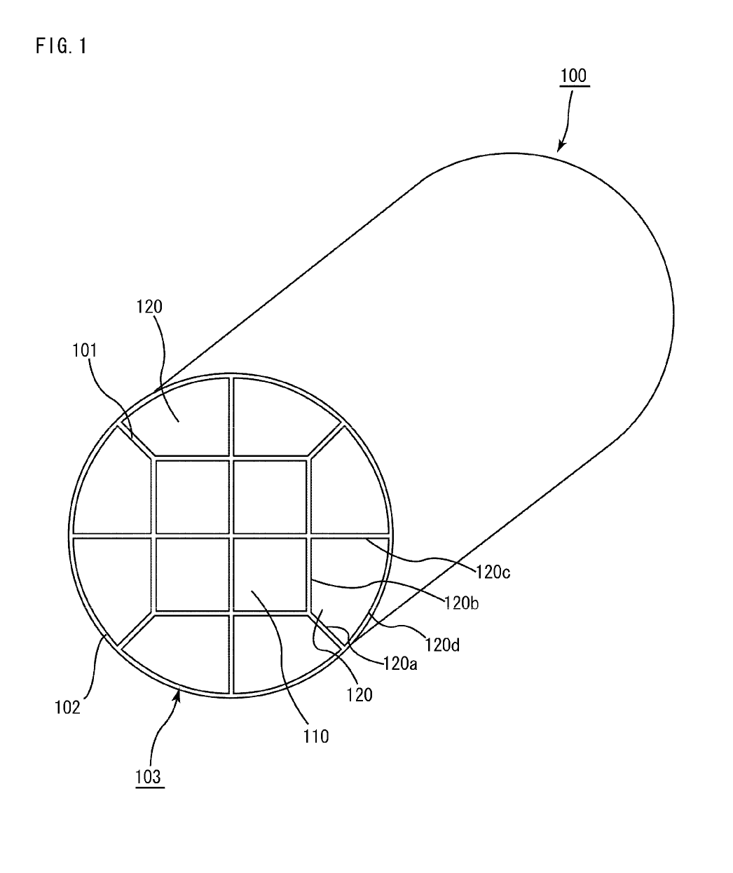

FIG. 1 is a perspective view schematically showing a honeycomb structure according to the first embodiment of the first aspect of the present invention.

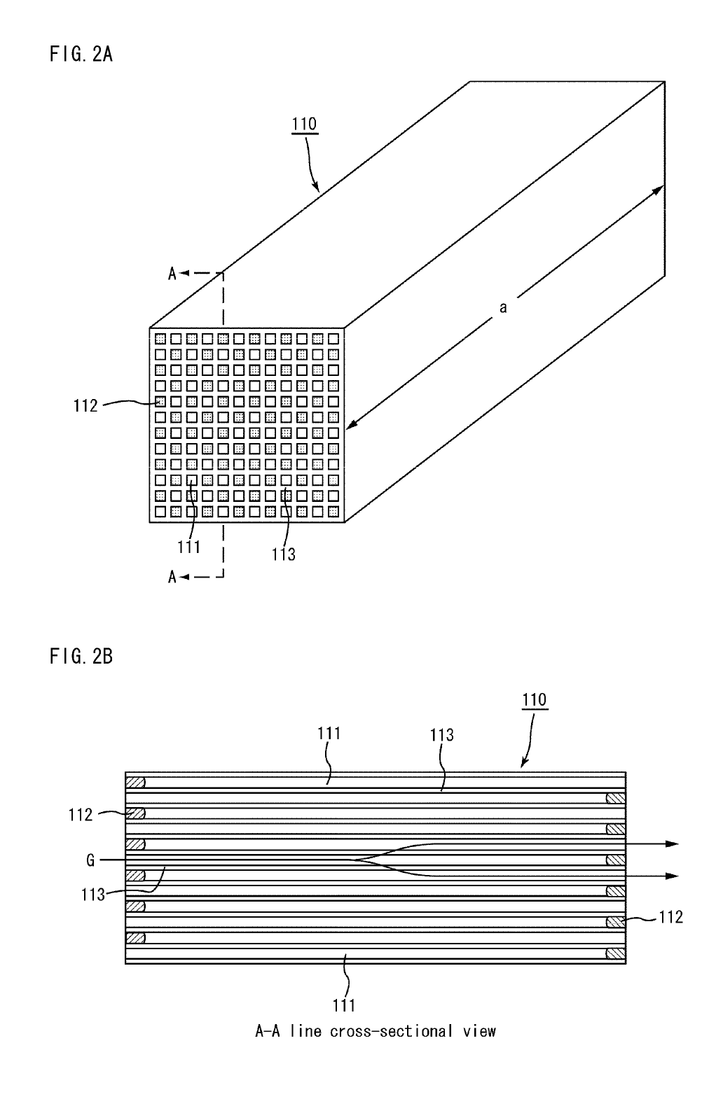

FIG. 2A is a perspective view schematically showing a center-portion honeycomb fired body in the honeycomb structure according to the first embodiment of the first aspect of the present invention and FIG. 2B is an A-A line cross-sectional view of the honeycomb fired body shown in FIG. 2A.

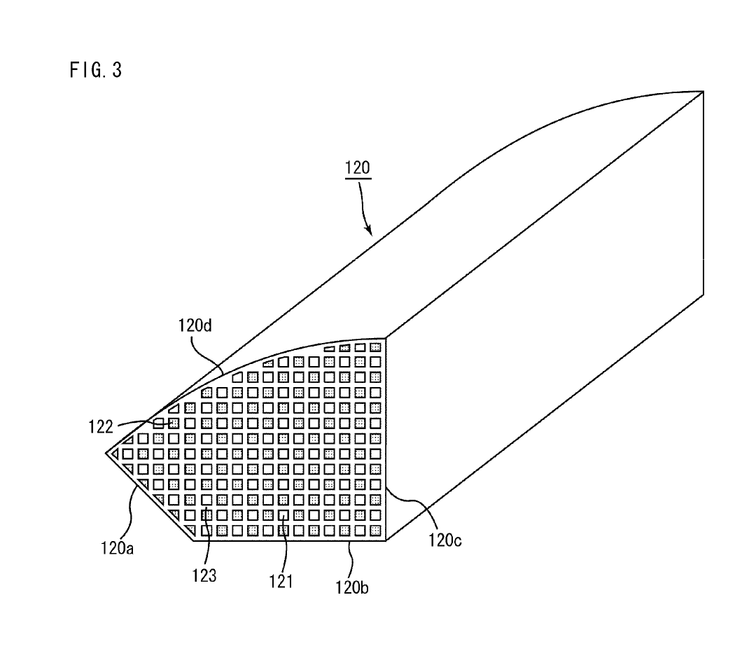

FIG. 3 is a perspective view schematically showing a peripheral-portion honeycomb fired body according to the first embodiment of the first aspect of the present invention.

In a honeycomb structure 100 shown in FIG. 1, a plurality of center-portion honeycomb fired bodies 110 having a shape shown in FIGS. 2A and 2B and a plurality of peripheral-portion honeycomb fired bodies 120 having a shape shown in FIG. 3 are combined with one another, with an adhesive layer 101 interposed therebetween, to form a ceramic block 103. A coat layer 102 is further formed on the periphery of the ceramic block 103.

The shape of the cross section of each of the center-portion honeycomb fired bodies 110 is a substantially square shape.

The shape of the cross section of each of the peripheral-portion honeycomb fired bodies 120 is formed into a shape surrounded by three line segments 120a, 120b and 120c and an arc 120d. The two angles made by two line segments out of these three line segments (an angle made by the line segments 120b and 120c and an angle made by the line segments 120a and 120b) are about 90° and about 135°.

The honeycomb fired bodies 110 and 120 include porous silicon carbide sintered bodies.

The center-portion honeycomb fired body 110 shown in FIGS. 2A and 2B has a structure in which a large number of cells 111 are longitudinally placed (the direction indicated by an arrow a in FIG. 2A) in parallel with one another with a cell wall 113 therebetween, the cells 111 having either one of the ends sealed with a plug 112. Therefore, exhaust gas G having flown into one cell 111 with an opening on one end face (see an arrow in FIG. 2B) flow out from another cell 111 with an opening on the other end face after having always passed through the cell wall 113 that separates the cells 111.

Therefore, the cell wall 113 functions as a filter for capturing PM and the like.

In the same manner as in the center-portion honeycomb fired body 110, the peripheral-portion honeycomb fired body 120 shown in FIG. 3 has a structure in which a large number of cells 121 are longitudinally placed in parallel with one another with a cell wall 123 therebetween, and the cells 121 having either one of the ends sealed with a plug 122. Therefore, exhaust gas having flown into one cell 121 with an opening on one end face flows out from another cell 121 with an opening on the other end face after having always passed through a cell wall 123 that separates the cells 121.

That is, although the outer shape of the peripheral-portion honeycomb fired body 120 is different from that of the center-portion honeycomb fired body 110, the peripheral-portion honeycomb fired body 120 has the same functions as those of the center-portion honeycomb fired body 110.

As shown in FIG. 1, in the honeycomb structure 100, four pieces of the center-portion honeycomb fired bodies 110 are located in the center portion of the cross section of the honeycomb structure 100, and eight pieces of the peripheral-portion honeycomb fired bodies 120 are located on the periphery of the four pieces of the center-portion honeycomb fired bodies 110. These honeycomb fired bodies are combined with one another with the adhesive layer 101 interposed therebetween so that the cross section of the honeycomb structure 100 (ceramic block 103) is formed into a substantially round shape.

In the honeycomb structure 100, the shape of the cross section of the peripheral-portion honeycomb fired body 120 is different from that of the center-portion honeycomb fired body 110, and the cross-sectional area of the peripheral-portion honeycomb fired body 120 is at least about 0.9 times and at most about 1.3 times larger than that of the center-portion honeycomb fired body 110.

Therefore, no honeycomb fired bodies having an extremely small cross-sectional area are located in the peripheral portion of the honeycomb structure 100, and of course, an adhesive layer to be used for combining such small honeycomb fired bodies with one another is not required. For this reason, the honeycomb structure 100 tends not to have a temperature distribution between the center portion and the peripheral portion, and unburned particulates tend not to remain upon carrying out the regenerating process.

As mentioned above, the cross section of the peripheral-portion honeycomb fired body 120 is formed into the shape surrounded by the three line segments 120a, 120b and 120c and an arc 120d. The two angles made by two line segments out of these three line segments (an angle made by the line segments 120b and 120c and an angle made by the line segments 120a and 120b) are about 90° and about 135°. The fact that the shape of the peripheral-portion honeycomb fired body 120 is formed into this shape is also one reason why no honeycomb fired body having an extremely small cross-sectional area is located in the peripheral portion of the honeycomb structure 100.

Moreover, in the honeycomb structure 100, the cross-sectional area of the center-portion honeycomb fired body 110 is at least about 900 mm² and at most about 2500 mm².

By setting the cross-sectional area of the center-portion honeycomb fired body 110 to such a size, it becomes easier to prevent cracks from occurring in the honeycomb structure 100 upon carrying out a regenerating process on the honeycomb structure 100.

The following description will discuss a method for manufacturing a honeycomb structure of the present embodiment.

(1) A molding process is carried out in which a wet mixture containing ceramic powders and a binder is extrusion-molded to manufacture a honeycomb molded body.

More specifically, first, as ceramic powders, silicon carbide powders each having a different average particle diameter, an organic binder, a liquid-state plasticizer, a lubricant and water are mixed to prepare a wet mixture used for manufacturing a honeycomb molded body.

Successively, this wet mixture is charged into an extrusion molding apparatus. When the wet mixture is charged into the extrusion molding apparatus, the wet mixture is extrusion-molded into a honeycomb molded body having a predetermined shape.

In order to manufacture a honeycomb molded body having a variety of cross-sectional shapes, extrusion-molding dies corresponding to the respective shapes are used. The variety of cross-sectional shapes include a square cross-sectional shape and a shape surrounded by three line segments and an arc, with the two angles (made by two line segments out of these three line segments) being about 90° and about 135°.

(2) Next, the honeycomb molded body thus formed is cut into a predetermined length, and undergoes a drying process by using a drying apparatus, such as a microwave drying apparatus, a hot-air drying apparatus, a dielectric drying apparatus, a reduced-pressure drying apparatus, a vacuum drying apparatus and a freeze drying apparatus. Then, this dried honeycomb molded body undergoes a sealing process in which predetermined cells are filled with a plug material paste to be formed into plugs to seal the cells.

Here, with respect to the conditions of the cutting process, drying process and sealing process, those conditions conventionally used upon manufacturing a honeycomb fired body can be adopted.

(3) Next, the honeycomb molded body undergoes a degreasing process in which the organic substances therein are heated in a degreasing furnace, and is then transported to a firing furnace, and undergoes a firing process therein to manufacture a honeycomb fired body.

Here, with respect to the conditions of the degreasing process and firing process, those conditions conventionally used upon manufacturing a honeycomb fired body can be adopted.

By carrying out the above-mentioned processes, the center-portion honeycomb fired body and the peripheral-portion honeycomb fired body are manufactured.

(4) Next, an adhesive paste was applied to a predetermined side surface of each of the center-portion honeycomb fired body and each of the peripheral-portion honeycomb fired body, with the predetermined end portion of each of the cells sealed, to form an adhesive paste layer. After this, another honeycomb fired body is piled up onto the above-mentioned adhesive paste layer sequentially. By carrying out the above process repeatedly, the combining process is carried out to manufacture a ceramic block in which a predetermined number of the honeycomb fired bodies are combined with one another.

With respect to the adhesive paste, the adhesive paste including an inorganic binder, an organic binder, and inorganic particles may be used, for example. Moreover, the adhesive paste may further include at least one of inorganic fibers and whiskers.

(5) Subsequently, a coat layer forming process is further carried out in which a coating material paste is applied to the periphery of the ceramic block formed into the substantially round pillar shape, and is dried and solidified to form a coat layer.

Here, the same paste as the adhesive paste may be used as the coating material paste. Alternatively, a paste having a different composition from the composition of the adhesive paste may be used as the coating material paste.

It is not necessarily required to form the coat layer, and the coat layer may be formed, on demand.

It is possible to manufacture the honeycomb structure of the present embodiment through the above-mentioned processes.

The following description will summarize the effects of the honeycomb structure of the present embodiment.

(1) In the honeycomb structure of the present embodiment, the cross-sectional shape of the peripheral-portion honeycomb fired body 120 is different from the cross-sectional shape of the center-portion honeycomb fired body 110, and the cross-sectional area of the peripheral-portion honeycomb fired body 120 is at least about 0.9 times and at most about 1.3 times larger than the cross-sectional area of the center-portion honeycomb fired body. Therefore, since no honeycomb fired body having an extremely small cross-sectional area is located in the peripheral portion of the honeycomb structure and since the adhesive layer to be used for combining such small honeycomb fired bodies with one another is not required, the honeycomb structure tends not to have a temperature distribution between the center portion and the peripheral portion, and unburned particulates tend not to remain upon carrying out the regenerating process.

(2) In the honeycomb structure of the present embodiment, the cross-sectional shape of the peripheral-portion honeycomb fired body is formed into a shape that is surrounded by three line segments and an arc. The two angles made by two line segments out of these three line segments are about 900 and about 135°. For this reason, it is possible to avoid the cross-sectional area of the peripheral-portion honeycomb fired body from becoming extremely small in comparison with the cross-sectional area of the center-portion honeycomb fired body. Moreover, the adhesive layer used for combining the honeycomb fired bodies having a small cross-sectional area with one another is not required. Therefore, the honeycomb structure tends not to have a temperature distribution between the center portion and the peripheral portion, and unburned particulates tend not to remain upon carrying out the regenerating process.

(3) In the honeycomb structure of the present embodiment, the cross-sectional area of the center-portion honeycomb fired body is at least about 900 mm² and at most about 2500 mm². For this reason, cracks tend not to occur in the honeycomb fired body upon carrying out a regenerating process.

(4) In the honeycomb fired body of the honeycomb structure of the present embodiment, either one end of each of the cells is sealed with a plug. Therefore, the honeycomb structure of the present embodiment is more likely to be suitably used as a diesel particulate filter.

(5) In the honeycomb structure of the present embodiment, since the coat layer is formed on the peripheral side face of the ceramic block, it is easier to prevent leakage of particulates from the peripheral side face of the honeycomb structure.

### Example 1-1

The following description will discuss examples that specifically disclose the first embodiment of the first aspect of the present invention. Here, the first aspect of the present invention is not limited to these examples.

(1) An amount of 52.8% by weight of a silicon carbide coarse powder having an average particle diameter of 22 μm and 22.6% by weight of a silicon carbide fine powder having an average particle diameter of 0.5 μm were mixed. To the resulting mixture, 2.1% by weight of an acrylic resin, 4.6% by weight of an organic binder (methylcellulose), 2.8% by weight of a lubricant (UNILUB, manufactured by NOF Corporation), 1.3% by weight of glycerin, and 13.8% by weight of water were added, and then kneaded to prepare a wet mixture. The obtained wet mixture was extrusion-molded.

In this process, there have been manufactured: a raw honeycomb molded body having approximately the same shape as that of the center-portion honeycomb fired body 110 illustrated in FIGS. 2A and 2B with cells not sealed; and a raw honeycomb molded body having approximately the same shape as that of the peripheral-portion honeycomb fired body 120 illustrated in FIG. 3 with cells not sealed.

(2) Next, the raw honeycomb molded bodies were dried by using a microwave drying apparatus to obtain dried honeycomb molded bodies. A paste having the same composition as that of the wet mixture was then filled into predetermined cells, and the filled portions of the dried honeycomb molded bodies were dried by using a drying apparatus again.

(3) The dried honeycomb molded bodies were degreased at 400° C., and then fired at 2200° C. under normal pressure argon atmosphere for three hours.

Thus, a center-portion honeycomb fired body 110 including a silicon carbide sintered body and having a porosity of 45%, an average pore diameter of 15 μm, a size of 34.3 mm×34.3 mm×150 mm, the number of cells (cell density) of 300 pcs/inch² and a thickness of cell walls of 0.25 mm (10 mil) was manufactured.

Also, a peripheral-portion honeycomb fired body 120 having the same porosity, the same average pore diameter, the same number of cells (cell density) and the same thickness of cell walls as those of the center-portion honeycomb fired body 110 and also having a cross-sectional shape surrounded by three line segments and an arc, with the two angles, made by two line segments out of these three line segments, being 90° and 135° (line segment 120a=20.8 mm, line segment 120b=35.0 mm, and line segment 120c=35.7 mm) was manufactured.

Here, the cross-sectional area of the center-portion honeycomb fired body 110 was 1190 mm² and the cross-sectional area of the peripheral-portion honeycomb fired body 120 was 1292 mm². Therefore, the cross-sectional area of the peripheral-portion honeycomb fired body 120 was 1.09 times larger than the cross-sectional area of the center-portion honeycomb fired body 110.

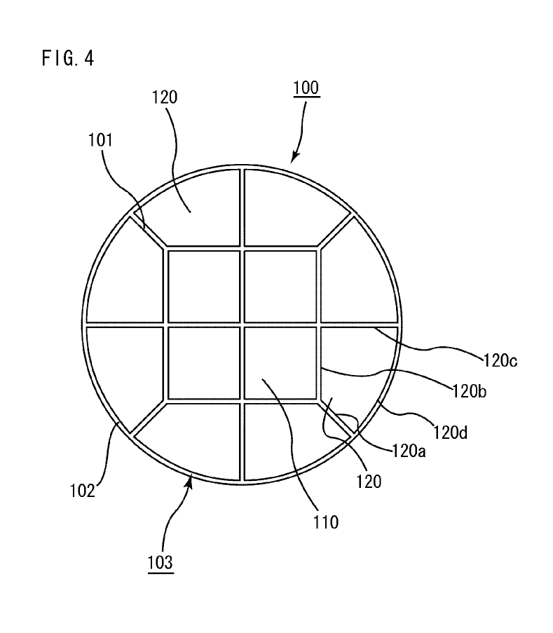

(4) An adhesive paste was applied to predetermined side faces of the center-portion honeycomb fired body 110 and the peripheral-portion honeycomb fired body 120, and four pieces of the center-portion honeycomb fired bodies 110 and eight pieces of the peripheral-portion honeycomb fired bodies 120 were bonded to one another with the adhesive paste interposed therebetween so as to be arranged as shown in FIG. 4. The adhesive paste was solidified at 180° C. in 20 minutes to manufacture a round pillar-shaped ceramic block 103 having the adhesive layer 1 mm in thickness.

Here, as the adhesive paste, an adhesive paste containing 30.0% by weight of silicon carbide particles having an average particle diameter of 0.6 μm, 21.4% by weight of silica sol, 8.0% by weight of carboxy methylcellulose and 40.6% by weight of water, was used.

(5) By using a coating material paste having the same composition as that of the adhesive paste used in the process (4), a coating material paste layer was formed on the periphery of the ceramic block 103. Thereafter, the coating material paste layer was dried at 120° C. to manufacture a round pillar-shaped honeycomb structure having a size of 143.8 mm in diameter×150 mm in length with a coat layer 102 formed on the periphery thereof.

The honeycomb structure 100 manufactured in Example 1 has a cross-sectional shape as shown in FIG. 4.

### Example 1-2

A honeycomb structure was manufactured in the same manner as in Example 1-1, except that the sizes of a center-portion honeycomb fired body 110 and a peripheral-portion honeycomb fired body 120, each manufactured through the processes (1) to (3) of Example 1-1, were changed to the below-mentioned sizes.

A center-portion honeycomb fired body 110 including a silicon carbide sintered body and having a porosity of 45%, an average pore diameter of 15 μm, a size of 36.7 mm×36.7 mm×150 mm, the number of cells (cell density) of 300 pcs/inch² and a thickness of cell walls of 0.25 mm (10 mil) was manufactured.

Also, a peripheral-portion honeycomb fired body 120 having the same porosity, the same average pore diameter, the same number of cells (cell density) and the same thickness of cell walls as those of the center-portion honeycomb fired body 110 and also having a cross-sectional shape surrounded by three line segments and an arc, with the two angles, made by two line segments out of these three line segments, being 90° and 135° (line segment 120a=17.7 mm, line segment 120b=37.2 mm and line segment 120c=33.5 mm) was manufactured.

Here, the cross-sectional area of the center-portion honeycomb fired body 110 was 1347 mm², and the cross-sectional area of the peripheral-portion honeycomb fired body 120 was 1215 mm². Therefore, the cross-sectional area of the peripheral-portion honeycomb fired body 120 was 0.90 times larger than the cross-sectional area of the center-portion honeycomb fired body 110.

### Example 1-3

A honeycomb structure was manufactured in the same manner as in Example 1-1, except that the sizes of a center-portion honeycomb fired body 110 and a peripheral-portion honeycomb fired body 120, each manufactured through the processes (1) to (3) of Example 1-1, were changed to the below-mentioned sizes.

A center-portion honeycomb fired body 110 including a silicon carbide sintered body and having a porosity of 45%, an average pore diameter of 15 μm, a size of 32.4 mm×32.4 mm×150 mm, the number of cells (cell density) of 300 pcs/inch² and a thickness of cell walls of 0.25 mm (10 mil) was manufactured.

Also, a peripheral-portion honeycomb fired body 120 having the same porosity, the same average pore diameter, the same number of cells (cell density) and the same thickness of cell walls as those of the center-portion honeycomb fired body 110 and also having a cross-sectional shape surrounded by three line segments and an arc, with the two angles, made by two line segments out of these three line segments, being 90° and 135° (line segment 120a=23.8 mm, line segment 120b=32.9 mm and line segment 120c=37.8 mm) was manufactured.

Here, the cross-sectional area of the center-portion honeycomb fired body 110 was 1050 mm², and the cross-sectional area of the peripheral-portion honeycomb fired body 120 was 1363 mm². Therefore, the cross-sectional area of the peripheral-portion honeycomb fired body 120 was 1.30 times larger than the cross-sectional area of the center-portion honeycomb fired body 110.

### Comparative Example 1-1

(1) By carrying out the same processes as the processes (1) to (3) of Example 1-1, a honeycomb fired body including a silicon carbide sintered body and having a porosity of 45%, an average pore diameter of 15 μm, a size of 34.5 mm×34.5 mm×150 mm, the number of cells (cell density) of 300 pcs/inch² and a thickness of cell walls of 0.25 mm (10 mil) was manufactured.

(2) An adhesive paste was applied to a predetermined side face of the honeycomb fired body, and 16 pieces of honeycomb fired bodies were bonded to one another with the adhesive paste interposed therebetween. The adhesive paste was solidified at 180° C. in 20 minutes to manufacture an aggregated body of the honeycomb fired bodies having a rectangular pillar-shape, with the thickness of the adhesive layer being 1 mm.

Here, as the adhesive paste, the same adhesive paste as that used in Example 1-1 was used.

(3) Next, the periphery of the aggregated body of the honeycomb fired bodies was cut by using a diamond cutter, to manufacture a round pillar-shaped ceramic block.

Subsequently, a coating material paste layer was formed on the periphery of the ceramic block by using the coating material paste made of the same material as that of the adhesive paste. Further, this coating material paste layer was dried at a temperature of 120° C. to manufacture a round pillar-shaped honeycomb structure having a size of 143.8 mm in diameter×150 mm in length, with a coat layer formed on the periphery thereof.

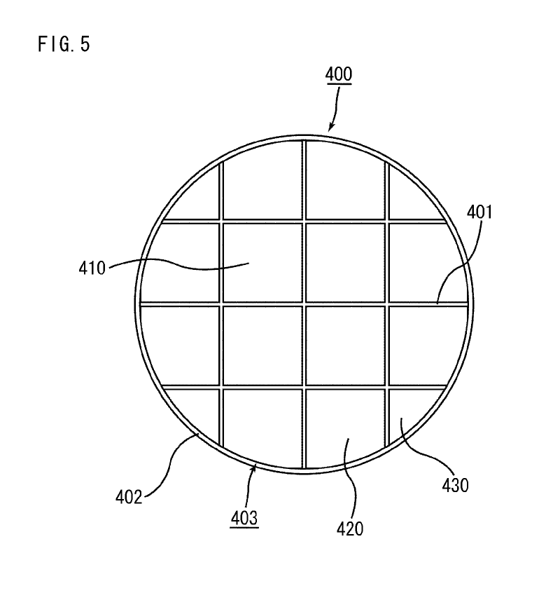

The cross-sectional shape of the honeycomb structure manufactured in Comparative Example 1-1 is shown in FIG. 5.

FIG. 5 is a cross-sectional view that shows the honeycomb structure 400 manufactured in Comparative Example 1-1, and in FIG. 5, a reference numeral 410 represents a center-portion honeycomb fired body, reference numerals 420 and 430 represent peripheral-portion honeycomb fired bodies, a reference numeral 401 represents an adhesive layer, a reference numeral 402 represents a coat layer and a reference numeral 403 represents a ceramic block.

In the honeycomb structure 400, the cross-sectional area of the center-portion honeycomb fired body 410 is 1190.5 mm², the cross-sectional area of the peripheral-portion honeycomb fired body 420 is 1095 mm², and the cross-sectional area of the peripheral-portion honeycomb fired body 430 is 357 mm².

Therefore, the cross-sectional area of the peripheral-portion honeycomb fired body 420 is 0.92 times larger than the cross-sectional area of the center-portion honeycomb fired body 410, and the cross-sectional area of the peripheral-portion honeycomb fired body 430 is 0.30 times larger than the cross-sectional area of the center-portion honeycomb fired body 410.

### Comparative Example 1-2

A honeycomb structure was manufactured in the same manner as in Example 1-1, except that the sizes of a center-portion honeycomb fired body 110 and a peripheral-portion honeycomb fired body 120, each manufactured through the processes (1) to (3) of Example 1-1, were changed to the below-mentioned sizes.

A center-portion honeycomb fired body 110 including a silicon carbide sintered body and having a porosity of 45%, an average pore diameter of 15 μm, a size of 31.5 mm×31.5 mm×150 mm, the number of cells (cell density) of 300 pcs/inch and a thickness of cell walls of 0.25 mm (10 mil) was manufactured.

Also, a peripheral-portion honeycomb fired body 120 having the same porosity, the same average pore diameter, the same number of cells (cell density) and the same thickness of cell walls as those of the center-portion honeycomb fired body 110 and also having a cross-sectional shape surrounded by three line segments and an arc, with the two angles, made by two line segments out of these three line segments, being 90° and 135° (line segment 120a=25.0 mm, line segment 120b=32.0 mm and line segment 120c=38.2 mm) was manufactured.

Here, the cross-sectional area of the center-portion honeycomb fired body 110 was 992 mm², and the cross-sectional area of the peripheral-portion honeycomb fired body 120 was 1392 mm². Therefore, the cross-sectional area of the peripheral-portion honeycomb fired body 120 was 1.40 times larger than the cross-sectional area of the center-portion honeycomb fired body 110.

### (Evaluation of Honeycomb Structure)

A regenerating process was carried out on each of the honeycomb structures manufactured in Examples 1-1 to 1-3 and Comparative Examples 1-1 and 1-2 by the following method, and a regenerating rate (%) was measured by the following method based on weight differences before and after the regenerating process.

Here, the smaller the regenerating rate is, the more the particulates remain.

### (Regenerating Process)

Each of the honeycomb structures according to Examples 1-1 to 1-3 and Comparative Examples 1-1 and 1-2 was placed in an exhaust passage of a 2 L engine, and a commercially available catalyst supporting carrier including a honeycomb structure made of cordierite (diameter: 200 mm, length: 100 mm, cell density: 400 pcs/inch², amount of supported platinum: 5 g/L) was placed in the exhaust passage of the engine at a position closer to a gas-inlet side than the previously-placed honeycomb structure as an exhaust gas purifying apparatus. Particulates were captured for 7 hours, while the engine was driven at the number of revolutions of 3000 min⁻¹ with a torque of 50 Nm. The amount of the captured particulates was 8 g/L.

Thereafter, the engine was driven at the number of revolutions of 1250 min⁻¹ with a torque of 60 Nm, and when the temperature of the filter became constant, the state was kept for one minute. Thereafter, a post injection was performed, and then the temperature of exhaust gas was raised by utilizing the oxidation catalyst present at the front side of the exhaust gas purifying apparatus to burn particulates.

The conditions for the post injection were set so that the temperature of the exhaust gases flowing in the honeycomb structure became almost constant at 600° C. after a lapse of one minute from the start.

### (Calculation of Regenerating Rate)

Provided that the initial weight of a honeycomb structure prior to capturing particulates is W₀, that the weight of the honeycomb structure prior to a regenerating process after capturing particulates is W₁, and that the weight of the honeycomb structure after the regenerating process is W₂, the regenerating rate was calculated by using the following equation (1):

Regenerating rate=[(W₁−W₀)−(W₂−W₀)]/(W₁−W₀) (1).

As a result, the regenerating rate of the honeycomb structure of Example 1-1 was 85%.

The regenerating rate of the honeycomb structure of Example 1-2 was 80%.

The regenerating rate of the honeycomb structure of Example 1-3 was 88%.

In contrast, the regenerating rate of the honeycomb structure of Comparative Example 1-1 was 70%.

Moreover, although the regenerating rate of the honeycomb structure of Comparative Example 1-2 was 90%, cracks occurred in a part of the peripheral-portion honeycomb fired body after the regenerating process.

Here, in the honeycomb structures of Examples 1-1 to 1-3 and Comparative Example 1-1, no cracks occurred in the honeycomb fired bodies after the regenerating process.

The reason that the regenerating rate was low in the honeycomb structure in Comparative Example 1-1 is presumably because a large amount of unburned particulates remained upon carrying out the regenerating process. Moreover, the reason that cracks were observed in the honeycomb structure of Comparative Example 1-2 is presumably because the cross-sectional area of the peripheral-portion honeycomb fired body was too large relative to the cross-sectional area of the center-portion honeycomb fired body.

### Second Embodiment of First Aspect of the Present Invention

Referring to the drawings, the following description will discuss a second embodiment that is another embodiment of the honeycomb structure of the first aspect of the present invention.

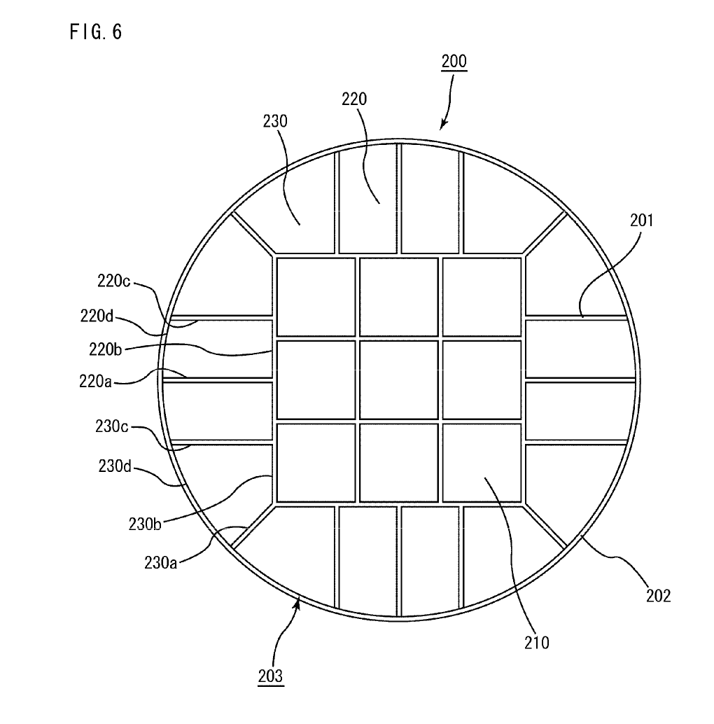

FIG. 6 is a cross-sectional view of a honeycomb structure according to the second embodiment of the first aspect of the present invention.

As shown in FIG. 6, the honeycomb structure 200 of the present embodiment has a structure in which a plurality of center-portion honeycomb fired bodies 210 and pluralities of peripheral-portion honeycomb fired bodies 220 and 230 are combined with one another with an adhesive layer 201 interposed therebetween to form a ceramic block 203. A coat layer 202 is formed on the periphery of the ceramic block 203.

The cross section of each of the center-portion honeycomb fired bodies 210 has a substantially square shape.

The cross section of each of the peripheral-portion honeycomb fired bodies 220 is formed into a shape surrounded by three line segments 220a, 220b and 220c and an arc 220d. The two angles made by two line segments out of these three line segments (an angle made by the line segments 220a and 220b and an angle made by the line segments 220b and 220c) are about 90°.

The cross section of each of the peripheral-portion honeycomb fired bodies 230 is formed into a shape surrounded by three line segments 230a, 230b and 230c and an arc 230d. The two angles made by two line segments out of these three line segments (an angle made by the line segments 230b and 230c and an angle made by the line segments 230a and 230b) are about 90° and about 135°.

The center-portion honeycomb fired body 210 is the same as the center-portion honeycomb fired body 110 used for the honeycomb structure of the first embodiment. The peripheral-portion honeycomb fired bodies 220 and 230 have the same functions as that of the center-portion honeycomb fired body 110 used for the honeycomb structure of the first embodiment although outer shapes of those peripheral-portion honeycomb fired bodies are different from that of the center-portion honeycomb fired body 110.

Moreover, the honeycomb fired bodies 210, 220 and 230 include porous silicon carbide sintered bodies.

As shown in FIG. 6, in the honeycomb structure 200, nine pieces of the center-portion honeycomb fired bodies 210 are located in the center portion of the cross section of the honeycomb structure 200, and eight pieces of the peripheral-portion honeycomb fired bodies 220 and eight pieces of the peripheral-portion honeycomb fired bodies 230 are located on the periphery of the nine pieces of center-portion honeycomb fired bodies 210. These honeycomb fired bodies are combined with one another with the adhesive layer 201 interposed therebetween so that the cross section of the honeycomb structure 200 (ceramic block 203) is formed into a substantially round shape.

In the honeycomb structure 200, the cross-sectional shape of each of the peripheral-portion honeycomb fired bodies 220 and 230 is different from that of the center-portion honeycomb fired body 210. The cross-sectional area of each of the peripheral-portion honeycomb fired bodies 220 and 230 is at least about 0.9 times and at most about 1.3 times larger than that of the center-portion honeycomb fired body 210.

Therefore, no honeycomb fired body having an extremely small cross-sectional area is located in the peripheral portion of the honeycomb structure 200, and of course, an adhesive layer to be used for combining such small honeycomb fired bodies with one another is not required. For this reason, the honeycomb structure 200 tends not to have a temperature distribution between the center portion and the peripheral portion, and unburned particulates tend not to remain upon carrying out the regenerating process.

As mentioned above, the cross section of the peripheral portion honeycomb fired body 220 is formed into the shape surrounded by the three line segments 220a, 220b and 220c and an arc 220d. The two angles made by two line segments out of these three line segments (an angle made by the line segments 220a and 220b and an angle made by the line segments 220b and 220c) are about 90°. As mentioned above, the cross section of the peripheral portion honeycomb fired body 230 is formed into the shape surrounded by three line segments 230a, 230b and 230c and an arc 230d. The two angles made by two line segments out of these three line segments (an angle made by the line segments 230b and 230c and an angle made by the line segments 230a and 230b) are about 90° and about 1350. The fact that the shape of each of the peripheral-portion honeycomb fired bodies 220 and 230 is formed into each of these shapes is also one reason why no honeycomb fired body having an extremely small cross-sectional area is located in the peripheral portion of the honeycomb structure 200.

Here, also in the honeycomb structure 200, the cross-sectional area of center-portion honeycomb fired body 210 is at least about 900 mm² and at most about 2500 mm².

The reason for this is the same as mentioned in the first embodiment of the first aspect of the present invention.

The following description will discuss a method for manufacturing the honeycomb structure of the present embodiment. The method for manufacturing the honeycomb structure of the present embodiment is the same as the method for manufacturing the honeycomb structure of the first embodiment of the first aspect of the present invention, except for the following points.

That is, the honeycomb structure of the present embodiment can be manufactured by using the same method as the method for manufacturing the honeycomb structure of the first embodiment of the first aspect of the present invention, except that the shapes of honeycomb molded bodies formed in the molding process (1) of the manufacturing method of the first embodiment of the first aspect of the present invention have almost the same shapes as those of the center-portion honeycomb fired body 210 and the peripheral-portion honeycomb fired bodies 220 and 230 as shown in FIG. 6 while either one end of each of the cells is not sealed, and except that, upon carrying out the combining process (4) of the manufacturing method of the first embodiment of the first aspect of the present invention, the respective honeycomb fired bodies are combined with one another so that the center-portion honeycomb fired body 210 and the peripheral-portion honeycomb fired bodies 220 and 230 are located as shown in FIG. 6.

The honeycomb structure of the present embodiment is capable of exerting the same effects as those of the honeycomb structure of the first embodiment of the first aspect of the present invention.

### Example 1-4

The following description will discuss an example that more specifically discloses the second embodiment of the first aspect of the present invention. However, the first aspect of the present invention is not intended to be limited only by this example.

(1) By carrying out the same method as the molding process (1) of Example 1-1, raw honeycomb molded bodies having almost the same shapes as those of the center-portion honeycomb fired body 210 and peripheral-portion honeycomb fired bodies 220 and 230 shown in FIG. 6, with no cells being sealed, were manufactured.

(2) Next, the raw honeycomb molded bodies were dried by using a microwave drying apparatus to obtain dried honeycomb molded bodies. A paste having the same composition as that of the wet mixture was then filled into predetermined cells, and the filled portions of the dried honeycomb molded bodies were dried by using a drying apparatus again.

(3) The dried honeycomb molded bodies were degreased at 400° C., and then fired at 2200° C. under normal pressure argon atmosphere for three hours.

Thus, a center-portion honeycomb fired body 210 including a silicon carbide sintered body and having a porosity of 45%, an average pore diameter of 15 μm, a size of 34.5 mm×34.5 mm×200 mm, the number of cells (cell density) of 300 pcs/inch² and a thickness of cell walls of 0.25 mm (10 mil) was manufactured.

Also, a peripheral-portion honeycomb fired body 220 having the same porosity, the same average pore diameter, the same number of cells (cell density) and the same thickness of cell walls as those of the center-portion honeycomb fired body 210 and also having a cross-sectional shape surrounded by three line segments and an arc, with the two angles, made by two line segments out of these three line segments, being 90° (line segment 220a=45.6 mm, line segment 220b=26.8 mm and line segment 220c=41.8 mm) was manufactured.

A peripheral-portion honeycomb fired body 230, which had the same porosity, the same average pore diameter, the same number of cells (cell density) and the same thickness of cell walls as those of the center-portion honeycomb fired body 210, and also had a cross-sectional shape surrounded by three line segments and an arc, with the two angles, made by two line segments out of these three line segments, being 90° and 135° (line segment 230a=24.9 mm, line segment 230b=24.5 mm and line segment 230c=41.8 mm) was manufactured. Here, the cross-sectional area of the center-portion honeycomb fired body 210 was 1190 mm², the cross-sectional area of the peripheral-portion honeycomb fired body 220 was 1226 mm² and the cross-sectional area of the peripheral-portion honeycomb fired body 230 was 1226 mm². Therefore, the cross-sectional area of the peripheral-portion honeycomb fired body 220 was 1.03 times larger than the cross-sectional area of the center-portion honeycomb fired body 210 and the cross-sectional area of the peripheral-portion honeycomb fired body 230 was 1.03 times larger than the cross-sectional area of the center-portion honeycomb fired body 210.

(4) An adhesive paste was applied to a predetermined side face of each of the center-portion honeycomb fired body 210 and the peripheral-portion honeycomb fired bodies 220 and 230, and nine pieces of the center-portion honeycomb fired bodies 210, eight pieces of the peripheral-portion honeycomb fired bodies 220, and eight pieces of the peripheral-portion honeycomb fired bodies 230 were bonded to one another with the adhesive paste interposed therebetween so as to be arranged as shown in FIG. 6. The adhesive paste was solidified at 180° C. in 20 minutes to manufacture a round pillar-shaped ceramic block 203 having the adhesive layer 1 mm in thickness.

Here, as the adhesive paste, the same adhesive paste as that used in Example 1-1 was used.

(5) By using a coating material paste having the same composition as the adhesive paste used in the process (4), a coating material paste layer was formed on the periphery of the ceramic block 203. Thereafter, the coating material paste layer was dried at 120° C. to manufacture a round pillar-shaped honeycomb structure 200 having a size of 203.2 mm in diameter×200 mm in length with a coat layer 202 formed on the periphery thereof.

The honeycomb structure manufactured in Example 1-4 has a cross-sectional shape as shown in FIG. 6.

A regenerating process was carried out on the honeycomb structure manufactured in Example 1-4 and a regenerating rate was measured based on weight differences, by the same method as in Example 1-1 except that a 4 L engine was used instead of a 2 L engine.

Consequently, the regenerating rate of the honeycomb structure of Example 1-4 was 82%.

### Third Embodiment of First Aspect of the Present Invention

In the methods for manufacturing the honeycomb structure according to the first and second embodiments of the first aspect of the present invention, the honeycomb structure is manufactured by forming the honeycomb fired body molded in the predetermined shape. However, the honeycomb structure according to an embodiment of the first aspect of the present invention may be manufactured according to the method mentioned below.

Hereinafter, another method for manufacturing a honeycomb structure according to an embodiment of the first aspect of the present invention will be described by exemplifying the case of manufacturing the honeycomb structure according to the first embodiment.

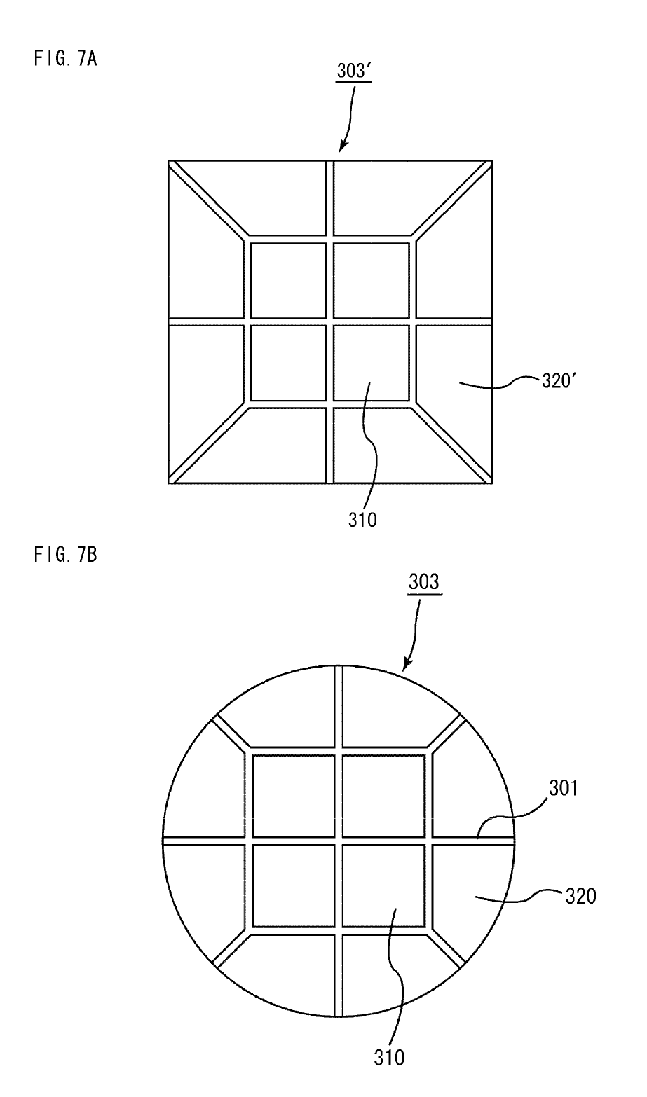

FIGS. 7A and 7B are cross-sectional views for describing one example of a method for manufacturing a honeycomb structure according to the third embodiment of the first aspect of the present invention.

(1) Honeycomb fired bodies with either one end of each of the cells sealed are manufactured by the same method as in the processes (1) to (3) of the first embodiment of the first aspect of the present invention.

At this time, a center-portion honeycomb fired body 310 having a rectangular cross-sectional shape and a peripheral-portion honeycomb fired body 320′ having a trapezoid cross-sectional shape are manufactured (see FIG. 7A).

(2) Next, in the same manner as in the process (4) of the first embodiment, the center-portion honeycomb fired bodies 310 and the peripheral-portion honeycomb fired bodies 320′ are combined with one another with the adhesive paste layer interposed therebetween so as to be arranged as shown in FIG. 7A. Moreover, the adhesive paste layer is solidified to manufacture an aggregated body of the honeycomb fired bodies 303′.

(3) Next, a periphery cutting process is carried out in which the side face of the aggregated body of the honeycomb fired bodies 303′ is cut by using a diamond cutter or the like to form a substantially round pillar shape so as to manufacture a ceramic block 303 in which the center-portion honeycomb fired bodies 310 and the peripheral-portion honeycomb fired bodies 320 are combined with one another with the adhesive layer 301 interposed therebetween (see FIG. 7B).

Then, if needed, a coat layer (not illustrated) is formed on the peripheral side face of the ceramic block 303 to complete a honeycomb structure.

### Other Embodiments of First Aspect of the Present Invention

The cross-sectional shape of the honeycomb structure according to an embodiment of the first aspect of the present invention is not limited to a substantially round shape. The cross-sectional shape may be a substantially elliptical shape, a substantially elongated round shape, a substantially racetrack shape, or the like.

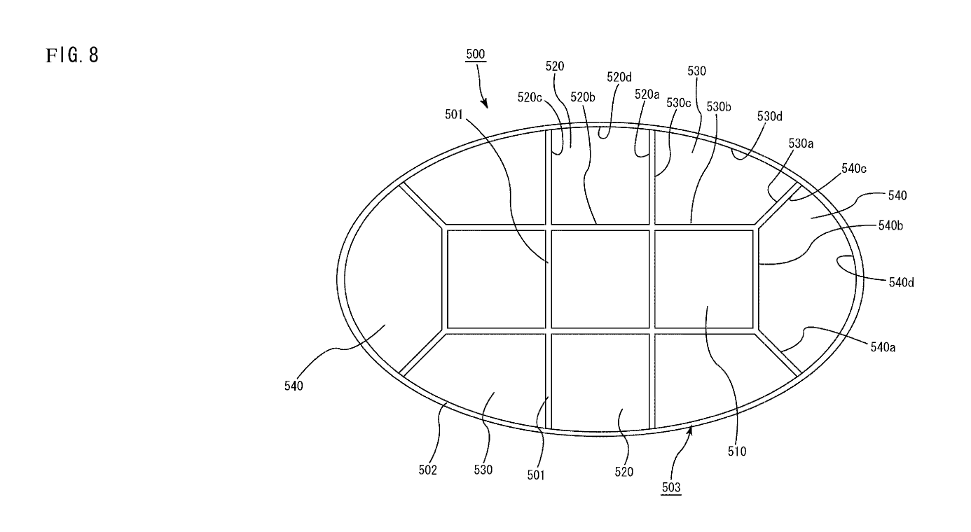

FIG. 8 is a cross-sectional view of a honeycomb structure according to another embodiment of the first aspect of the present invention.

The cross-sectional shape of the honeycomb structure illustrated in FIG. 8 is a substantially elliptical shape.

A honeycomb structure 500 shown in FIG. 8 has a structure in which a plurality of center-portion honeycomb fired bodies 510 and pluralities of peripheral-portion honeycomb fired bodies 520, 530 and 540 are combined with one another with an adhesive layer 501 interposed therebetween to form a ceramic block 503. Moreover, a coat layer 502 is formed on the periphery of the ceramic block 503.

The center-portion honeycomb fired body 510 has a substantially square cross-sectional shape.

The cross section of each of the peripheral-portion honeycomb fired bodies 520 is formed into a shape surrounded by three line segments 520a, 520b and 520c and an elliptical arc 520d. The two angles made by two line segments out of these three line segments (an angle made by the line segments 520a and 520b and an angle made by the line segments 520b and 520c) are about 90°.

The cross section of each of the peripheral-portion honeycomb fired bodies 530 is formed into a shape surrounded by three line segments 530a, 530b and 530c and an elliptical arc 530d. The two angles made by two line segments out of these three line segments (an angle made by the line segments 530b and 530c and an angle made by the line segments 530a and 530b) are about 90° and about 135°.

The cross section of each of the peripheral-portion honeycomb fired bodies 540 is formed into a shape surrounded by three line segments 540a, 540b and 540c and an elliptical arc 540d. The two angles made by two line segments out of these three line segments (an angle made by the line segments 540a and 540b and an angle made by the line segments 540b and 540c) are about 135°.

The center-portion honeycomb fired body 510 is the same as the center-portion honeycomb fired body 110 used for the honeycomb structure of the first embodiment.

The peripheral-portion honeycomb fired bodies 520, 530 and 540 have the same functions as that of the center-portion honeycomb fired body 110 used for the honeycomb structure of the first embodiment although outer shapes of those peripheral-portion honeycomb fired bodies are different from that of the center-portion honeycomb fired body 110.

The honeycomb structure 500 includes three pieces of the center-portion honeycomb fired bodies 510 combined with one another with the adhesive layer 501 interposed therebetween, two pieces of the peripheral-portion honeycomb fired bodies 520, four pieces of the peripheral-portion honeycomb fired bodies 530 and two pieces of the peripheral-portion honeycomb fired bodies 540. These peripheral-portion honeycomb fired bodies are located on the periphery of the three pieces of the center-portion honeycomb fired bodies 510. These honeycomb fired bodies are combined with one another with the adhesive layer 501 interposed therebetween so that the cross section of the honeycomb structure 500 (ceramic block 503) is formed into a substantially elliptical shape.

Here, in the honeycomb structure 500, the cross-sectional area of each of the peripheral-portion honeycomb fired bodies 520, 530 and 540 is at least about 0.9 times and at most about 1.3 times larger than the cross-sectional area of the center-portion honeycomb fired body 510.

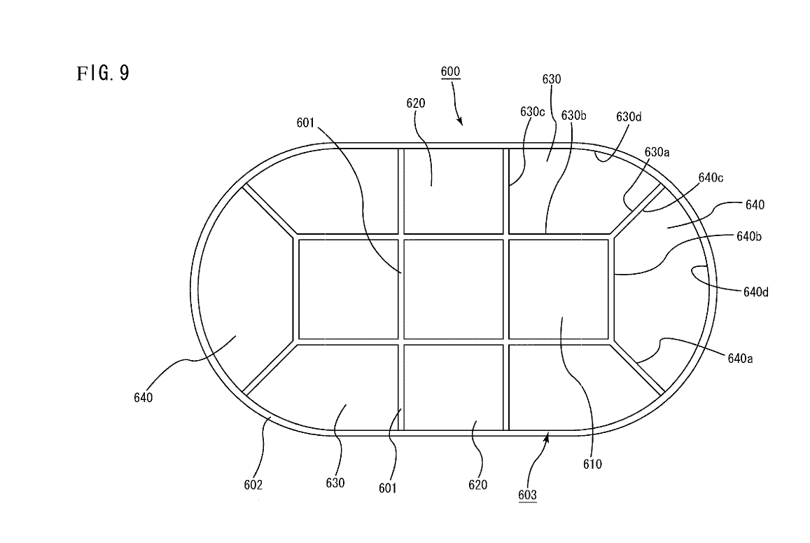

FIG. 9 is a cross-sectional view of a honeycomb structure according to another embodiment of the first aspect of the present invention.

The cross-sectional shape of the honeycomb structure illustrated in FIG. 9 is a substantially racetrack shape.

A honeycomb structure 600 shown in FIG. 9 has a structure in which a plurality of center-portion honeycomb fired bodies 610 and pluralities of peripheral-portion honeycomb fired bodies 620, 630 and 640 are combined with one another with an adhesive layer 601 interposed therebetween to form a ceramic block 603. Moreover, a coat layer 602 is formed on the periphery of the ceramic block 603.

The center-portion honeycomb fired body 610 has a substantially square cross-sectional shape.

The peripheral-portion honeycomb fired body 620 has a substantially rectangular cross-sectional shape.

The cross section of the peripheral-portion honeycomb fired body 630 is formed into a shape surrounded by three line segments 630a, 630b and 630c, and a curve 630d formed by one straight line and an arc. The two angles made by two line segments out of these three line segments (an angle made by the line segments 630b and 630c and an angle made by the line segments 630a and 630b) are about 90° and about 135°.

The cross section of the peripheral-portion honeycomb fired body 640 is formed into a shape surrounded by three line segments 640a, 640b and 640c and an arc 640d. The two angles made by two line segments out of these three line segments (an angle made by the line segments 640a and 640b and an angle made by the line segments 640b and 640c) are about 135°.

The center-portion honeycomb fired body 610 is the same as the center-portion honeycomb fired body 110 used for the honeycomb structure of the first embodiment. The peripheral-portion honeycomb fired bodies 620, 630 and 640 have the same functions as that of the center-portion honeycomb fired body 110 used for the honeycomb structure of the first embodiment although outer shapes of those peripheral-portion honeycomb fired bodies are different from that of the center-portion honeycomb fired body 110.

The honeycomb structure 600 includes three pieces of the center-portion honeycomb fired bodies 610 combined with one another with adhesive layer 601 interposed therebetween, two pieces of the peripheral-portion honeycomb fired bodies 620, four pieces of the peripheral-portion honeycomb fired bodies 630 and two pieces of the peripheral-portion honeycomb fired bodies 640. These peripheral-portion honeycomb fired bodies are located on the periphery of the three pieces of the center-portion honeycomb fired bodies 610. These honeycomb fired bodies are combined with one another with the adhesive layer 601 interposed therebetween so that the cross section of the honeycomb structure 600 (ceramic block 603) is formed into a substantially racetrack shape.

Here, in the honeycomb structure 600, the cross-sectional area of each of the peripheral-portion honeycomb fired bodies 620, 630 and 640 is at least about 0.9 times and at most about 1.3 times larger than the cross-sectional area of the center-portion honeycomb fired body 610.

As mentioned above, the honeycomb structure according to the embodiments of the first aspect of the present invention may have a substantially elliptical cross-sectional shape as shown in FIG. 8 or may have a substantially racetrack cross-sectional shape as shown in FIG. 9.

Moreover, in the honeycomb structure according to an embodiment of the first aspect of the present invention, the number of the center-portion honeycomb fired bodies is not limited to plural but may be one.

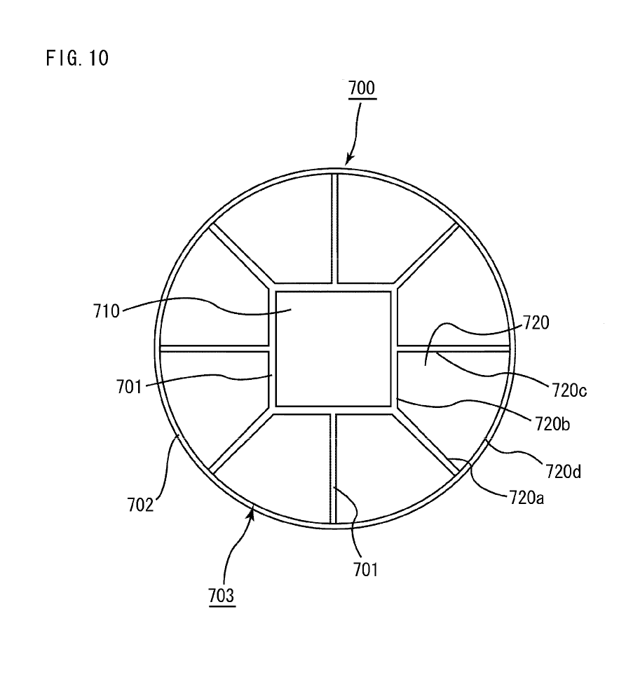

More specifically, the honeycomb structure may have a cross-sectional shape as shown in FIG. 10.

FIG. 10 is a cross-sectional view of a honeycomb structure according to another embodiment of the first aspect of the present invention.

The honeycomb structure 700 as illustrated in FIG. 10 has the same structure as that of the honeycomb structure 100 of the first embodiment, except that the number of the center-portion honeycomb fired bodies is different.

That is, the honeycomb structure 700 as illustrated in FIG. 10 includes one center-portion honeycomb fired body 710, instead of four pieces of the honeycomb fired bodies 110 combined with one another with the adhesive layer 101 interposed therebetween in the honeycomb structure 100 as illustrated in FIG. 1.

Compared with the center-portion honeycomb fired body 110, the center-portion honeycomb fired body 710 has a larger cross-sectional area but has the same functions.

The cross section of the peripheral-portion honeycomb fired body 720 in the honeycomb structure 700 is formed into a shape surrounded by three line segments 720a, 720b and 720c, and an arc 720d. The two angles made by two line segments out of these three line segments (an angle made by the line segments 720b and 720c and an angle made by the line segments 720a and 720b) are about 90° and about 135°.

Here, the cross-sectional area of the peripheral-portion honeycomb fired body 720 is at least about 0.9 times and at most about 1.3 times larger than that of the center-portion honeycomb fired body 710.

The honeycomb structure 700 of such an embodiment is allowed to exert the same effects as those of the honeycomb structure of the first embodiment of the first aspect of the present invention.

Here, in FIG. 10, a reference numeral 701 represents an adhesive layer; a reference numeral 702 represents a coat layer; and a reference numeral 703 represents a ceramic block.

In the honeycomb structure of the embodiments of the first aspect of the present invention having a substantially round cross-sectional shape, four or five pieces of the honeycomb fired bodies are preferably penetrated by one diameter in the cross section of the honeycomb structure as well as another diameter that is orthogonal to the one diameter. The honeycomb structures having such structure are suitably allowed to exert the effects of the present invention.

Upon counting the number of the honeycomb fired bodies penetrated by the one diameter or the another diameter, if at least one of the one diameter and the another diameter is entirely superposed on or partly overlaps with an adhesive layer, one piece of honeycomb fired body located on one side adjacent to the adhesive layer is counted as one piece of honeycomb fired body penetrated by the one or another diameter.

With respect to the honeycomb structures of the embodiments of the first aspect of the present invention explained above, in the honeycomb structure of the first embodiment, four pieces of the honeycomb fired bodies are respectively superposed on the one diameter and the another diameter (see FIG. 4). In the honeycomb structure of the second embodiment, five pieces of the honeycomb fired bodies are respectively superposed on the one diameter and the another diameter (see FIG. 6). In the honeycomb structure of the embodiment shown in FIG. 10, three pieces of the honeycomb fired bodies are respectively superposed on the one diameter and the another diameter. Out of these three embodiments, the first and second embodiments are more preferable embodiments.

Referring to the drawings, the following description will discuss an embodiment of a honeycomb structure according to the second aspect of the present invention.

### First Embodiment of Second Aspect of the Present Invention

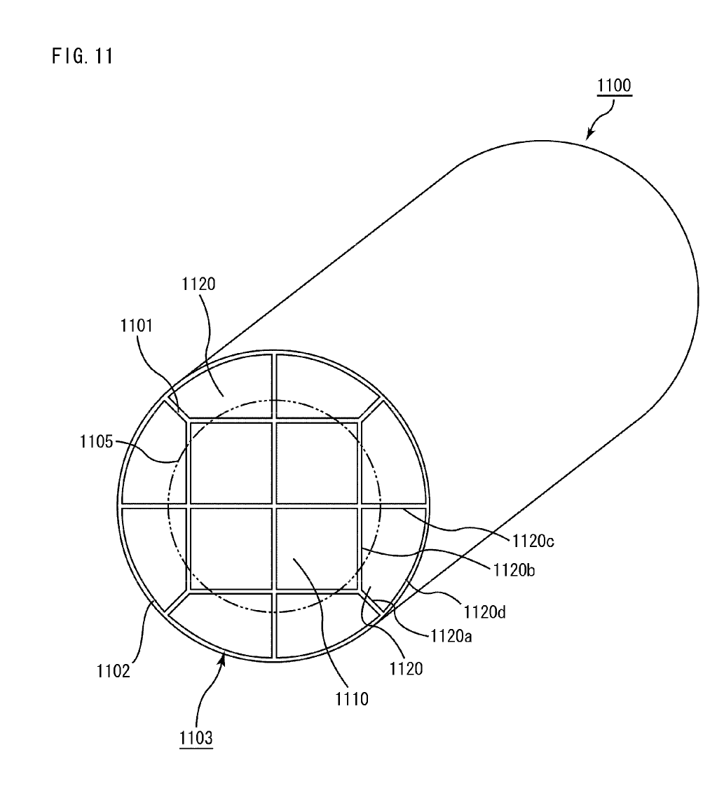

FIG. 11 is a perspective view schematically showing a honeycomb structure according to the first embodiment of the second aspect of the present invention.

The honeycomb structure 1100 shown in FIG. 11 has a structure in which a plurality of center-portion honeycomb fired bodies 1110 and a plurality of peripheral-portion honeycomb fired bodies 1120 are combined with one another with an adhesive layer 1101 interposed therebetween to form a ceramic block 1103. A coat layer 1102 is formed on the periphery of the ceramic block 1103.

The center-portion honeycomb fired body 1110 has almost the same shape as that of the center-portion honeycomb fired body 110 of the honeycomb structure 100 according to the first embodiment of the first aspect of the present invention, and includes the same material as that thereof. The peripheral-portion honeycomb fired body 1120 has almost the same shape as that of the peripheral-portion honeycomb fired body 120 of the honeycomb structure 100 according to the first embodiment of the first aspect of the present invention, and includes the same material as that thereof.

In the center-portion honeycomb fired body 1110 and the peripheral-portion honeycomb fired body 1120, either one end of each of the cells is sealed, so that the cell wall functions as a filter for capturing PM and the like.

As shown in FIG. 11, in the honeycomb structure 1100, four pieces of the center-portion honeycomb fired bodies 1110 are located in the center portion of the cross section of the honeycomb structure 1100, and eight pieces of the peripheral-portion honeycomb fired bodies 1120 are located on the periphery of the four pieces of the center-portion honeycomb fired bodies 1110. These honeycomb fired bodies are combined with one another with the adhesive layer 1101 interposed therebetween so that the cross section of the honeycomb structure 1100 (ceramic block 1103) is formed into a substantially round shape.

In the honeycomb structure 1100, provided that a FIG. (substantially round shape) 1105, which is similar to the shape of the ceramic block 1103 in the cross section and is concentric with the shape of the ceramic block 1103 in the cross section, is drawn in the cross section with an area ratio of the figure being about 49% to the area of the ceramic block 1103 in the cross section, a part of each of the peripheral-portion honeycomb fired bodies 1120 is located in the FIG. 1105.

In the case that a part of each of the peripheral-portion honeycomb fired bodies 1120 is located in the FIG. 1105, there is no peripheral-portion honeycomb fired body isolated from the center of the honeycomb structure 1100 (ceramic block 1103) by interposing the adhesive layer, so that the honeycomb structure tends not to have a temperature distribution between the center portion and the peripheral portion.

Further, in the honeycomb structure 1100, the cross-sectional area of the center-portion honeycomb fired body 1110 is at least about 900 mm² and at most about 2500 mm².

This size of the cross-sectional area of the center-portion honeycomb fired body 1110 makes it easier to prevent cracks from occurring in the honeycomb structure 1100 upon carrying out a regenerating process on the honeycomb structure 1100.

The honeycomb structure according to the present embodiment can be manufactured by the same method for manufacturing the honeycomb structure according to the first embodiment of the first aspect of the present invention.

The following description will summarize the effects of the honeycomb structure of the present embodiment.

(1) In the honeycomb structure of the present embodiment, provided that a figure, which is similar to the shape of the ceramic block in the cross section and is concentric with the shape of the ceramic block in the cross section, is drawn in the cross section with an area ratio of the figure being about 49% to the area of the ceramic block in the cross section, a part of each of the peripheral-portion honeycomb fired bodies is necessarily located in the figure.

Therefore, there is no peripheral-portion honeycomb fired body located only outside the figure, so that the honeycomb structure tends not to have a temperature distribution between the center portion and the peripheral portion, and unburned particulates tend not to remain upon carrying out a regenerating process.

(2) In the honeycomb structure of the present embodiment, the cross-sectional area of the center-portion honeycomb fired body is at least about 900 mm² and at most about 2500 mm². For this reason, cracks are less likely to occur in the honeycomb fired body upon carrying out a regenerating process.

(3) In the honeycomb fired body of the honeycomb structure of the present embodiment, either one end of each of the cells is sealed with a plug. Therefore, the honeycomb structure of the present embodiment is more likely to be suitably used as a diesel particulate filter.

(4) In the honeycomb structure of the present embodiment, since the coat layer is formed on the peripheral side face of the ceramic block, it is easier to prevent leakage of particulates from the peripheral side face of the honeycomb structure.

### Example 2-1

The following description will discuss an example that specifically discloses the first embodiment of the second aspect of the present invention. Here, the second aspect of the present invention is not limited to the example.

(1) Honeycomb fired bodies were manufactured in the same manner as in the processes (1) to (3) of Example 1-1.

Thus, a center-portion honeycomb fired body 1110 including a silicon carbide sintered body and having a porosity of 45%, an average pore diameter of 15 μm, a size of 34.5 mm×34.5 mm×150 mm, the number of cells (cell density) of 300 pcs/inch² and a thickness of cell walls of 0.25 mm (10 mil) was manufactured.

Also, a peripheral-portion honeycomb fired body 1120 having the same porosity, the same average pore diameter, the same number of cells (cell density) and the same thickness of cell walls as those of the center-portion honeycomb fired body 1110 and also having a cross-sectional shape surrounded by three line segments and an arc, with the two angles, made by two line segments out of these three line segments, being 90° and 135° (line segment 1120a=20.8 mm, line segment 1120b=35.0 mm and line segment 1120c=35.7 mm) was manufactured.

(2) A honeycomb structure 1100 with a coat layer 1102 formed on the periphery thereof was manufactured in the same manner as in the processes (4) and (5) of Example 1-1.

The honeycomb structure 1100 has a round pillar shape with a size of 143.8 mm in diameter×150 mm in length.

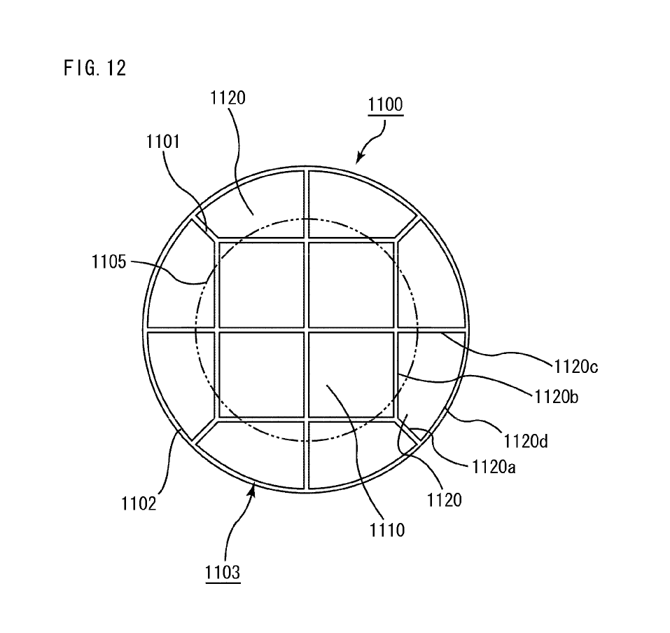

The cross-sectional shape of the honeycomb structure 1100 manufactured in Example 2-1 is shown in FIG. 12.

In the honeycomb structure 1100, provided that a FIG. 1105, which is similar to the shape of the ceramic block 1103 in the cross section and is concentric with the shape of the ceramic block 1103 in the cross section, is drawn in the cross section with an area ratio of the figure being about 49% to the area of the ceramic block 1103 in the cross section, a part of each of the peripheral-portion honeycomb fired bodies 1120 is necessarily located in the FIG. 1105 (see FIG. 12).

### Comparative Example 2-1

A honeycomb structure same as that in Comparative Example 1-1 was manufactured.

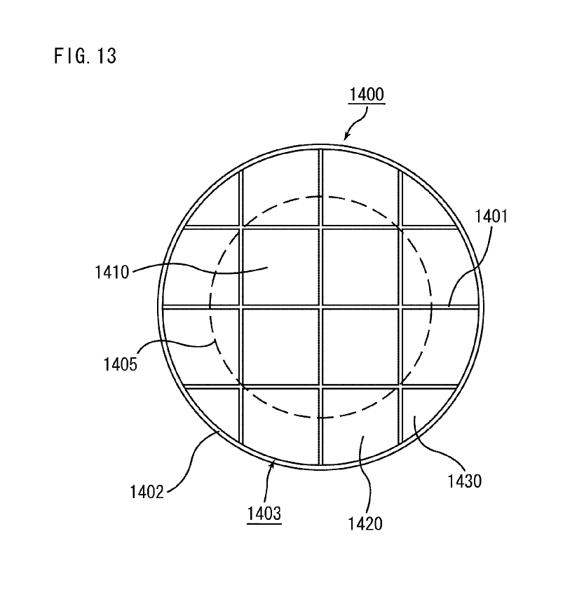

The cross-sectional shape of the honeycomb structure 1400 manufactured in Comparative Example 2-1 is shown in FIG. 13.

FIG. 13 is a cross-sectional view that shows the honeycomb structure 1400 manufactured in Comparative Example 2-1, and in FIG. 13, a reference numeral 1410 represents a center-portion honeycomb fired body, reference numerals 1420 and 1430 represent peripheral-portion honeycomb fired bodies, a reference numeral 1401 represents an adhesive layer, a reference numeral 1402 represents a coat layer and a reference numeral 1403 represents a ceramic block.

In the honeycomb structure 1400, provided that a FIG. 1405, which is similar to the shape of the ceramic block 1403 in the cross section and is concentric with the shape of the ceramic block 1403 in the cross section, is drawn in the cross section with an area ratio of the figure being about 49% to the area of the ceramic block 1403 in the cross section, the peripheral-portion honeycomb fired body 1430 is located only outside the FIG. 1405.

### (Evaluation of Honeycomb Structure)

Evaluated in the same manner as in Example 1-1, the regenerating rate of the honeycomb structure of Example 2-1 was 85%, and the regenerating rate of the honeycomb structure of Comparative Example 2-1 was 70%.

The reason of this is presumably because a large amount of unburned particulates remained upon carrying out the regenerating process in the honeycomb structure of Comparative Example 2-1.

### Second Embodiment of Second Aspect of the Present Invention

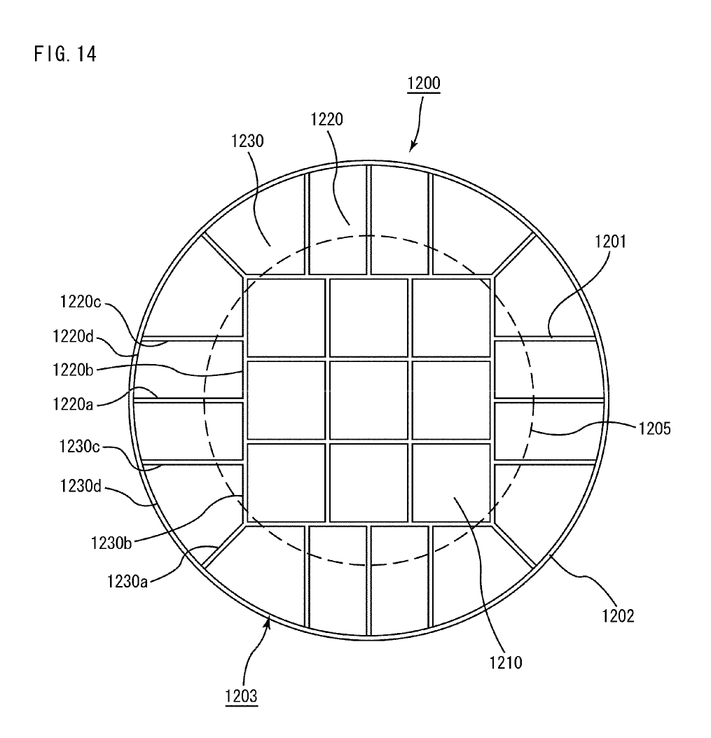

FIG. 14 is a cross-sectional view of a honeycomb structure according to the second embodiment of the second aspect of the present invention.

As shown in FIG. 14, the honeycomb structure 1200 of the present embodiment has a structure in which a plurality of center-portion honeycomb fired bodies 1210 and pluralities of peripheral-portion honeycomb fired bodies 1220 and 1230 are combined with one another with an adhesive layer 1201 interposed therebetween to form a ceramic block 1203. A coat layer 1202 is formed on the periphery of the ceramic block 1203.

The center-portion honeycomb fired body 1210 has almost the same shape as that of the center-portion honeycomb fired body 210 of the honeycomb structure 200 according to the second embodiment of the first aspect of the present invention, and includes the same material as that thereof. The peripheral-portion honeycomb fired bodies 1220 and 1230 have almost the same shapes as those of the peripheral-portion honeycomb fired bodies 220 and 230 of the honeycomb structure 200 according to the second embodiment of the first aspect of the present invention, and include the same material as those thereof.

As shown in FIG. 14, in the honeycomb structure 1200, nine pieces of the center-portion honeycomb fired bodies 1210 are located in the center portion of the cross section of the honeycomb structure 1200, and eight pieces of the peripheral-portion honeycomb fired bodies 1220 and eight pieces of the peripheral-portion honeycomb fired bodies 1230 are located on the periphery of the nine pieces of center-portion honeycomb fired bodies 1210. These honeycomb fired bodies are combined with one another with the adhesive layer 1201 interposed therebetween so that the cross section of the honeycomb structure 1200 (ceramic block 1203) is formed into a substantially round shape.

In the honeycomb structure 1200, provided that a FIG. (substantially round shape) 1205, which is similar to the shape of the ceramic block 1203 in the cross section and is concentric with the shape of the ceramic block 1203 in the cross section, is drawn in the cross section with an area ratio of the figure being about 49% to the area of the ceramic block 1203 in the cross section, a part of each of the peripheral-portion honeycomb fired bodies 1220 and 1230 is located in the FIG. 1205.

In the case that a part of each of the peripheral-portion honeycomb fired bodies 1220 and 1230 is located in the FIG. 1205, there is no peripheral-portion honeycomb fired body isolated from the center of the honeycomb structure 1200 (ceramic block 1203) by interposing the adhesive layer, so that the honeycomb structure tends not to have a temperature distribution between the center portion and the peripheral portion.

Here, also in the honeycomb structure 1200, a cross-sectional area of the center-portion honeycomb fired body 1210 is at least about 900 mm² and at most about 2500 mm².

The honeycomb structure according to the present embodiment can be manufactured by the same method for manufacturing the honeycomb structure according to the second embodiment of the first aspect of the present invention.

The honeycomb structure of the present embodiment is allowed to exert the same effects as those of the honeycomb structure of the first embodiment of the second aspect of the present invention.

### Example 2-2

The following description will discuss an example that specifically discloses the second embodiment of the second aspect of the present invention. Here, the second aspect of the present invention is not limited to the example.

(1) Honeycomb fired bodies were manufactured in the same manner as in the processes (1) to (3) of Example 1-4.

Thus, a center-portion honeycomb fired body 1210 including a silicon carbide sintered body and having a porosity of 45%, an average pore diameter of 15 μm, a size of 34.5 mm×34.5 mm×150 mm, the number of cells (cell density) of 300 pcs/inch² and a thickness of cell walls of 0.25 mm (10 mil) was manufactured.

Also, a peripheral-portion honeycomb fired body 1220 having the same porosity, the same average pore diameter, the same number of cells (cell density) and the same thickness of cell walls as those of the center-portion honeycomb fired body 1210 and also having a cross-sectional shape surrounded by three line segments and an arc, with the two angles, made by two line segments out of these three line segments, being 900 (line segment 1220a=45.6 mm, line segment 1220b=26.8 mm and line segment 1220c=41.8 mm) was manufactured.

Further, a peripheral-portion honeycomb fired body 1230 having the same porosity, the same average pore diameter, the same number of cells (cell density) and the same thickness of cell walls as those of the center-portion honeycomb fired body 1210 and also having a cross-sectional shape surrounded by three line segments and an arc, with the two angles, made by two line segments out of these three line segments, being 90° and 135° (line segment 1230a=24.9 mm, line segment 1230b=24.5 mm and line segment 1230c=41.8 mm) was manufactured.

(2) A honeycomb structure 1200 with a coat layer 1202 formed on the periphery thereof was manufactured in the same manner as in the processes (4) and (5) of Example 1-4.

The honeycomb structure 1200 has a round pillar shape with a size of 203.2 mm in diameter×150 mm in length.

The cross-sectional shape of the honeycomb structure 1200 manufactured in Example 2-2 is shown in FIG. 14.

In the honeycomb structure 1200, provided that a FIG. 1205, which is similar to the shape of the ceramic block 1203 in the cross section and is concentric with the shape of the ceramic block 1203 in the cross section, is drawn in the cross section with an area ratio of the figure being about 49% to the area of the ceramic block 1203 in the cross section, a part of each of the peripheral-portion honeycomb fired bodies 1220 and 1230 is necessarily located in the FIG. 1205 (see FIG. 14).

Evaluated in the same manner as in Example 1-4, regenerating rate of the honeycomb structure of Example 2-2 was 82%.

### Other Embodiments of Second Aspect of the Present Invention

The honeycomb structure in each of the first and second embodiments of the second aspect of the present invention may be manufactured in the same manner as in, for example, the third embodiment of the first aspect of the present invention.

In the honeycomb structure according to the embodiments of the second aspect of the present invention, each of the peripheral-portion honeycomb fired bodies does not necessarily have the same cross-sectional shape.

That is, in the embodiments of the second aspect of the present invention, in the case that a figure, which is similar to the shape of the ceramic block in the cross section and is concentric with the shape of the ceramic block in the cross section, is drawn in the cross section with an area ratio of the figure being about 49% to the area of the ceramic block in the cross section, each of the peripheral-portion honeycomb fired bodies does not necessarily have the same cross-sectional shape as long as a part of each of the peripheral-portion honeycomb fired bodies is located in the figure.

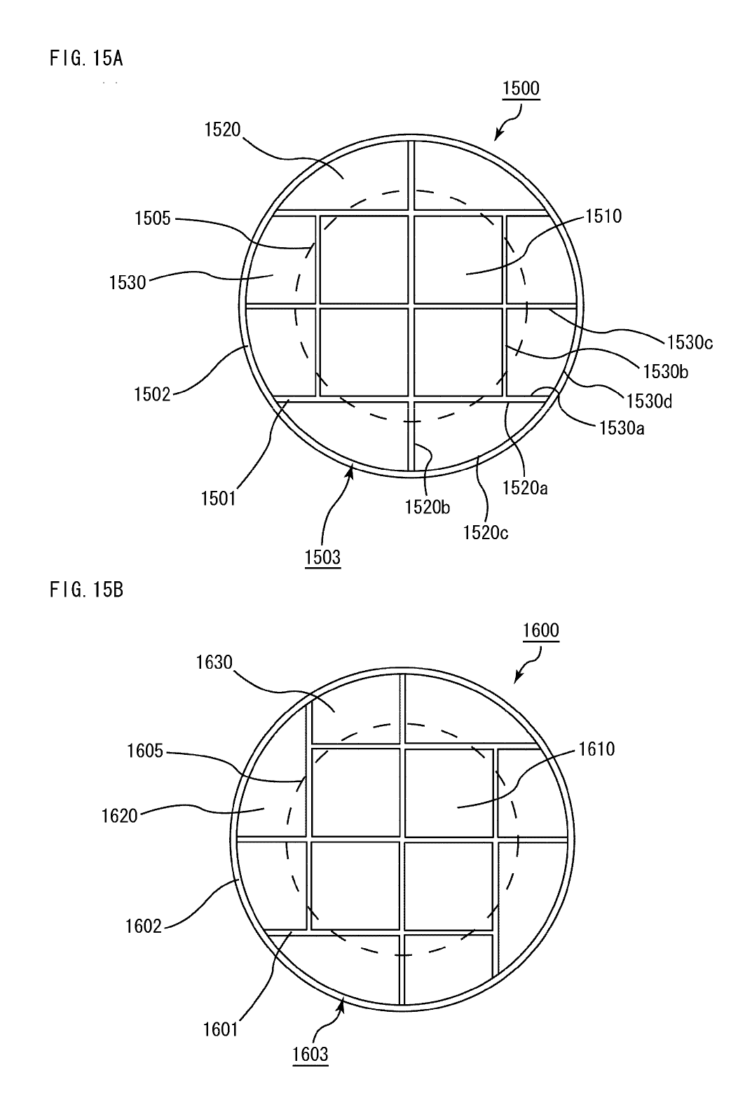

Specifically, the honeycomb structure may have a cross-sectional shape shown in FIGS. 15A and 15B.

Each of FIGS. 15A and 15B is a cross-sectional view of the honeycomb structure according to another embodiment of the second aspect of the present invention.

The honeycomb structure 1500 shown in FIG. 15A is identical to the honeycomb structure 1100 according to the first embodiment of the second aspect of the present invention except that the cross-sectional shape of the peripheral-portion honeycomb fired bodies 1520 is not the same as that of the peripheral-portion honeycomb fired bodies 1530.

That is, in the honeycomb structure 1500 shown in FIG. 15A, four pieces of the center-portion honeycomb fired bodies 1510 are combined with one another with the adhesive layer 1501 interposed therebetween, and four pieces of the peripheral-portion honeycomb fired bodies 1520 and four pieces of the peripheral-portion honeycomb fired bodies 1530 are located on the periphery of the four pieces of the center-portion honeycomb fired bodies 1510. These honeycomb fired bodies are combined with the adhesive layer 1501 interposed therebetween to form the ceramic block 1503.

The coat layer 1502 is formed on the periphery of the ceramic block 1503.

The cross section of each of the peripheral-portion honeycomb fired bodies 1520 is formed into a shape surrounded by two line segments 1520a and 1520b and an arc 1520c. An angle made by two line segments (the angle made by the line segments 1520a and 1520b) is about 90°.

The cross section of each of the peripheral-portion honeycomb fired bodies 1530 is formed into a shape surrounded by three line segments 1530a, 1530b and 1530c and an arc 1530d. The two angles made by two line segments out of these three line segments (an angle made by the line segments 1530b and 1530c and an angle made by the line segments 1530a and 1530b) are about 90°.

In the honeycomb structure 1500, provided that a figure (substantially round shape) 1505, which is similar to the shape of the ceramic block 1503 in the cross section and is concentric with the shape of the ceramic block 1503 in the cross section, is drawn in the cross section with an area ratio of the figure being about 49% to the area of the ceramic block 1503 in the cross section, a part of each of the peripheral-portion honeycomb fired bodies 1520 and 1530 is located in the FIG. 1505.

Thus, the honeycomb structure 1500 according to the embodiment of this kind is also allowed to exert the same effects as those of the honeycomb structure according to the first embodiment of the second aspect of the present invention.

The peripheral-portion honeycomb fired bodies 1520 and 1530 have the same functions as that of the peripheral-portion honeycomb fired bodies 1120 of the honeycomb structure 1100 although their cross-sectional shapes are different from that of the peripheral-portion honeycomb fired bodies 1120 of the honeycomb structure 1100.

The honeycomb structure 1600 shown in FIG. 15B is identical to the honeycomb structure 1500 shown in FIG. 15A except for the arrangement of the peripheral-portion honeycomb fired bodies 1620 and 1630.

That is, in the honeycomb structure 1600 shown in FIG. 15B, the peripheral-portion honeycomb fired body 1620 and the peripheral-portion honeycomb fired body 1630 are alternately placed with the adhesive layer 1601 interposed therebetween, which is different from the case in the honeycomb structure 1500 shown in FIG. 15A.

Each of the peripheral-portion honeycomb fired bodies 1620 and 1630 is identical to each of the peripheral-portion honeycomb fired bodies 1520 and 1530, respectively, except for the place in the honeycomb structure.

In the honeycomb structure 1600, provided that a figure (substantially round shape) 1605, which is similar to the shape of the ceramic block 1603 in the cross section and is concentric with the shape of the ceramic block 1603 in the cross section, is drawn in the cross section with an area ratio of the figure being about 49% to the area of the ceramic block 1603 in the cross section, a part of each of the peripheral-portion honeycomb fired bodies 1620 and 1630 is located in the FIG. 1605.

Thus, the honeycomb structure 1600 according to the embodiment of this kind is also allowed to exert the same effects as those of the honeycomb structure according to the first embodiment of the second aspect of the present invention.

In FIG. 15B, a reference numeral 1602 represents a coat layer, and a reference numeral 1610 represents a center-portion honeycomb fired body.

Each of the honeycomb structures 1500 and 1600 shown in FIGS. 15A and 15B, respectively, can be manufactured in the following manner: a necessary number of two kinds of honeycomb fired bodies with each kind having a different cross-sectional shape are combined with one another with an adhesive layer interposed therebetween to manufacture an aggregated body of the honeycomb fired bodies; and the periphery thereof is cut to manufacture the honeycomb structure.

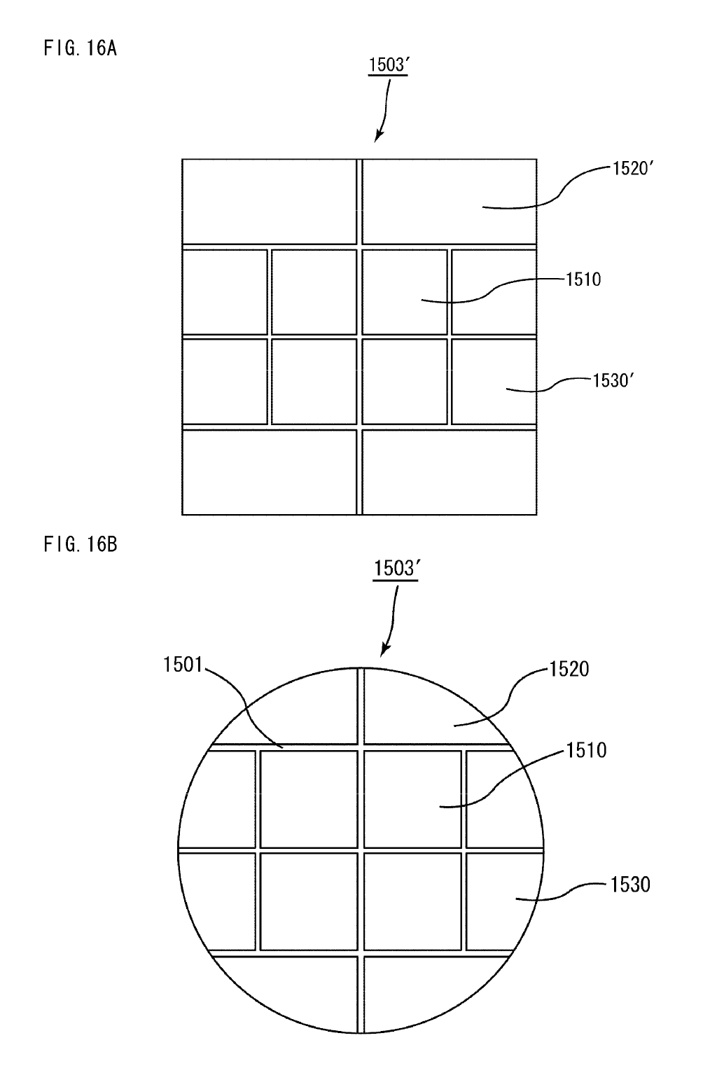

This will be described more specifically by exemplifying the case of manufacturing the honeycomb structure 1500 referring to FIGS. 16A and 16B.

FIGS. 16A and 16B are cross-sectional views for describing another example of a method for manufacturing a honeycomb structure according to the embodiments of the second aspect of the present invention.

(1) Honeycomb fired bodies with either one end of each of the cells sealed are manufactured by the same method as in the processes (1) to (3) of the first embodiment of the first aspect of the present invention.

At this time, a center-portion honeycomb fired body 1510 having a substantially rectangular cross-sectional shape and peripheral-portion honeycomb fired bodies 1520′ and 1530′ having a substantially rectangular cross-sectional shape are manufactured (see FIG. 16A).

The center-portion honeycomb fired body 1510 and the peripheral-portion honeycomb fired body 1530′ are substantially the same honeycomb fired body.

(2) Next, in the same manner as in the process (4) of the first embodiment of the first aspect of the present invention, the center-portion honeycomb fired bodies 1510 and the peripheral-portion honeycomb fired bodies 1520′ and 1530′ are combined with one another with the adhesive paste layer interposed therebetween so as to be arranged as shown in FIG. 16A. Moreover, an aggregated body of the honeycomb fired bodies 1503′ is manufactured by solidifying the adhesive paste layer.

(3) Next, a periphery cutting process is carried out in which the side face of the aggregated body of honeycomb fired bodies 1503′ is cut by using a diamond cutter or the like to form a substantially round pillar shape so as to manufacture a ceramic block 1503 in which the center-portion honeycomb fired bodies 1510 and the peripheral-portion honeycomb fired bodies 1520 and 1530 are combined with one another with the adhesive layer 1501 interposed therebetween (see FIG. 16B).

Then, if needed, a coat layer (not illustrated) is formed on the peripheral side face of the ceramic block 1503 to complete a honeycomb structure.

The shape of the honeycomb structure according to an embodiment of the second aspect of the present invention is not limited to a substantially round pillar shape. The shape may be a substantially cylindroid shape.

Specifically, when a figure (substantially elliptical shape), which is similar to the shape of the ceramic block in the cross section and is concentric with the shape of the ceramic block in the cross section, is drawn in the cross section with an area ratio of the figure being about 49% to the area of the ceramic block in the cross section and a part of each of the peripheral-portion honeycomb fired bodies is located in the figure, the honeycomb structure may be a substantially cylindroid shape having the substantially elliptical cross-sectional shape shown in FIG. 8.

This is because, also in the honeycomb structure having the substantially cylindroid shape, in the case that a part of each of the peripheral-portion honeycomb fired bodies is located in the figure, there is no peripheral-portion honeycomb fired body isolated from the center of the honeycomb structure (ceramic block) by interposing the adhesive layer, so that the honeycomb structure tends not to have a temperature distribution between the center portion and the peripheral portion.

Further, a shape of the cross section of the honeycomb structure may be a substantially elongated round shape or a substantially racetrack shape.

Referring to the drawings, the following description will discuss an embodiment of a honeycomb structure according to the third aspect of the present invention.

### First Embodiment of Third Aspect of the Present Invention

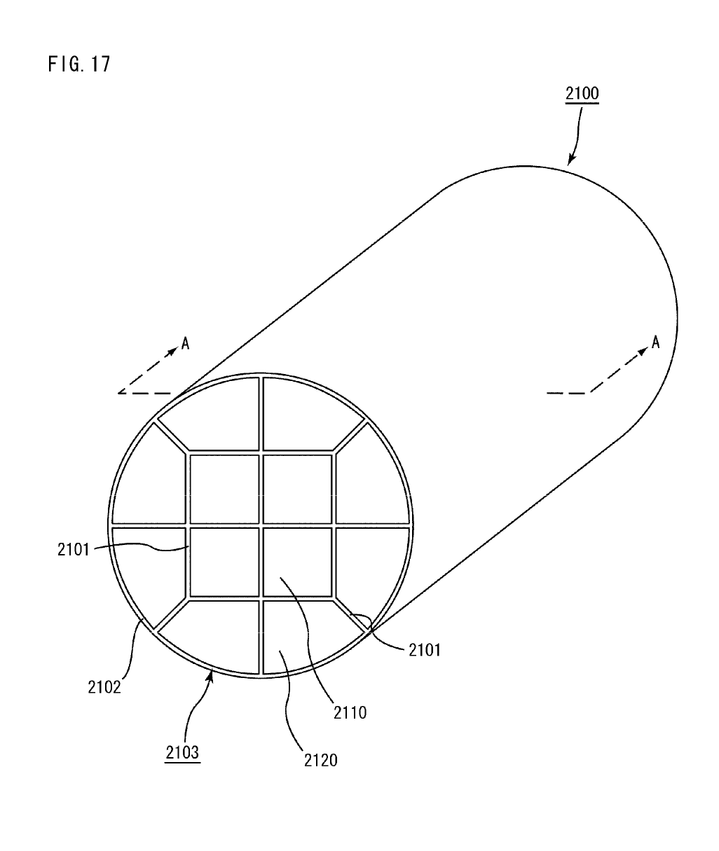

FIG. 17 is a perspective view schematically showing a honeycomb structure according to the first embodiment of the third aspect of the present invention.

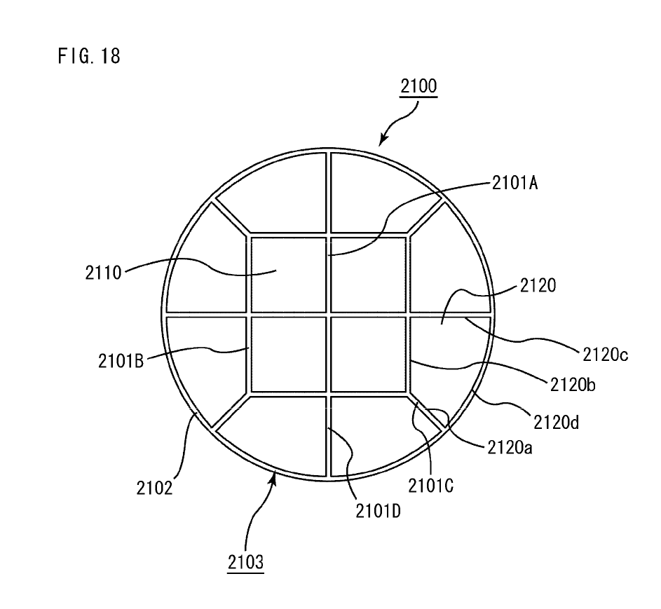

FIG. 18 is an A-A line cross-sectional view of the honeycomb structure shown in FIG. 17.

The honeycomb structure 2100 shown in FIGS. 17 and 18 has a structure in which a plurality of center-portion honeycomb fired bodies 2110 and a plurality of peripheral-portion honeycomb fired bodies 2120 are combined with one another with an adhesive layer 2101 (2101A to 2101D) interposed therebetween to form a ceramic block 2103. A coat layer 2102 is formed on the periphery of the ceramic block 2103.

The center-portion honeycomb fired body 2110 has almost the same shape as that of the center-portion honeycomb fired body 110 of the honeycomb structure 100 according to the first embodiment of the first aspect of the present invention, and includes the same material as that thereof. The peripheral-portion honeycomb fired body 2120 has almost the same shape as that of the peripheral-portion honeycomb fired body 120 of the honeycomb structure 100 according to the first embodiment of the first aspect of the present invention, and includes the same material as that thereof.

In the center-portion honeycomb fired body 2110 and the peripheral-portion honeycomb fired body 2120, either one end of each of the cells is sealed, so that the cell wall functions as a filter for capturing PM and the like.

As shown in FIGS. 17 and 18, in the honeycomb structure 2100, four pieces of the center-portion honeycomb fired bodies 2110 are located in the center portion of the cross section of the honeycomb structure 2100, and eight pieces of the peripheral-portion honeycomb fired bodies 2120 are located on the periphery of the four pieces of the center-portion honeycomb fired bodies 2110. These honeycomb fired bodies are combined with one another with the adhesive layers 2101 interposed therebetween so that the cross section of the honeycomb structure 2100 (ceramic block 2103) is formed into a substantially round shape.

The four pieces of the center-portion honeycomb fired bodies 2110 combined with one another by interposing the adhesive layer 2101A therebetween form the center portion in the cross-section of the honeycomb structure 2100. The eight pieces of the peripheral-portion honeycomb fired bodies 2120 combined with one another by interposing the adhesive layers 2101C and 2101D form the peripheral portion in the cross section of the honeycomb structure 2100.

In the cross section of the honeycomb structure 2100 having the above-mentioned configuration (see FIG. 18), the region occupied by the four pieces of the center-portion honeycomb fired bodies 2110, the adhesive layer 2101A combining the center-portion honeycomb fired bodies 2110 with one another, the adhesive layer 2101B combining the center-portion honeycomb fired body 2110 with the peripheral-portion honeycomb fired bodies 2120 corresponds to the center portion, and the region occupied by the eight pieces of the peripheral-portion honeycomb fired bodies 2120, and the adhesive layers 2101C and 2101D combining the peripheral-portion honeycomb fired bodies 2120 with one another corresponds to the peripheral portion.

Further, in the cross section of the honeycomb structure 2100, the adhesive layer 2101C (first peripheral-portion adhesive layer) that is formed in a direction extending from a corner point of the center portion to the peripheral side face of the honeycomb structure 2100 and the adhesive layer 2101D (second peripheral-portion adhesive layer) that is formed in a direction extending from the center portion other than the corner points thereof to the peripheral side face of the honeycomb structure 2100 form an angle of about 45°.

When the first peripheral-portion adhesive layer and the second peripheral-portion adhesive layer form an angle of about 45° as mentioned above, it is easier to prevent damages from occurring in the honeycomb structure.

Moreover, in the honeycomb structure 2100, at the corner point of the above-mentioned center-portion, the first peripheral-portion adhesive layer 2101C and the adhesive layers 2101B combining the center-portion honeycomb fired body 2110 with the peripheral-portion honeycomb fired body 2120 form a Y shape.

When there is a portion where the adhesive layers form a Y shape in the cross-section of the honeycomb structure as mentioned above, it is easier to prevent damages from occurring in the honeycomb structure.

Moreover, in the honeycomb structure 2100, the second peripheral-portion adhesive layer 2101D and the adhesive layers 2101A combining the center-portion honeycomb fired bodies 2110 with one another form a substantially straight line.

The adhesive layer of this kind is more likely to play a role as, so as to say, a beam for improving strength of the honeycomb structure.

The honeycomb structure according to the present embodiment can be manufactured by the same method for manufacturing the honeycomb structure according to the first embodiment of the first aspect of the present invention.

The following description will summarize the effects of the honeycomb structure of the present embodiment.

(1) In the honeycomb structure of the present embodiment, since the first peripheral-portion adhesive layer and the second peripheral-portion adhesive layer form an angle of about 45°, it is easier to prevent the honeycomb structure from being damaged due to compressive stress applied from the outside of the honeycomb structure.

(2) In the honeycomb structure of the present embodiment, since there is a portion where the adhesive layer forms a Y shape in the cross section of the honeycomb structure, it is easier to prevent the honeycomb structure from being damaged.

(3) In the honeycomb fired body of the honeycomb structure of the present embodiment, either one end of each of the cells is sealed with a plug. Therefore, the honeycomb structure of the present embodiment is more likely to be suitably used as a diesel particulate filter.

(4) In the honeycomb structure of the present embodiment, since the coat layer is formed on the peripheral side face of the ceramic block, it is easier to prevent leakage of particulates from the peripheral side face of the honeycomb structure.

### Example 3-1

The following description will discuss an example that specifically discloses the first embodiment of the third aspect of the present invention. Here, the third aspect of the present invention is not limited to the example.

(1) Honeycomb fired bodies were manufactured in the same manner as in the processes (1) to (3) of Example 1-1.

Thus, a center-portion honeycomb fired body 2110 including a silicon carbide sintered body and having a porosity of 45%, an average pore diameter of 15 μm, a size of 34.5 mm×34.5 mm×150 mm, the number of cells (cell density) of 300 pcs/inch² and a thickness of cell walls of 0.25 mm (10 mil) was manufactured.

Also, a peripheral-portion honeycomb fired body 2120 having the same porosity, the same average pore diameter, the same number of cells (cell density) and the same thickness of cell walls as those of the center-portion honeycomb fired body 2110 and also having a cross-sectional shape surrounded by three line segments and an arc, with the two angles, made by two line segments out of these three line segments, being 90° and 135° (line segment 2120a=20.8 mm, line segment 2120b=35.0 mm and line segment 2120c=35.7 mm) was manufactured.

(2) A honeycomb structure 2100 with a coat layer 2102 formed on the periphery thereof was manufactured in the same manner as in the processes (4) and (5) of Example 1-1.

The honeycomb structure 2100 has a round pillar shape with a size of 143.8 mm in diameter×150 mm in length.

The cross-sectional shape of the honeycomb structure 2100 manufactured in Example 3-1 is shown in FIG. 18.

In the honeycomb structure 2100, the first peripheral-portion adhesive layer 2101C and the second peripheral-portion adhesive layer 2101D form an angle of 45° in the cross section of the honeycomb structure 2100.

Further, in the cross section of the honeycomb structure 2100, there is a portion where the first peripheral-portion adhesive layer 2101C and the adhesive layers 2101B combining the center-portion honeycomb fired body 2110 and the peripheral portion honeycomb fired body 2120 form a Y shape.

### Comparative Example 3-1

A honeycomb structure same as that in Comparative Example 1-1 was manufactured.

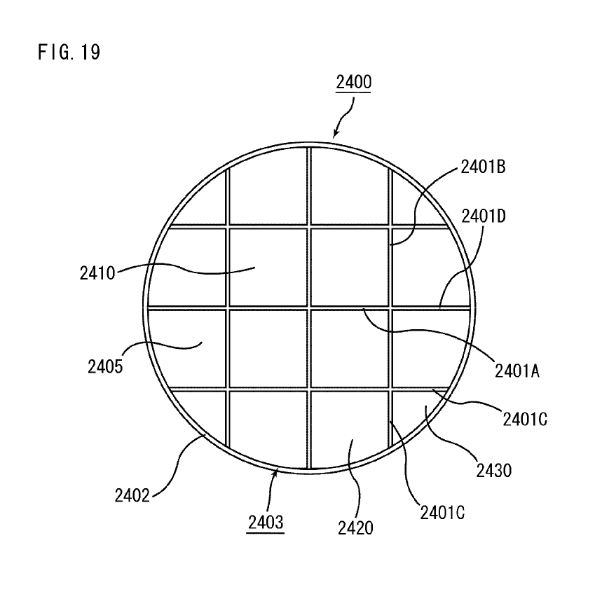

The cross-sectional shape of the honeycomb structure 2400 manufactured in Comparative Example 3-1 is shown in FIG. 19.

FIG. 19 is a cross-sectional view that shows the honeycomb structure 2400 manufactured in Comparative Example 3-1, and in FIG. 19, a reference numeral 2410 represents a center-portion honeycomb fired body, reference numerals 2420 and 2430 represent peripheral-portion honeycomb fired bodies, reference numerals 2401A to 2401D represent adhesive layers, a reference numeral 2402 represents a coat layer and a reference numeral 2403 represents a ceramic block.

In the honeycomb structure 2400, the first peripheral-portion adhesive layer 2401C and the second peripheral-portion adhesive layer 2401D are in parallel or form an angle of 90° in the cross section.

Further, in the cross section of the honeycomb structure 2400, there is no portion where the adhesive layers form the Y-shape.

### (Evaluation of Honeycomb Structure)

With respect to the honeycomb structure manufactured in each of Example 3-1 and Comparative example 3-1, isostatic strength was measured in conformity to “JASO M 505-87; method for testing ceramic monolith supporting carrier for automobile exhaust-gas purifying catalyst” defined in Japanese Automobile Standards Organization instituted by Society of Automotive Engineers of Japan, Inc.

The contents of JASO M 505-87 are incorporated herein by reference in their entirety.

Isostatic strength of the honeycomb structure of Example 3-1 was measured to be 9 MPa.

On the other hand, isostatic strength of the honeycomb structure of Comparative Example 3-1 was measured to be 6 MPa.

As mentioned above, it is clear that the honeycomb structure according to the first embodiment of the third aspect of the present invention was more suitable for preventing the honeycomb structure from being damaged than the conventional honeycomb structure (the honeycomb structure of the Comparative Example 3-1).

### Second Embodiment of Third Aspect of the Present Invention

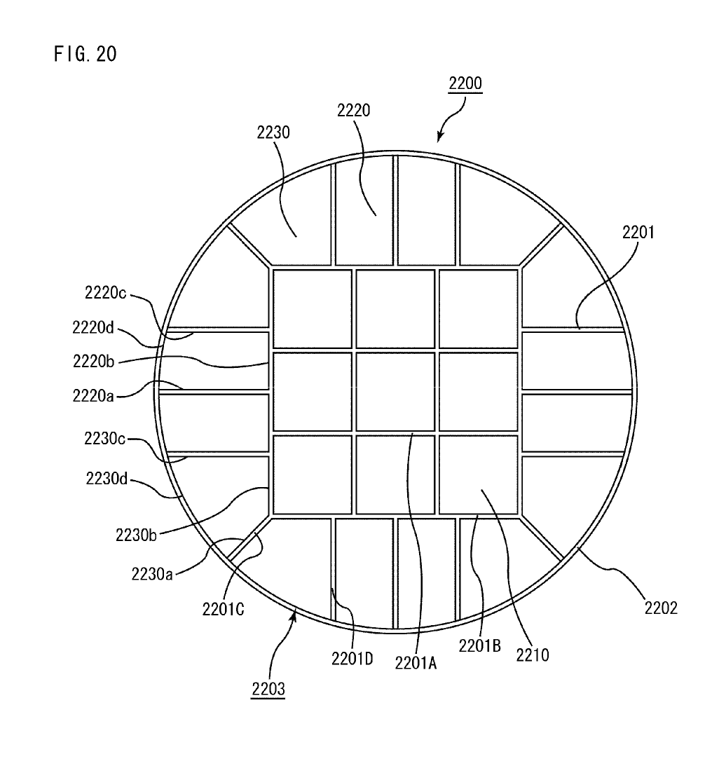

FIG. 20 is a cross-sectional view of a honeycomb structure according to the second embodiment of the third aspect of the present invention.

As shown in FIG. 20, the honeycomb structure 2200 of the present embodiment has a structure in which a plurality of center-portion honeycomb fired bodies 2210 and pluralities of peripheral-portion honeycomb fired bodies 2220 and 2230 are combined with one another with adhesive layers 2201A to 2201D interposed therebetween to form a ceramic block 2203. A coat layer 2202 is formed on the periphery of the ceramic block 2203.

The center-portion honeycomb fired body 2210 has almost the same shape as that of the center-portion honeycomb fired body 210 of the honeycomb structure 200 according to the second embodiment of the first aspect of the present invention, and includes the same material as that thereof. The peripheral-portion honeycomb fired bodies 2220 and 2230 have almost the same shape as those of the peripheral-portion honeycomb fired bodies 220 and 230 of the honeycomb structure 200 according to the second embodiment of the first aspect of the present invention, and include the same material as those thereof.

As shown in FIG. 20, in the honeycomb structure 2200, nine pieces of the center-portion honeycomb fired bodies 2210 are located in the center portion of the cross section of the honeycomb structure 2200, and eight pieces of the peripheral-portion honeycomb fired bodies 2220 and eight pieces of the peripheral-portion honeycomb fired bodies 2230 are located on the periphery of the nine pieces of the center-portion honeycomb fired bodies 2210. These honeycomb fired bodies are combined with one another with the adhesive layers 2201A to 2201D interposed therebetween so that the cross section of the honeycomb structure 2200 (ceramic block 2203) is formed into a substantially round shape.

The nine pieces of the center-portion honeycomb fired bodies 2210 combined with one another by interposing the adhesive layer 2201A therebetween form the center portion in the cross-section of the honeycomb structure 2200. The total 16 pieces of the peripheral-portion honeycomb fired bodies 2220 and 2230 combined with one another by interposing the adhesive layer 2201C or 2201D form the peripheral portion in the cross section of the honeycomb structure 2200.

In the cross section of the honeycomb structure 2200 having the above-mentioned configuration, the region occupied by the nine pieces of the center-portion honeycomb fired bodies 2210, the adhesive layer 2201A combining the center-portion honeycomb fired bodies 2210 with one another, and the adhesive layer 2201B combining the center-portion honeycomb fired body 2210 with the peripheral-portion honeycomb fired bodies 2220 and 2230 corresponds to the center portion, and the region occupied by the 16 pieces of the peripheral-portion honeycomb fired bodies 2220 and 2230, and the adhesive layers 2201C and 2201D combining the peripheral-portion honeycomb fired bodies 2220 and 2230 with one another corresponds to the peripheral portion.

Further, in the cross section of the honeycomb structure 2200, the adhesive layer 2201C (first peripheral-portion adhesive layer) that is formed in a direction extending from a corner point of the center portion to the peripheral side face of the honeycomb structure 2200 and the adhesive layer 2201D (second peripheral-portion adhesive layer) that is formed in a direction extending from the center portion other than the corner points thereof to the peripheral side face of the honeycomb structure 2200 form an angle of about 45°.

When the first peripheral-portion adhesive layer and the second peripheral-portion adhesive layer form an angle of about 45° as mentioned above, it is easier to prevent damages from occurring in the honeycomb structure.

Moreover, in the honeycomb structure 2200, at the corner point of the above-mentioned center portion, the first peripheral-portion adhesive layer 2201C and the adhesive layers 2201B combining the center-portion honeycomb fired body 2210 with the peripheral-portion honeycomb fired body 2220 form a Y shape.

When there is a portion where the adhesive layers form a Y shape in the cross-section of the honeycomb structure as mentioned above, it is easier to prevent damages from occurring in the honeycomb structure.

The honeycomb structure according to the present embodiment can be manufactured by the same method for manufacturing the honeycomb structure according to the second embodiment of the first aspect of the present invention.

The honeycomb structure of the present embodiment is allowed to exert the same effects as those of the honeycomb structure of the first embodiment of the third aspect of the present invention.

### Example 3-2

The following description will discuss an example that specifically discloses the second embodiment of the third aspect of the present invention. Here, the third aspect of the present invention is not limited to the example.

(1) Honeycomb fired bodies were manufactured in the same manner as in the processes (1) to (3) of Example 1-4.

Thus, a center-portion honeycomb fired body 2210 including a silicon carbide sintered body and having a porosity of 45%, an average pore diameter of 15 μm, a size of 34.5 mm×34.5 mm×200 mm, the number of cells (cell density) of 300 pcs/inch² and a thickness of cell walls of 0.25 mm (10 mil) was manufactured.

Also, a peripheral-portion honeycomb fired body 2220 having the same porosity, the same average pore diameter, the same number of cells (cell density) and the same thickness of cell walls as those of the center-portion honeycomb fired body 2210 and also having a cross-sectional shape surrounded by three line segments and an arc, with the two angles, made by two line segments out of these three line segments, being 90° (line segment 2220a=45.6 mm, line segment 2220b=26.8 mm and line segment 2220c=41.8 mm) was manufactured.

Further, a peripheral-portion honeycomb fired body 2230 having the same porosity, the same average pore diameter, the same number of cells (cell density) and the same thickness of cell walls as those of the center-portion honeycomb fired body 2210 and also having a cross-sectional shape surrounded by three line segments and an arc, with the two angles, made by two line segments out of these three line segments, being 90° and 135° (line segment 2230a=24.9 mm, line segment 2230b=24.5 mm and line segment 2230c=41.8 mm) was manufactured.

(2) A honeycomb structure 2200 with a coat layer 2202 formed on the periphery thereof was manufactured in the same manner as in the processes (4) and (5) of Example 1-4.

The honeycomb structure 2200 has a round pillar shape with a size of 203.2 mm in diameter×200 mm in length.

The cross-sectional shape of the honeycomb structure 2200 manufactured in Example 3-2 is shown in FIG. 20.

In the honeycomb structure 2200, the first peripheral-portion adhesive layer 2201C and the second peripheral-portion adhesive layer 2201D form an angle of 45° in the cross section of the honeycomb structure 2200.

Further, in the cross section of the honeycomb structure 2200, there is a portion where the first peripheral-portion adhesive layer 2201C and the peripheral-portion adhesive layers 2201B combining the center-portion honeycomb fired body 2210 and the peripheral-portion honeycomb fired body 2220 form a Y shape.

Measurement of isostatic strength of the honeycomb structure manufactured in Example 3-2 was carried out in the same manner as in Example 3-1.

Isostatic strength of the honeycomb structure manufactured in Example 3-2 was measured to be 8.5 MPa.

As mentioned above, it is clear that the honeycomb structure manufactured in Example 3-2 (the second embodiment of the third aspect of the present invention) is suitable for preventing the honeycomb structure from being damaged.

### Other Embodiments of Third Aspect of the Present Invention

The honeycomb structure according to each of the first and second embodiments of the third aspect of the present invention may be manufactured in the same manner as in, for example, the third embodiment of the first aspect of the present invention.

The cross-sectional shape of the honeycomb structure according to the embodiments of the third aspect of the present invention is not limited to a substantially round shape. The cross-sectional shape may be a substantially elliptical shape, a substantially elongated round shape, a substantially racetrack shape or the like.

Moreover, in the honeycomb structure according to the embodiments of the present invention, the number of the center-portion honeycomb fired body is not limited to plural, and may be one.

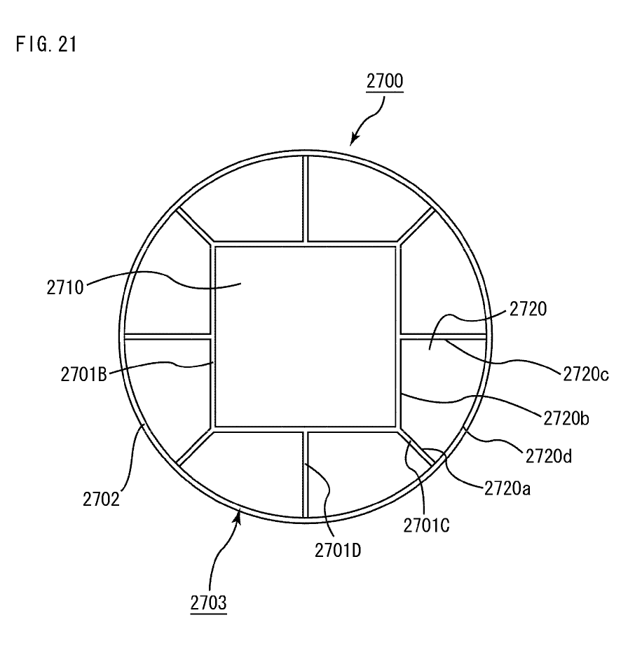

Specifically, the shape of the cross section of the honeycomb structure may be a shape shown in FIG. 21.

FIG. 21 is a cross-sectional view of a honeycomb structure according to another embodiment of the third aspect of the present invention.

The honeycomb structure 2700 as illustrated in FIG. 21 has the same structure as that of the honeycomb structure 2100 of the first embodiment of the third aspect of the present invention, except that the number of the center-portion honeycomb fired bodies is different.

That is, the honeycomb structure 2700 as illustrated in FIG. 21 includes one center-portion honeycomb fired body 2710 instead of the four pieces of the center-portion honeycomb fired bodies 2110 combined with one another with the adhesive layer 2101A interposed therebetween in the honeycomb structure 2100 as illustrated in FIG. 18.

Compared with the center-portion honeycomb fired body 2110, the center-portion honeycomb fired body 2710 has a larger cross-sectional area but has the same functions.

In the cross-section of the honeycomb structure 2700 of this kind, the first peripheral-portion adhesive layer 2701C and the second peripheral-portion adhesive layer 2701D form an angle of about 45°.

Further, in the honeycomb structure 2700, the first peripheral-portion adhesive layer 2701C and the adhesive layers 2701B combining the center-portion honeycomb fired body 2710 with the peripheral-portion honeycomb fired body 2720 form a Y shape at a corner point of the center portion.

Therefore, the honeycomb structure 2700 is allowed to exert the same effects as the effects described in the first embodiment of the third aspect of the present invention.

Here, in FIG. 21, the reference numeral 2702 represents a coat layer, and the reference numeral 2703 represents a ceramic block.

In the cross section of the honeycomb structure according to the embodiments of the third aspect of the present invention, the angle formed by the first peripheral-portion adhesive layer and the second peripheral portion adhesive layer is not limited to about 45°, and may be an angle of at least about 40° and at most about 50°.

This is because, the angle formed by the first peripheral-portion adhesive layer and the second peripheral-portion adhesive layer within the above range is appropriate for preventing damages due to compressive stress generated in various directions on the peripheral side face of the honeycomb structure.

Although all the angles formed by the first peripheral-portion adhesive layer and the second peripheral-portion adhesive layer are angles of at least about 40° and at most about 50° in the honeycomb structure of the embodiment mentioned above, not all of the angles should be at least about 40° and at most about 50° as long as at least one angle is at least about 40° and at most about 50° out of the angles formed by the first peripheral-portion adhesive layer and the second peripheral-portion adhesive layer in the honeycomb structure of the present embodiment.

With respect to the honeycomb structure according to the embodiments of the third aspect of the present invention, the cross-sectional area of the center-portion honeycomb fired body is preferably at least about 900 mm² and at most about 2500 mm².

In the case that the cross-sectional area of the center-portion honeycomb fired body is in the above range, cracks tend not to occur in the honeycomb structure upon carrying out a regenerating process on the honeycomb structure.

Referring to the drawings, the following description will discuss an embodiment of a honeycomb structure according to the fourth aspect of the present invention.

### First Embodiment of Fourth Aspect of the Present Invention

In the honeycomb structure of the present embodiment, a cross-sectional area of a ceramic block is about 10000 mm² or more and less than 25000 mm².

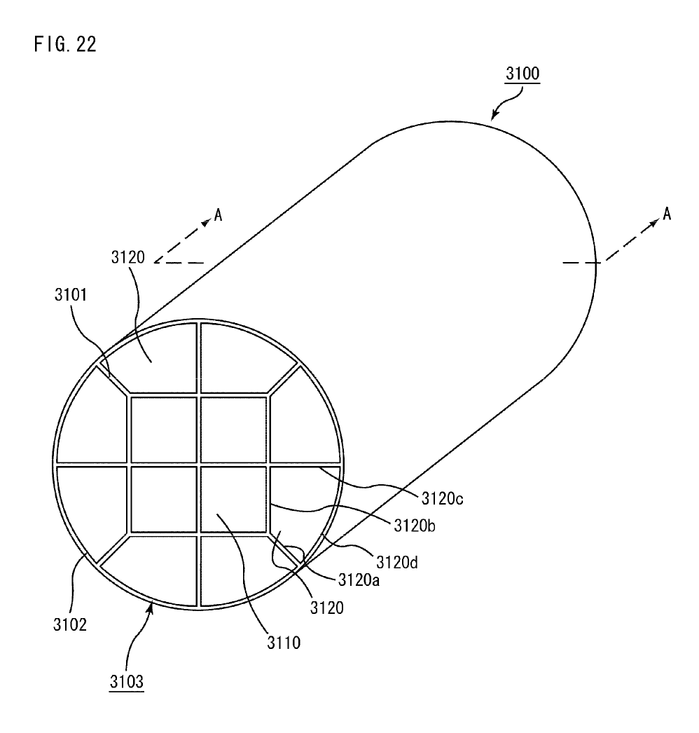

FIG. 22 is a perspective view schematically showing a honeycomb structure according to the first embodiment of the fourth aspect of the present invention.

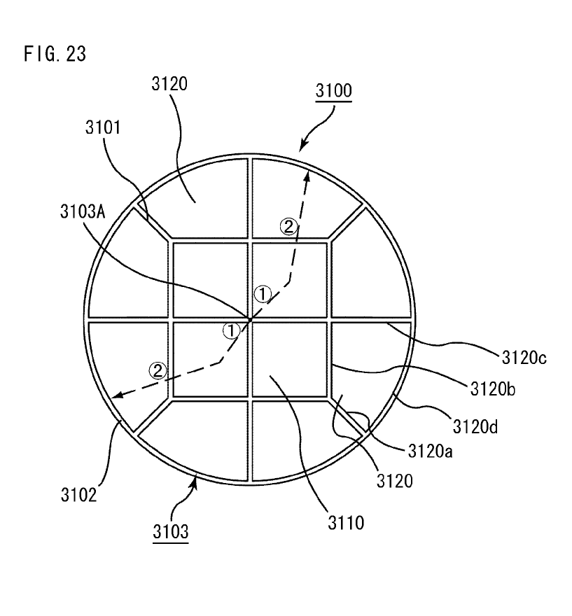

FIG. 23 is an A-A line cross-sectional view of the honeycomb structure shown in FIG. 22.

The honeycomb structure 3100 shown in FIGS. 22 and 23 has a structure in which a plurality of honeycomb fired bodies 3110 and a plurality of honeycomb fired bodies 3120 are combined with one another with an adhesive layer 3101 interposed therebetween to form a ceramic block 3103. A coat layer 3102 is formed on the periphery of the ceramic block 3103.

The honeycomb fired body 3110 has almost the same shape as that of the center-portion honeycomb fired body 110 of the honeycomb structure 100 according to the first embodiment of the first aspect of the present invention, and includes the same material as that thereof. The honeycomb fired body 3120 has almost the same shape as that of the peripheral-portion honeycomb fired body 120 of the honeycomb structure 100 according to the first embodiment of the first aspect of the present invention, and includes the same material as that thereof.

In the honeycomb fired body 3110 and the honeycomb fired body 3120, either one end of each of the cells is sealed, so that the cell wall functions as a filter for capturing PM and the like.

As shown in FIGS. 22 and 23, in the honeycomb structure 3100, four pieces of the honeycomb fired bodies 3110 combined with one another with the adhesive layer 3101 interposed therebetween are located in the center portion of the cross section of the honeycomb structure 3100, and eight pieces of the honeycomb fired bodies 3120 are located on the periphery of the four pieces of the honeycomb fired bodies 3110 so that the cross section of the honeycomb structure 3100 (ceramic block 3103) is formed into a substantially round shape.

In the cross section of the honeycomb structure 3100, the number of the adhesive layers existing on a route which passes through the honeycomb fired bodies 3110 and 3120 and extends from the center of gravity 3103A of the ceramic block 3103 to the periphery of the ceramic block 3103 (see an arrow in FIG. 23) is two or less.

As mentioned above, in the case that the cross-sectional area of the ceramic block is about 10000 mm² or more and less than 25000 mm², and the number of the adhesive layers existing on a route which passes through the honeycomb fired bodies and extends from the center of gravity of the ceramic block to the periphery of the ceramic block in the cross section is two or less, the honeycomb structure is allowed to exert the following effects:

the adhesive layer easily alleviates thermal stress, and thus, it is easier to prevent occurrence of cracks and damages on the honeycomb structure, and

the honeycomb structure tends not to have a temperature distribution between the center portion and the peripheral portion of the honeycomb structure, and thus, unburned particulates tend not to remain upon carrying out a regenerating process.

The honeycomb structure according to the present embodiment can be manufactured by the same method for manufacturing the honeycomb structure according to the first embodiment of the first aspect of the present invention.

The following description will summarize the effects of the honeycomb structure of the present embodiment.

(1) In the honeycomb structure of the present embodiment, the cross-sectional area of the honeycomb fired body is at least about 900 mm² and at most about 2500 mm², the cross-sectional area of the ceramic block is about 10000 mm² or more and less than 25000 mm², and the number of the adhesive layers existing on a route which passes through the honeycomb fired bodies and extends from the center of gravity of the ceramic block to the periphery of the ceramic block in the cross section is two or less.

Thus, the honeycomb structure is allowed to exert the following effects:
the adhesive layer easily alleviates thermal stress, and thus, it is easier to prevent occurrence of cracks and damages on the honeycomb structure; and

the honeycomb structure tends not to have a temperature distribution between the center portion and the peripheral portion of the honeycomb structure, and thus, unburned particulates tend not to remain upon carrying out a regenerating process.

(2) In the honeycomb fired body of the honeycomb structure of the present embodiment, either one end of each of the cells is sealed with a plug. Therefore, the honeycomb structure of the present embodiment is more likely to be suitably used as a diesel particulate filter.

(3) In the honeycomb structure of the present embodiment, since the coat layer is formed on the peripheral side face of the ceramic block, it is easier to prevent leakage of particulates from the peripheral side face of the honeycomb structure.

(4) In the honeycomb structure of the present embodiment, since the ceramic block has a substantially round cross-sectional shape, in the case that the cross-sectional area and the number of the adhesive layers existing on a route which extends from the center of gravity of the ceramic block to the periphery of the ceramic block in the cross section satisfy the above relationships, the effect that the honeycomb structure tends not to have a temperature distribution between the center portion and the peripheral portion is more likely to be easily exerted.

### Example 4-1

The following description will discuss an example that specifically discloses the first embodiment of the fourth aspect of the present invention. Here, the fourth aspect of the present invention is not limited to the examples.

(1) Honeycomb fired bodies were manufactured in the same manner as in the processes (1) to (3) of Example 1-1.

Thus, a honeycomb fired body 3110 including a silicon carbide sintered body and having a porosity of 45%, an average pore diameter of 15 μm, a size of 34.5 mm×34.5 mm×150 mm, the number of cells (cell density) of 300 pcs/inch², a thickness of cell walls of 0.25 mm (10 mil), and a cross-sectional area of 1190 mm² was manufactured.

Also, a honeycomb fired body 3120 having the same porosity, the same average pore diameter, the same number of cells (cell density) and the same thickness of cell walls as those of the honeycomb fired body 3110 and also having a cross-sectional shape surrounded by three line segments and an arc, with the two angles, made by two line segments out of these three line segments, being 90° and 135° (line segment 3120a=20.3 mm, line segment 3120b=34.6 mm and line segment 3120c=34.6 mm), and a cross-sectional area of 1293 mm² was manufactured.

(2) A honeycomb structure 3100 with a coat layer 3102 formed on the periphery thereof was manufactured in the same manner as in the processes (4) and (5) of Example 1-1. The honeycomb structure 3100 has a round pillar shape with a size of 143.8 mm in diameter×150 mm in length.

The cross-sectional shape of the honeycomb structure manufactured in Example 4-1 is shown in FIG. 23.

The cross-sectional area of the honeycomb fired body 3110 is 1190 mm², the cross-sectional area of the honeycomb fired body 3120 is 1293 mm², the cross-sectional area of the ceramic block 3103 is 16151 mm², and the number of the adhesive layers existing on a route which passes through the honeycomb fired bodies 3110 and 3120 and extends from the center of gravity 3103A of the ceramic block 3103 to the periphery of the ceramic block 3103 in the cross section is two.

### Comparative Example 4-1

A honeycomb structure same as that in Comparative Example 1-1 was manufactured.

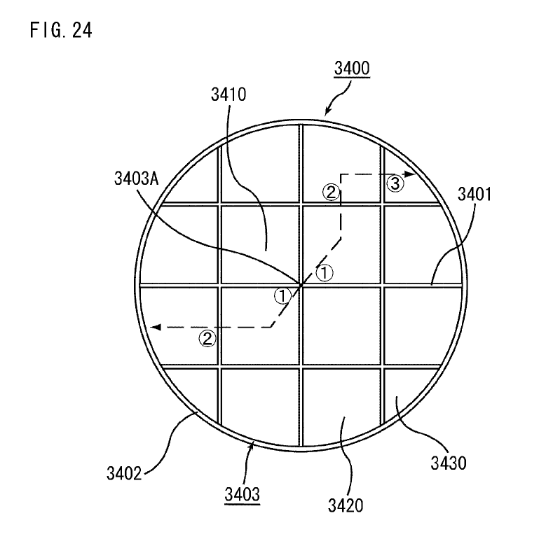

The cross-sectional shape of the honeycomb structure manufactured in Comparative Example 4-1 is shown in FIG. 24.

FIG. 24 is a cross-sectional view that shows the honeycomb structure 3400 manufactured in Comparative Example 4-1, and in FIG. 24, reference numerals 3410, 3420, and 3430 represent honeycomb fired bodies, a reference numeral 3401 represents an adhesive layer, a reference numeral 3402 represents a coat layer and a reference numeral 3403 represents a ceramic block.

The cross-sectional area of the honeycomb fired body 3410 is 1190 mm², the cross-sectional area of the honeycomb fired body 3420 is 1095 mm², the cross-sectional area of the honeycomb fired body 3430 is 357 mm², the cross-sectional area of the ceramic block 3403 is 16151 mm², and the number of the adhesive layers existing on a route which passes through the honeycomb fired bodies 3410, 3420, and 3430 and extends from the center of gravity 3403A of the ceramic block 3403 to the periphery of the ceramic block 3403 in the cross section is three, while the number of the adhesive layers existing on a route which passes through the honeycomb fired bodies 3410 and 3420 and extends from the center of gravity 3403A of the ceramic block 3403 to the periphery of the ceramic block 3403 in the cross section is two.

### (Evaluation of Honeycomb Structure)

Evaluated in the same manner as in Example 1-1, the regenerating rate of the honeycomb structure of Example 4-1 was 85%, and the regenerating rate of the honeycomb structure of Comparative Example 4-1 was 70%.

The reason of this is presumably because a large amount of unburned particulates remained upon carrying out the regenerating process on the honeycomb structure of Comparative Example 4-1.

### Second Embodiment of Fourth Aspect of the Present Invention

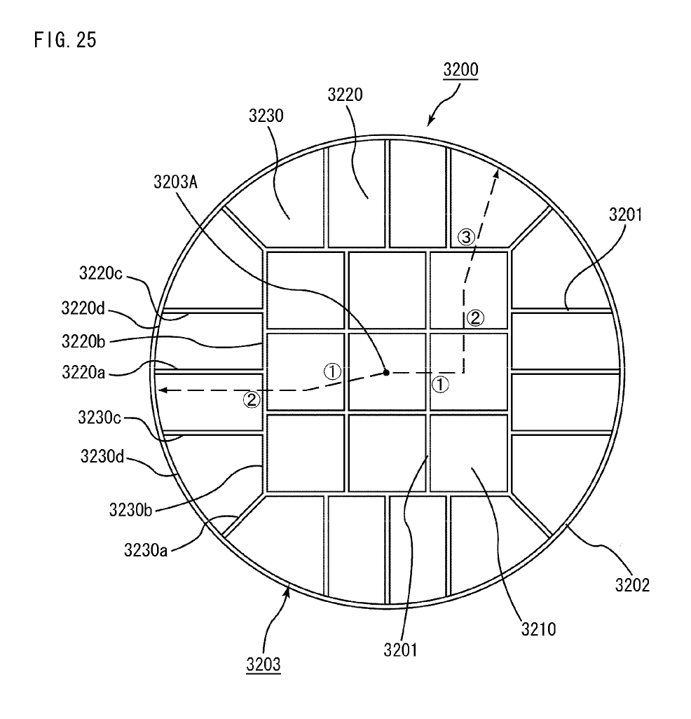

FIG. 25 is a cross-sectional view of a honeycomb structure according to the second embodiment of the fourth aspect of the present invention.

In the honeycomb structure 3200 of the present embodiment, a cross-sectional area of a ceramic block 3203 is 25000 mm² or more and less than 40000 mm².

As shown in FIG. 25, the honeycomb structure 3200 of the present embodiment has a structure in which pluralities of honeycomb fired bodies 3210, 3220 and 3230 are combined with one another with an adhesive layer 3201 interposed therebetween to form a ceramic block 3203. A coat layer 3202 is formed on the periphery of the ceramic block 3203.

The honeycomb fired bodies 3210 has almost the same shape as that of the center-portion honeycomb fired bodies 210 of the honeycomb structure 200 according to the second embodiment of the first aspect of the present invention, and includes the same material as that thereof. The honeycomb fired bodies 3220 and 3230 have almost the same shape as those of the peripheral-portion honeycomb fired bodies 220 and 230 respectively of the honeycomb structure 200 according to the second embodiment of the first aspect of the present invention, and include the same material as those thereof.

Further, a cross-sectional area of each of the honeycomb fired bodies 3210, 3220 and 3230 is at least about 900 mm² and at most about 2500 mm².

As shown in FIG. 25, in the honeycomb structure 3200, nine pieces of the honeycomb fired bodies 3210 combined with one another with the adhesive layer 3201 interposed therebetween are located in the center portion of the cross section of the honeycomb structure 3200, and eight pieces of the honeycomb fired bodies 3220 and eight pieces of the honeycomb fired bodies 3230 are located on the periphery of the nine pieces of the honeycomb fired bodies 3210 so that the cross section of the honeycomb structure 3200 (ceramic block 3203) is formed into a substantially round shape.

In the cross section of the honeycomb structure 3200, the number of the adhesive layers existing on a route which passes through the honeycomb fired bodies 3210 and 3220 and extends from the center of gravity 3203A of the ceramic block 3203 to the periphery of the ceramic block 3203 (see an arrow in FIG. 25) is two.

In the cross section of the honeycomb structure 3200, the number of the adhesive layers existing on a route which passes through the honeycomb fired bodies 3210 and 3230 and extends from the center of gravity 3203A of the ceramic block 3203 to the periphery of the ceramic block 3203 (see an arrow in FIG. 25) is three.

As mentioned above, in the case that the cross-sectional area of the ceramic block is 25000 mm² or more and less than 40000 mm², and the number of the adhesive layers existing on a route which passes through the honeycomb fired bodies and extends from the center of gravity of the ceramic block to the periphery of the ceramic block in the cross section is three or less, the honeycomb structure is allowed to exert the following effects:

the adhesive layer easily alleviates thermal stress, and thus, it is easier to prevent occurrence of cracks and damages on the honeycomb structure; and

the honeycomb structure tends not to have a temperature distribution between the center portion and the peripheral portion, and thus, unburned particulates tend not to remain upon carrying out a regenerating process.

The honeycomb structure according to the present embodiment can be manufactured by the same method for manufacturing the honeycomb structure according to the second embodiment of the first aspect of the present invention.

The honeycomb structure of the present embodiment is allowed to exert the same effects as those of the honeycomb structure of the first embodiment of the fourth aspect of the present invention.

### Example 4-2

The following description will discuss an example that specifically discloses the second embodiment of the fourth aspect of the present invention. Here, the fourth aspect of the present invention is not limited to the example.

(1) Honeycomb fired bodies were manufactured in the same manner as in the processes (1) to (3) of Example 1-4.

Thus, a honeycomb fired body 3210 including a silicon carbide sintered body and having a porosity of 45%, an average pore diameter of 15 μm, a size of 34.5 mm×34.5 mm×200 mm, the number of cells (cell density) of 300 pcs/inch², a thickness of cell walls of 0.25 mm (10 mil), and a cross-sectional area of 1190 mm² was manufactured.

Also, a honeycomb fired body 3220 having the same porosity, the same average pore diameter, the same number of cells (cell density) and the same thickness of cell walls as those of the honeycomb fired body 3210 and also having a cross-sectional shape surrounded by three line segments and an arc, with the two angles, made by two line segments out of these three line segments, being 90° (line segment 3220a=45.6 mm, line segment 3220b=26.8 mm and line segment 3220c=41.8 mm), and a cross-sectional area of 1226 mm² was manufactured.

Further, a honeycomb fired body 3230 having the same porosity, the same average pore diameter, the same number of cells (cell density) and the same thickness of cell walls as those of the honeycomb fired body 3210 and also having a cross-sectional shape surrounded by three line segments and an arc, with the two angles, made by two line segments out of these three line segments, being 900 and 135° (line segment 3230a=24.9 mm, line segment 3230b=24.5 mm and line segment 3230c=41.8 mm), and a cross-sectional area of 1226 mm² was manufactured.

(2) A honeycomb structure 3200 with a coat layer 3202 formed on the periphery thereof was manufactured in the same manner as in the processes (4) and (5) of Example 1-4.

In the honeycomb structure 3200, a cross-sectional area of the ceramic block is 32302 mm². The honeycomb structure 3200 has a round pillar shape with a size of 203.2 mm in diameter×200 mm in length.

The cross-sectional shape of the honeycomb structure manufactured in Example 4-2 is shown in FIG. 25.

The cross-sectional area of the honeycomb fired body 3210 is 1190 mm², the cross-sectional area of the honeycomb fired body 3220 is 1226 mm², the cross-sectional area of the honeycomb fired body 3230 is 1226 mm², the cross-sectional area of the ceramic block 3203 is 32302 mm², the number of the adhesive layers existing on a route which passes through the honeycomb fired bodies 3210 and 3220 and extends from the center of gravity 3203A of the ceramic block 3203 to the periphery of the ceramic block 3203 in the cross section is two, and the number of the adhesive layers existing on a route which passes through the honeycomb fired bodies 3210 and 3230 and extends from the center of gravity 3203A of the ceramic block 3203 to the periphery of the ceramic block 3203 in the cross section is three.

### Comparative Example 4-2

(1) By carrying out the same process as the process (1) of Example 4-1, a honeycomb fired body including a silicon carbide sintered body and having a porosity of 45%, an average pore diameter of 15 μm, a size of 34.5 mm×34.5 mm×200 mm, the number of cells (cell density) of 300 pcs/inch², a thickness of cell walls of 0.25 mm (10 mil), and a cross-sectional area of 1190 mm² was manufactured.

(2) An adhesive paste was applied to a predetermined side face of the honeycomb fired body, and 32 pieces of the honeycomb fired bodies were bonded to one another with the adhesive paste interposed therebetween. The adhesive paste was solidified at 180° C. in 20 minutes to manufacture an aggregated body of the honeycomb fired bodies having a rectangular pillar shape, with the thickness of the adhesive layer being 1 mm.

Here, as the adhesive paste, the same adhesive paste as that used in Example 1-1 was used.

(3) Next, the periphery of the aggregated body of the honeycomb fired bodies was cut by using a diamond cutter to manufacture a round pillar-shaped ceramic block having a cross-sectional area of 32302 mm².

Subsequently, a coating material paste layer was formed on the periphery of the ceramic block by using the coating material paste made of the same material as that of the adhesive paste. Further, this coating material paste layer was dried at a temperature of 120° C. to manufacture a round pillar-shaped honeycomb structure having a size of 203.2 mm in diameter×200 mm in length, with a coat layer formed on the periphery thereof.

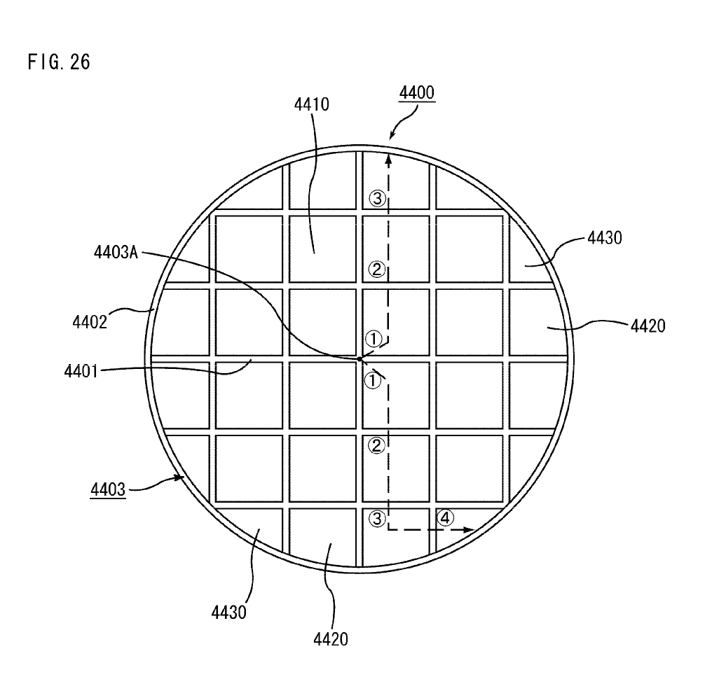

The cross-sectional shape of the honeycomb structure manufactured in Comparative Example 4-2 is shown in FIG. 26.

FIG. 26 is a cross-sectional view that shows the honeycomb structure 4400 manufactured in Comparative Example 4-2, and in FIG. 26, reference numerals 4410, 4420, and 4430 represent honeycomb fired bodies, a reference numeral 4401 represents an adhesive layer, a reference numeral 4402 represents a coat layer and a reference numeral 4403 represents a ceramic block.

The cross-sectional area of the ceramic block 4403 is 32302 mm², the number of the adhesive layers existing on a route which passes through the honeycomb fired bodies 4410 and 4420 and extends from the center of gravity 4403A of the ceramic block 4403 to the periphery of the ceramic block 4403 in the cross section is three, and the number of the adhesive layers existing on a route which passes through the honeycomb fired bodies 4410 and 4430 and extends from the center of gravity 4403A of the ceramic block 4403 to the periphery of the ceramic block 4403 in the cross section is four.

Evaluated in the same manner as in Example 1-4, the regenerating rate of the honeycomb structure of Example 4-2 was 82%, and the regenerating rate of the honeycomb structure of Comparative Example 4-2 was 65%.

### Third Embodiment of Fourth Aspect of the Present Invention

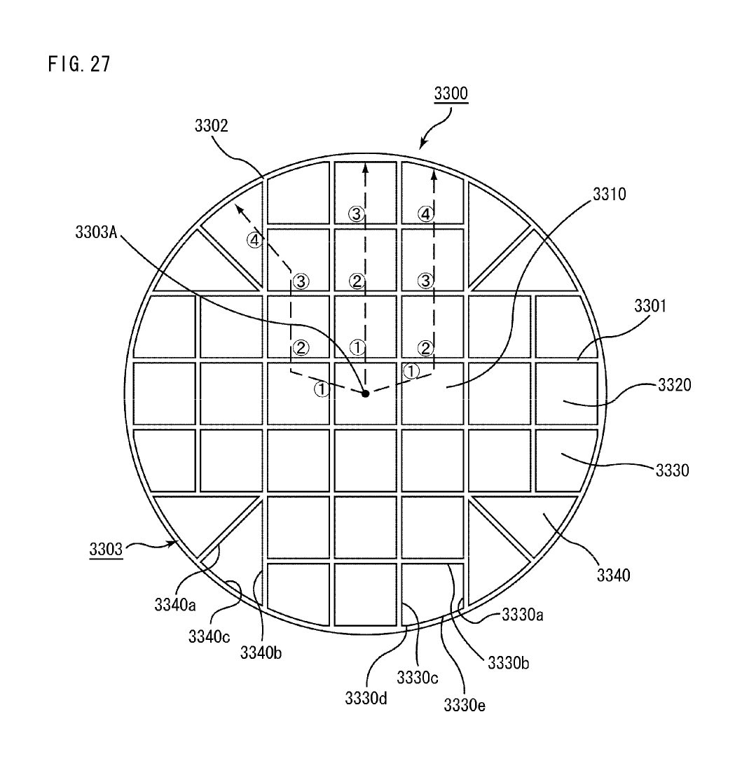

FIG. 27 is a cross-sectional view of a honeycomb structure according to the third embodiment of the fourth aspect of the present invention.

In the honeycomb structure 3300 of the present embodiment, a cross-sectional area of a ceramic block 3303 is 40000 mm² or more and about 55000 mm² or less.

As shown in FIG. 27, the honeycomb structure 3300 of the present embodiment has a structure in which pluralities of honeycomb fired bodies 3310, 3320, 3330 and 3340 are combined with one another with an adhesive layer 3301 interposed therebetween to form a ceramic block 3303. A coat layer 3302 is formed on the periphery of the ceramic block 3303.

The cross section of each of the honeycomb fired bodies 3310 and 3320 has a substantially square shape.

The cross section of the honeycomb fired body 3330 has a shape surrounded by four line segments 3330a, 3330b, 3330c, and 3330d and one arc 3330e, and all angles formed by two line segments of the four line segments (an angle formed by the line segments 3330a and 3330b, an angle formed by the line segments 3330b and 3330c, and an angle formed by the line segments 3330c and 3330d) are about 90°.

The cross section of the honeycomb fired body 3340 has a shape surrounded by two line segments 3340a and 3340b and one arc 3340c, and the angle formed by the two line segments (the angle formed by the line segments 3340a and 3340b) is about 45°.

That is, the honeycomb fired bodies 3310 and 3320 are the same as the honeycomb fired body 3110 used for the honeycomb structure according to the first embodiment of the fourth aspect of the present invention. The honeycomb fired bodies 3330 and 3340 have the same functions as that of the honeycomb fired body 3110 of the honeycomb structure according to the first embodiment of the fourth aspect of the present invention, although the outer shapes of the honeycomb fired bodies 3330 and 3340 are different from that of the honeycomb fired body 3110.

The cross-sectional area of each of the honeycomb fired bodies 3310, 3320, 3330, and 3340 is at least about 900 mm² and at most about 2500 mm².

Further, the honeycomb fired bodies 3310, 3320, 3330, and 3340 include a porous silicon carbide sintered body.

As shown in FIG. 27, in the honeycomb structure 3300, 21 pieces of the honeycomb fired bodies 3310 combined with one another with the adhesive layer 3301 interposed therebetween are located near the center of the cross section of the honeycomb structure 3300, and four pieces of the honeycomb fired bodies 3320, eight pieces of the honeycomb fired bodies 3330, and eight pieces of the honeycomb fired bodies 3340 are located on the periphery of the 21 pieces of the honeycomb fired bodies 3310. These honeycomb fired bodies are combined with one another with the adhesive layer 3301 interposed therebetween so that the cross section of the ceramic block 3303 is formed into a substantially round shape.

In the cross section of the honeycomb structure 3300, the number of the adhesive layers existing on a route which passes through the honeycomb fired bodies 3310 and 3320 and extends from the center of gravity 3303A of the ceramic block 3303 to the periphery of the ceramic block 3303 (see an arrow in FIG. 27) is three.

In the cross section of the honeycomb structure 3300, the number of the adhesive layers existing on a route which passes through the honeycomb fired bodies 3310 and 3330 and extends from the center of gravity 3303A of the ceramic block 3303 to the periphery of the ceramic block 3303 (see an arrow in FIG. 27) is four.

In the cross section of the honeycomb structure 3300, the number of the adhesive layers existing on a route which passes through the honeycomb fired bodies 3310 and 3340 and extends from the center of gravity 3303A of the ceramic block 3303 to the periphery of the ceramic block 3303 (see an arrow in FIG. 27) is four.

As mentioned above, in the case that the cross-sectional area of the ceramic block is 40000 mm² or more and about 55000 mm² or less, and the number of the adhesive layers existing on a route which passes through the honeycomb fired bodies and extends from the center of gravity of the ceramic block to the periphery of the ceramic block in the cross section is four or less, the honeycomb structure is allowed to exert the following effects:

the adhesive layer easily alleviates thermal stress, and thus, it is easier to prevent occurrence of cracks and damages on the honeycomb structure, and

the honeycomb structure tends not to have a temperature distribution between the center portion and the peripheral portion, and thus, unburned particulates tend not to remain upon carrying out a regenerating process.

The following description will discuss a method for manufacturing a honeycomb structure of the present embodiment.

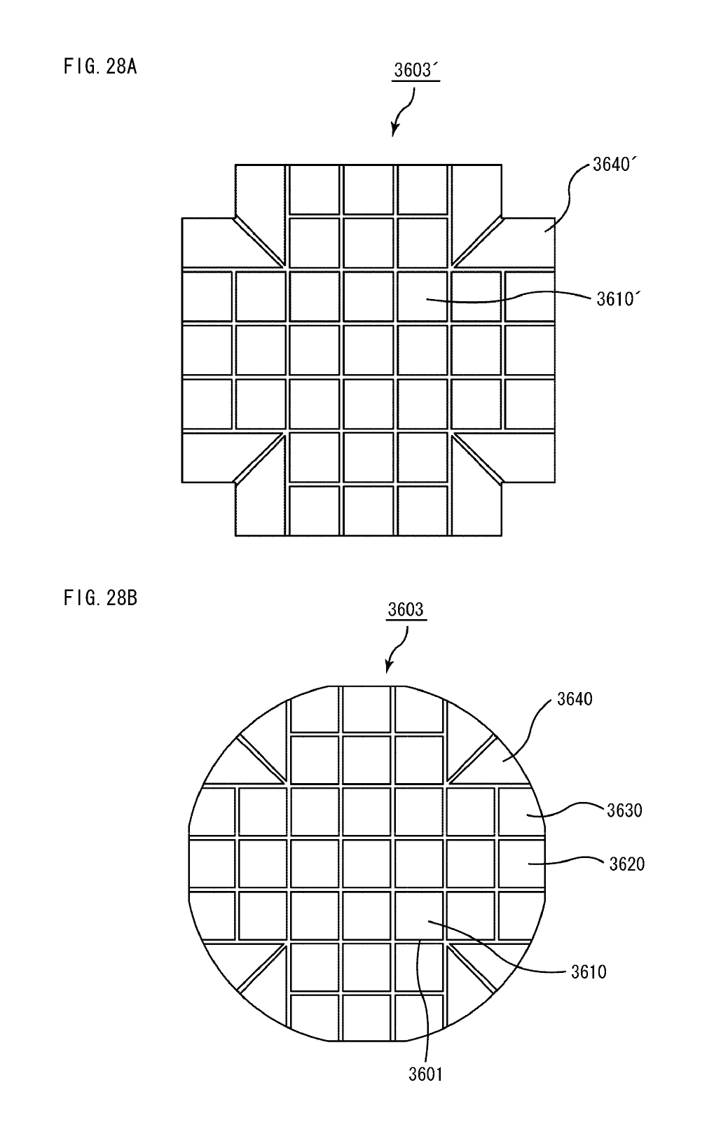

FIGS. 28A and 28B are cross-sectional views for describing an example of a method for manufacturing a honeycomb structure according to the third embodiment of the fourth aspect of the present invention.

(1) Honeycomb fired bodies with either one end of each of the cells sealed are manufactured by the same method as in the processes (1) to (3) of the first embodiment of the first aspect of the present invention.

At this time, a honeycomb fired body 3610 having a square cross-sectional shape and a honeycomb fired body 3640′ having a trapezoid cross-sectional shape are manufactured (see FIG. 28A).

(2) Next, in the same manner as in the process (4) of the first embodiment of the first aspect of the present invention, the honeycomb fired bodies 3610 and the honeycomb fired bodies 3640′ are combined with one another with the adhesive paste layer interposed therebetween so as to be arranged as shown in FIG. 28A. Further, the adhesive paste layer is solidified to manufacture an aggregated body of the honeycomb fired bodies 3603′.

(3) Next, a periphery cutting process is carried out in which the side face of the aggregated body of the honeycomb fired bodies 3603′ is cut by using a diamond cutter or the like to form a substantially round pillar shape so as to manufacture a ceramic block 3603 in which the honeycomb fired bodies 3610, 3620, 3630 and 3640 are combined with one another with the adhesive layer 3601 interposed therebetween (see FIG. 28B).

Then, if needed, a coat layer (not illustrated) is formed on the peripheral side face of the ceramic block 3603 to complete a honeycomb structure 3600.

The honeycomb structure of the present embodiment is allowed to exert the same effects as those of the honeycomb structure of the first embodiment of the fourth aspect of the present invention.

### Example 4-3

The following description will discuss an example that more specifically discloses the third embodiment of the fourth aspect of the present invention. However, the fourth aspect of the present invention is not limited to the Example.

(1) By carrying out the same method as the molding process

(1) of Example 1-1, raw honeycomb molded bodies having almost the same shapes as those of the honeycomb fired body 3610 and honeycomb fired body 3640′, shown in FIG. 28A, with no cells sealed, were manufactured.

(2) Next, the raw honeycomb molded bodies were dried by using a microwave drying apparatus to obtain a dried honeycomb molded bodies. A paste having the same composition as that of the wet mixture was then filled into predetermined cells, and the filled portions of the dried honeycomb molded bodies were dried by using a drying apparatus again.

(3) The dried honeycomb molded bodies were degreased at 400° C., and then fired at 2200° C. under normal pressure argon atmosphere for three hours.

Thus, a honeycomb fired body 3610 including a silicon carbide sintered body and having a porosity of 45%, an average pore diameter of 15 μm, a size of 34.5 mm×34.5 mm×250 mm, the number of cells (cell density) of 300 pcs/inch², a thickness of cell walls of 0.25 mm (10 mil), and a cross-sectional area of 1190 mm² was manufactured.

Also, a honeycomb fired body 3640′ having the same porosity, the same average pore diameter, the same number of cells (cell density) and the same thickness of cell walls as those of the honeycomb fired body 3610 and also having a trapezoidal cross-sectional shape (upper parallel side=35.5 mm, lower parallel side=70.0 mm, height=34.5 mm) was manufactured.

(4) An adhesive paste was applied to a predetermined side face of each of the honeycomb fired bodies 3610 and 3640′, and 33 pieces of the honeycomb fired bodies 3610 and eight pieces of the honeycomb fired bodies 3640′ were bonded to one another with the adhesive paste interposed therebetween so as to be arranged as shown in FIG. 28A. The adhesive paste was solidified at 180° C. in 20 minutes to manufacture an aggregated body of the honeycomb fired bodies 3603′.

Next, the periphery of the aggregated body of the honeycomb fired bodies 3603′ was cut by using a diamond cutter to manufacture an almost round pillar-shaped ceramic block 3603 having the cross-sectional area of 49400 mm².

With respect to the adhesive paste, the adhesive paste used in Example 1-1 was used.

(5) By using a coating material paste having the same composition as that of the adhesive paste used in the process (4), a coating material paste layer was formed on the periphery of the ceramic block 3603. Thereafter, the coating material paste layer was dried at 120° C. to manufacture a round pillar-shaped honeycomb structure having a size of 254 mm in diameter×250 mm in length with a coat layer formed on the periphery thereof.

The cross-sectional shape of the honeycomb structure manufactured in Example 4-3 is shown in FIG. 27.

The cross-sectional area of the honeycomb fired body 3310 is 1190 mm², the cross-sectional area of the honeycomb fired body 3320 is 1190 mm², the cross-sectional area of the honeycomb fired body 3330 is 1066 mm², the cross-sectional area of the honeycomb fired body 3340 is 1093 mm², the cross-sectional area of the ceramic block 3303 is 49400 mm², the number of the adhesive layers existing on a route which passes through the honeycomb fired bodies 3310 and 3320 and extends from the center of gravity 3303A of the ceramic block 3303 to the periphery of the ceramic block 3303 in the cross section is three, the number of the adhesive layers existing on a route which passes through the honeycomb fired bodies 3310 and 3330 and extends from the center of gravity 3303A of the ceramic block 3303 to the periphery of the ceramic block 3303 in the cross section is four, and the number of the adhesive layers existing on a route which passes through the honeycomb fired bodies 3310 and 3340 and extends from the center of gravity 3303A of the ceramic block 3303 to the periphery of the ceramic block 3303 in the cross section is four.

### Comparative Example 4-3

(1) By carrying out the same process as the process (1) of Example 4-2, a honeycomb fired body including a silicon carbide sintered body and having a porosity of 45%, an average pore diameter of 15 μm, a size of 34.5 mm×34.5 mm×250 mm, the number of cells (cell density) of 300 pcs/inch², a thickness of cell walls of 0.25 mm (10 mil), and a cross-sectional area of 1190 mm² was manufactured.

(2) An adhesive paste was applied to a predetermined side face of the honeycomb fired body, and 52 pieces of the honeycomb fired bodies were bonded to one another with the adhesive paste interposed therebetween. The adhesive paste was solidified at 180° C. in 20 minutes to manufacture an aggregated body of the honeycomb fired bodies having a rectangular pillar-shape, with the thickness of the adhesive layer being 1 mm.

Here, as the adhesive paste, the same adhesive paste as that used in Example 1-1 was used.

(3) Next, the periphery of the aggregated body of the honeycomb fired bodies was cut by using a diamond cutter to manufacture a round pillar-shaped ceramic block having a cross-sectional area of 50511 mm².

Subsequently, a coating material paste layer was formed on the periphery of the ceramic block by using the coating material paste made of the same material as that of the adhesive paste.

Further, this coating material paste layer was dried at a temperature of 120° C. to manufacture a round pillar-shaped honeycomb structure having a size of 254.2 mm in diameter×250 mm in length.

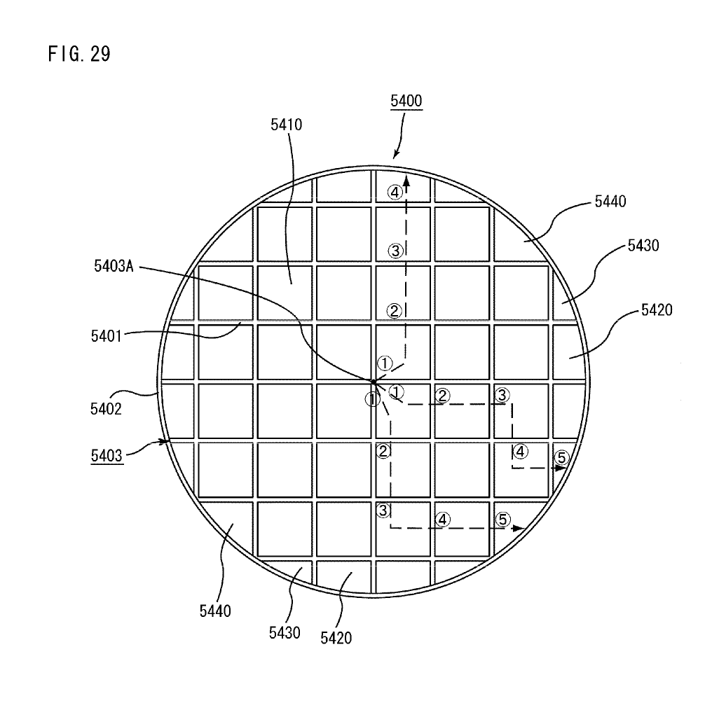

The cross-sectional shape of the honeycomb structure manufactured in Comparative Example 4-3 is shown in FIG. 29.

FIG. 29 is a cross-sectional view that shows the honeycomb structure 5400 manufactured in Comparative Example 4-3, and in FIG. 29, reference numerals 5410, 5420, 5430, and 5440 represent honeycomb fired bodies, a reference numeral 5401 represents an adhesive layer, a reference numeral 5402 represents a coat layer and a reference numeral 5403 represents a ceramic block.

The cross-sectional area of the honeycomb fired body 5410 is 1190 mm², the cross-sectional area of the ceramic block 5403 is 50511 mm², the number of the adhesive layers existing on a route which passes through the honeycomb fired bodies 5410 and 5420 and extends from the center of gravity 5403A of the ceramic block 5403 to the periphery of the ceramic block 5403 in the cross section is four, the number of the adhesive layers existing on a route which passes through the honeycomb fired bodies 5410 and 5430 and extends from the center of gravity 5403A of the ceramic block 5403 to the periphery of the ceramic block 5403 in the cross section is five, and the number of the adhesive layers existing on a route which passes through the honeycomb fired bodies 5410 and 5440 and extends from the center of gravity 5403A of the ceramic block 5403 to the periphery of the ceramic block 5403 in the cross section is five.

Evaluated in the same manner as in Example 1-1 except that an 8 L engine was used instead of the 2 L engine, the regenerating rate of the honeycomb structure of Example 4-3 was 85%. Further, the regenerating rate of the honeycomb structure of Comparative Example 4-3 was 72%.

### Other Embodiments of Fourth Aspect of the Present Invention

The honeycomb structure according to each of the first and second embodiments of the fourth aspect of the present invention may be manufactured in the same manner as in, for example, the third embodiment of the first aspect of the present invention.

The cross-sectional shape of the honeycomb structure according to the embodiments of the fourth aspect of the present invention is not limited to a substantially round shape. The cross-sectional shape may be a substantially elliptical shape, a substantially elongated round shape, a substantially racetrack shape, or the like.

### Other Embodiments of First to Fourth Aspects of the Present Invention

As mentioned above, the honeycomb structure with either one end of each of the cells sealed was described as the honeycomb structure according to each of the embodiments of the first to fourth aspects of the present invention; however, in the honeycomb structure according to each of the embodiments of the first to fourth aspects of the present invention, each of the cells is not necessarily sealed at either one end. The honeycomb structure of this kind can be used as a catalyst supporting carrier.

The shape of each of the honeycomb fired bodies of the honeycomb structure according to each of the embodiments of the first to fourth aspects of the present invention is not particularly limited. The shape is preferably a shape which makes it easy to combine the honeycomb fired bodies with one another with the adhesive layer interposed therebetween to manufacture a honeycomb structure, and examples of the cross-sectional shape thereof.

Include a substantially square shape, a substantially rectangular shape, a hexagonal shape, a sector shape, and the like.

In the honeycomb structure according to each of the embodiments of the first to fourth aspects of the present invention, examples of the inorganic binder contained in the adhesive paste include silica sol, alumina sol, and the like. Each of these may be used alone, or two or more of these may be used in combination. Out of the inorganic binders, silica sol is preferably used.

Examples of the inorganic particles contained in the adhesive paste include carbides, nitrides, and the like, and more specifically, inorganic powder made from silicon carbide, silicon nitride, boron nitride and the like. Each of these may be used alone, or two or more kinds of these may be used in combination. Out of the inorganic particles, silicon carbide is preferably used due to its superior thermal conductivity.

Examples of at least one of the inorganic fibers and whiskers contained in the adhesive paste include at least one of inorganic fibers and whiskers made of silica-alumina, mullite, alumina, silica or the like. Each of these materials may be used alone, or two or more of these may be used in combination. Out of the inorganic fibers, alumina fibers are preferably used.

Although not particularly limited, a porosity of the honeycomb fired body of the honeycomb structure according to each of the embodiments of the first to fourth aspects of the present invention is preferably at least about 35% and at most about 60%.

When the honeycomb structure is used as a filter, the porosity of about 35% or more is less likely to cause clogging in the honeycomb structure. In contrast, the porosity of about 60% or less is less likely to cause a reduction in the strength of the honeycomb fired body, so that the honeycomb fired body is less likely to be easily broken.

The average pore diameter of the honeycomb fired body of the honeycomb structure according to each of the embodiments of the first to fourth aspects of the present invention is preferably at least about 5 μm and at most about 30 μm.

When the honeycomb structure is used as a filter, the average pore diameter of about 5 μm or more is less likely to easily cause clogging of particulates. In contrast, the average pore diameter of about 30 μm or less is less likely to allow particulates to pass through the pores. As a result, the honeycomb fired body may easily capture the particulates, and thus, the honeycomb structure may function as a filter for sure.

Here, the porosity and the average pore diameter can be measured by conventionally known methods such as a mercury porosimetry, Archimedes method, and a measuring method using a scanning electronic microscope (SEM).

The cell density in the cross-section perpendicular to the longitudinal direction of the honeycomb fired body constituting the honeycomb structure according to each of the embodiments of the first to fourth aspects of the present invention is not particularly limited. However, a preferable lower limit thereof is about 31.0 pcs/cm² (about 200 pcs/inch 2) and a preferable upper limit is about 93.0 pcs/cm² (about 600 pcs/inch²). A more preferable lower limit is about 38.8 pcs/cm² (about 250 pcs/inch²) and a more preferable upper limit is about 77.5 pcs/cm² (about 500 pcs/inch²).

Further, the thickness of the cell walls of the honeycomb fired body constituting the honeycomb structure is not particularly limited, and preferably at least about 0.1 mm and at most about 0.4 mm.

The main component of the honeycomb fired body constituting the honeycomb structure according to each of the embodiments of the first to fourth aspects of the present invention is not limited to silicon carbide, and may be powders of the following ceramics: nitride ceramics such as aluminum nitride, silicon nitride, boron nitride, and titanium nitride; carbide ceramics such as zirconium carbide, titanium carbide, tantalum carbide, and tungsten carbide; oxide ceramics such as cordierite, aluminum titanate; and the like.

Out of these components, non-oxide ceramics are preferable, and silicon carbide is particularly preferable. This is because they are excellent in thermal resistance, mechanical strength, thermal conductivity and the like. Moreover, ceramic materials such as silicon-containing ceramics, in which the above-mentioned ceramic is blended with metallic silicon, and ceramics bonded by silicon or silicate compounds can also be used as the constitutional material. Out of these, silicon carbide blended with metallic silicon (silicon-containing silicon carbide) is preferable.

In particular, ceramics of silicon-containing silicon carbide including about 60% by weight or more of silicon carbide are preferable.

The particle diameter of the ceramic powder is not particularly limited, and the silicon carbide powder that tends not to cause the case where the size of the honeycomb fired body manufactured by the following firing treatment becomes smaller than that of the honeycomb molded body after degreased is preferable.

With respect to the wet mixture prepared upon manufacturing the honeycomb structure according to each of the embodiments of the first to fourth aspects of the present invention, the organic binder to be mixed in the wet mixture is not particularly limited, and examples thereof include methyl cellulose, carboxymethyl cellulose, hydroxyethyl cellulose, polyethylene glycol, and the like. Methyl cellulose is preferable out of these. The binder is preferably blended at a ratio of at least about 1 part by weight and at most about 10 parts by weight per 100 parts by weight of the ceramic powder.

The plasticizer to be mixed in the wet mixture is not particularly limited, and examples thereof include glycerin and the like.

Also, the lubricant to be mixed in the wet mixture is not particularly limited, and examples thereof include polyoxyalkylene compounds such as polyoxyethylene alkyl ether, polyoxypropylene alkyl ether, and the like. Specific examples of the lubricant include polyoxyethylene monobutyl ether, polyoxypropylene monobutyl ether, and the like.

Also, in some cases, the plasticizer or lubricant may not be mixed in the wet mixture.

Also, when preparing the wet mixture, it is acceptable to use a dispersant solution such as water, organic solvents such as benzene, and alcohol such as methanol.

Further, it is also acceptable to add a forming auxiliary to the wet mixture.

The forming auxiliary is not particularly limited, and examples thereof include ethylene glycol, dextrin, fatty acids, fatty acid soap, polyalcohol, and the like.

Further, it is acceptable to add balloons, which are fine hollow spheres containing oxide ceramic as a component, and a pore-forming agent such as spherical acrylic particles or graphite to the wet mixture, if necessary.

The balloons are not particularly limited, and examples thereof include alumina balloons, glass micro balloons, shirasu balloons, fly ash balloons (FA balloons), mullite balloons, and the like. Alumina balloons are preferable out of these.

The plug material paste for sealing the cells is not particularly limited, and the plug, manufactured in the subsequent process, preferably has a porosity of at least about 30% and at most about 75%. For example, it is possible to use a paste-like material, which is the same material as the wet mixture.

A catalyst for converting exhaust gases may be supported on the honeycomb structure according to the embodiments of the first to fourth aspects of the present invention, and the catalyst to be supported is desirably noble metals such as platinum, palladium, and rhodium. Out of these, platinum is more desirably used. Moreover, alkali metals such as potassium and sodium, or alkali-earth metals such as barium may be used as other catalysts. Each of these catalysts may be used alone, or two or more kinds of these may be used in combination.

In the combining process in the method for manufacturing the honeycomb structure of each of the embodiments of the first to fourth aspects of the present invention, instead of the method in which an adhesive paste is applied to a side face of each honeycomb fired body, for example, a method may be used in which, with each of honeycomb fired bodies being temporarily secured in a mold frame having almost the same shape as the shape of a ceramic block (or an aggregated body of honeycomb fired bodies) to be manufactured, an adhesive paste is injected between each of the honeycomb fired bodies.

Each of the honeycomb structure according to the embodiments of the first to fourth aspects of the present invention may also have the characteristics of other aspects of the present invention.

For example, in addition to the above characteristic, the honeycomb structure according to the embodiments of the first aspect of the present invention may have the following characteristics, that is: provided that a figure, which is similar to the shape of the ceramic block in the cross section and is concentric with the shape of the ceramic block in the cross section, is drawn in the cross section with an area ratio of the figure being about 49% to the area of the ceramic block in the cross section, a part of each of the peripheral-portion honeycomb fired bodies is necessarily located in the figure; the honeycomb structure includes the first peripheral-portion adhesive layer and the second peripheral-portion adhesive layer, and at least one of the first peripheral-portion adhesive layers and the second peripheral-portion adhesive layer form an angle of at least about 40° and at most about 50°; or the cross-sectional area of the ceramic block and the number of the adhesive layers existing on a route which extends from the center of gravity of the ceramic block to the periphery of the ceramic block in the cross section satisfy the predetermined relationships.

Further, for example, in addition to the above characteristic, the honeycomb structure according to the embodiments of the second aspect of the present invention may have the following characteristics, that is: the honeycomb structure includes the first peripheral-portion adhesive layer and the second peripheral-portion adhesive layer, and at least one of the first peripheral-portion adhesive layers and the second peripheral-portion adhesive layer forms an angle of at least about 40° and at most about 50°; or the cross-sectional area of the ceramic block and the number of the adhesive layers existing on a route which extends from the center of gravity of the ceramic block to the periphery of the ceramic block in the cross section satisfy the predetermined relationships.

Further, for example, in addition to the above characteristic, the honeycomb structure according to the embodiments of the third aspect of the present invention may have the following characteristic, that is: the cross-sectional area of the ceramic block and the number of the adhesive layers existing on a route which extends from the center of gravity of the ceramic block to the periphery of the ceramic block in the cross section satisfy the predetermined relationships.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A honeycomb structure comprising:
a plurality of honeycomb fired bodies that are combined with one another with an adhesive layer interposed therebetween, each of the honeycomb fired bodies having cell walls extending along a longitudinal direction of the honeycomb structure to define cells,
wherein
said honeycomb fired bodies comprise a center-portion honeycomb fired body located in a center portion and a peripheral-portion honeycomb fired body located in a peripheral portion in a cross section perpendicular to the longitudinal direction of said honeycomb structure,
a shape of said center-portion honeycomb fired body is a substantially rectangular shape in said cross section,
an area of said center-portion honeycomb fired body is at least about 900 mm² and at most about 2500 mm² in said cross section,
a shape of said peripheral-portion honeycomb fired body is different from the shape of said center-portion honeycomb fired body in said cross section, and
an area of said peripheral-portion honeycomb fired body is at least about 0.9 times and at most about 1.3 times larger than the area of said center-portion honeycomb fired body in said cross section.

2. The honeycomb structure according to claim 1,
wherein
the shape of said peripheral-portion honeycomb fired body is formed into a shape surrounded by three line segments and one arc or elliptical arc in said cross section, and
two angles made by the two line segments out of said three line segments are a substantially right angle and an obtuse angle.

3. The honeycomb structure according to claim 2,
wherein
said obtuse angle is about 135°.

4. The honeycomb structure according to claim 1,
wherein
the shape of the cross section of said center-portion honeycomb fired body is a substantially square shape.

5. The honeycomb structure according to claim 1,
wherein
said honeycomb structure comprises:
four pieces of said center-portion honeycomb fired bodies; and
eight pieces of said peripheral-portion honeycomb fired bodies.

6. The honeycomb structure according to claim 1,
wherein
the shape of the cross section of said honeycomb structure is a substantially round shape.

7. The honeycomb structure according to claim 1,
wherein
either one end portion of each of said cells is sealed.

8. The honeycomb structure according to claim 1, further comprising
a coat layer formed on a peripheral side face of said honeycomb structure.

9. The honeycomb structure according to claim 1,
wherein
said honeycomb structure comprises:
nine pieces of said center-portion honeycomb fired bodies; and
sixteen pieces of said peripheral-portion honeycomb fired bodies.

10. The honeycomb structure according to claim 1,
wherein
said peripheral-portion honeycomb fired body is preliminary molded into a predetermined shape.

11. The honeycomb structure according to claim 1,
wherein
periphery cutting is carried out to a side face of said peripheral-portion honeycomb fired body.

12. The honeycomb structure according to claim 1,
wherein
a shape of the cross section of said honeycomb structure is one of a substantially elliptical shape, a substantially elongated round shape, and a substantially racetrack shape.

13. The honeycomb structure according to claim 1,
wherein
said honeycomb structure comprises:
three pieces of said center-portion honeycomb fired bodies; and
eight pieces of said peripheral-portion honeycomb fired bodies.

14. The honeycomb structure according to claim 1,
wherein
a number of said center-portion honeycomb fired bodies is one.

15. The honeycomb structure according to claim 6,
wherein
four pieces of said honeycomb fired bodies are penetrated by one diameter in the cross section of said honeycomb structure as well as another diameter that is orthogonal to the one diameter.

16. The honeycomb structure according to claim 6,
wherein
five pieces of said honeycomb fired bodies are penetrated by one diameter in the cross section of said honeycomb structure as well as another diameter that is orthogonal to the one diameter.

17. The honeycomb structure according to claim 1,
wherein
an end portion of each of said cells is not sealed.

18. The honeycomb structure according to claim 1,
wherein
said honeycomb fired body comprises at least one of nitride ceramics, carbide ceramics, oxide ceramics, silicon-containing ceramics in which the above-mentioned ceramic is blended with metallic silicon and ceramics bonded by silicon or silicate compounds.

19. The honeycomb structure according to claim 18,
wherein
said honeycomb fired body comprises at least one of silicon carbide and silicon-containing silicon carbide.

20. The honeycomb structure according to claim 1,
wherein
said honeycomb structure supports a catalyst to convert and/or purify exhaust gases thereon.

21. The honeycomb structure according to claim 20,
wherein
said catalyst includes at least one of noble metals, alkali metals and alkali earth metals.

22. A honeycomb structure comprising:
a ceramic block in which
a plurality of honeycomb fired bodies are combined with one another with an adhesive layer interposed therebetween, and
each of the honeycomb fired bodies has cell walls extending along a longitudinal direction of the honeycomb structure to define cells,
wherein
a plurality of said honeycomb fired bodies comprise a center-portion honeycomb fired body located in a center portion of said ceramic block and a peripheral-portion honeycomb fired body forming a part of a peripheral side face of said ceramic block,
an area of said center-portion honeycomb fired body is at least about 900 mm² and at most about 2500 mm² in a cross section perpendicular to said longitudinal direction, and
provided that a figure, which is similar to a shape of said ceramic block in said cross section and is concentric with the shape of said ceramic block in said cross section, is drawn in said cross section with an area ratio of the figure being about 49% to the area of said ceramic block in said cross section, a part of said peripheral-portion honeycomb fired body is located in said figure.

23. The honeycomb structure according to claim 22,
wherein
either one end portion of each of said cells is sealed.

24. The honeycomb structure according to claim 22,
wherein
said honeycomb structure comprises:
four pieces of said center-portion honeycomb fired bodies; and
eight pieces of said peripheral-portion honeycomb fired bodies.

25. The honeycomb structure according to claim 22,
wherein
a shape of the cross section of said honeycomb structure is a substantially round shape or a substantially elliptical shape.

26. The honeycomb structure according to claim 22, further comprising:
a coat layer formed on the peripheral side face of said honeycomb structure.

27. The honeycomb structure according to claim 22,
wherein
said honeycomb structure comprises:
nine pieces of said center-portion honeycomb fired bodies; and
sixteen pieces of said peripheral-portion honeycomb fired bodies.

28. The honeycomb structure according to claim 22,
wherein
said peripheral-portion honeycomb fired bodies include two or more kinds of honeycomb fired bodies each different in the cross-sectional shape.

29. The honeycomb structure according to claim 22,
wherein
a shape of the cross section of said honeycomb structure is a substantially elongated round shape or a substantially racetrack shape.

30. The honeycomb structure according to claim 22,
wherein
an end portion of each of said cells is not sealed.

31. The honeycomb structure according to claim 22,
wherein
said honeycomb fired body comprises at least one of nitride ceramics, carbide ceramics, oxide ceramics, silicon-containing ceramics in which the above-mentioned ceramic is blended with metallic silicon and ceramics bonded by silicon or silicate compounds.

32. The honeycomb structure according to claim 31,
wherein
said honeycomb fired body comprises at least one of silicon carbide and silicon-containing silicon carbide.

33. The honeycomb structure according to claim 22,
wherein
said honeycomb structure supports a catalyst to convert and/or purify exhaust gases thereon.

34. The honeycomb structure according to claim 33,
wherein
said catalyst includes at least one of noble metals, alkali metals and alkali earth metals.

35. A honeycomb structure comprising:
a plurality of honeycomb fired bodies that are combined with one another with an adhesive layer interposed therebetween, each of the honeycomb fired bodies having cell walls extending along a longitudinal direction of the honeycomb structure to define cells,
wherein
said honeycomb structure comprises: a peripheral portion forming a peripheral side face of said honeycomb structure; and
a center portion having a substantially rectangular shape located at the inner side of said peripheral portion in a cross section perpendicular to the longitudinal direction of said honeycomb structure,
said peripheral portion includes a plurality of peripheral-portion honeycomb fired bodies combined with one another with said adhesive layer interposed therebetween, said center portion includes one center-portion honeycomb fired body or a plurality of center-portion honeycomb fired bodies combined with one another with said adhesive layer interposed therebetween,
said honeycomb structure includes at least one of the adhesive layers in said peripheral portion formed in a direction extending from a corner point of said center portion to the peripheral side face of said honeycomb structure in said cross section, and
said adhesive layer extending from the corner point of said center portion to the peripheral side face of said honeycomb structure forms an angle of at least about 40° and at most about 50° with at least one adhesive layer formed in a direction extending from the center portion other than the corner points thereof to the peripheral side face of said honeycomb structure.

36. The honeycomb structure according to claim 35, wherein
said center portion includes a plurality of the center-portion honeycomb fired bodies combined with one another with said adhesive layer interposed therebetween and
in said cross section perpendicular to said longitudinal direction of said honeycomb structure, at least one adhesive layer, which is disposed between said peripheral-portion honeycomb fired bodies and formed in a direction extending from the center portion other than the corner points thereof to the peripheral side face of said honeycomb structure, forms a substantially straight line with at least one adhesive layer which is disposed between said center-portion honeycomb fired bodies.

37. The honeycomb structure according to claim 35,
wherein
either one end portion of each of said cells is sealed.

38. The honeycomb structure according to claim 35,
wherein
said honeycomb structure comprises:
four pieces of said center-portion honeycomb fired bodies; and
eight pieces of said peripheral-portion honeycomb fired bodies.

39. The honeycomb structure according to claim 35,
wherein
a shape of the cross section of said honeycomb structure is a substantially round shape.

40. The honeycomb structure according to claim 35, further comprising:
a coat layer formed on the peripheral side face of said honeycomb structure.

41. The honeycomb structure according to claim 35,
wherein
said adhesive layer extending from the corner point of said center portion to the peripheral side face of said honeycomb structure forms an angle of about 45° with the adhesive layer formed in a direction extending from the center portion other than the corner points thereof to the peripheral side face of said honeycomb structure.

42. The honeycomb structure according to claim 35,
wherein
a Y-shape portion of said adhesive layer is present in the cross section of said honeycomb structure.

43. The honeycomb structure according to claim 35,
wherein
said honeycomb structure comprises:
nine pieces of said center-portion honeycomb fired bodies; and
sixteen pieces of said peripheral-portion honeycomb fired bodies.

44. The honeycomb structure according to claim 35,
wherein
a shape of the cross section of said honeycomb structure is one of a substantially elliptical shape, a substantially elongated round shape and a substantially racetrack shape.

45. The honeycomb structure according to claim 35,
wherein
the number of said center-portion honeycomb fired body is one.

46. The honeycomb structure according to claim 35,
wherein
all the angles formed by said adhesive layer extending from the corner point of said center portion to the peripheral side face of said honeycomb structure with the adhesive layers formed in a direction extending from the center portion other than the corner points thereof to the peripheral side face of said honeycomb structure are angles of at least about 40° and at most about 50°.

47. The honeycomb structure according to claim 35,
wherein
an area of said center-portion honeycomb fired body is at least about 900 mm² and at most about 2500 mm² in said cross section.

48. The honeycomb structure according to claim 35,
wherein
an end portion of each of said cells is not sealed.

49. The honeycomb structure according to claim 35,
wherein
said honeycomb fired body comprises at least one of nitride ceramics, carbide ceramics, oxide ceramics, silicon-containing ceramics in which the above-mentioned ceramic is blended with metallic silicon, and ceramics bonded by silicon or silicate compounds.

50. The honeycomb structure according to claim 49,
wherein
said honeycomb fired body comprises at least one of silicon carbide and silicon-containing silicon carbide.

51. The honeycomb structure according to claim 35,
wherein said honeycomb structure supports a catalyst to convert and/or purify exhaust gases thereon.

52. The honeycomb structure according to claim 51,
wherein
said catalyst includes at least one of noble metals, alkali metals and alkali earth metals.

53. A honeycomb structure comprising:
a ceramic block in which
a plurality of honeycomb fired bodies are combined with one another with an adhesive layer interposed therebetween, and
each of the honeycomb fired bodies has cell walls extending along a longitudinal direction of the honeycomb structure to define cells,
wherein
an area of said honeycomb fired body is at least about 900 mm² and at most about 2500 mm² in a cross section perpendicular to said longitudinal direction,
an area of said ceramic block is at least about 10000 mm² and at most about 55000 mm² in said cross section, and a number of the adhesive layers existing on a route which passes through said honeycomb fired bodies and extends from a center of gravity of said ceramic block to a periphery of said ceramic block in said cross section is:
two or less in a case that the area of said ceramic block in said cross section is about 10000 mm² or more and less than 25000 mm²,
three or less in a case that the area of said ceramic block in said cross section is 25000 mm² or more and less than 40000 mm², and
four or less in a case that the area of said ceramic block in said cross section is 40000 mm² or more and about 55000 mm² or less.

54. The honeycomb structure according to claim 53,
wherein
said ceramic block has a substantially round shape in said cross section.

55. The honeycomb structure according to claim 53,
wherein
either one end portion of each of said cells is sealed.

56. The honeycomb structure according to claim 53, further comprising:
a coat layer formed on a peripheral side face of said honeycomb structure.

57. The honeycomb structure according to claim 53,
wherein
said honeycomb fired bodies comprise a center-portion honeycomb fired body located in a center portion and a peripheral-portion honeycomb fired body located in a peripheral portion in said cross section.

58. The honeycomb structure according to claim 57,
wherein
said honeycomb structure comprises:
four pieces of said center-portion honeycomb fired bodies; and
eight pieces of said peripheral-portion honeycomb fired bodies.

59. The honeycomb structure according to claim 57,
wherein
said honeycomb structure comprises:
nine pieces of said center-portion honeycomb fired bodies; and
sixteen pieces of said peripheral-portion honeycomb fired bodies.

60. The honeycomb structure according to claim 57,
wherein
said honeycomb structure comprises:
21 pieces of said center-portion honeycomb fired bodies; and
20 pieces of said peripheral-portion honeycomb fired bodies.

61. The honeycomb structure according to claim 57,
wherein
a shape of the cross section of said center-portion honeycomb fired body is a substantially square shape.

62. The honeycomb structure according to claim 53,
wherein
a shape of the cross section of said honeycomb structure is one of a substantially elliptical shape, a substantially elongated round shape, and a substantially racetrack shape.

63. The honeycomb structure according to claim 53,
wherein
an end portion of each of said cells is not sealed.

64. The honeycomb structure according to claim 53,
wherein
said honeycomb fired body comprises at least one of nitride ceramics, carbide ceramics, oxide ceramics, silicon-containing ceramics in which the above-mentioned ceramic is blended with metallic silicon, and ceramics bonded by silicon or silicate compounds.

65. The honeycomb structure according to claim 64,
wherein
said honeycomb fired body comprises at least one of silicon carbide and silicon-containing silicon carbide.

66. The honeycomb structure according to claim 53,
wherein said honeycomb structure supports a catalyst to convert and/or purify exhaust gases thereon.

67. The honeycomb structure according to claim 66,
wherein
said catalyst includes at least one of noble metals, alkali metals and alkali earth metals.
